(19) United States
(12) Patent Application Publication
(10) Pub. No.: US 2026/0046395 A1
(43) Pub. Date: Feb. 12, 2026

(54) ENCODING AND DECODING METHODS, ENCODER, DECODER, BITSTREAM, AND STORAGE MEDIUM

(71) Applicant: GUANGDONG OPPO MOBILE TELECOMMUNICATIONS CORP., LTD., Dongguan (CN)

(72) Inventor: Zexing SUN, Dongguan (CN)

(21) Appl. No.: 19/359,908

(22) Filed: Oct. 16, 2025

Related U.S. Application Data
(63) Continuation of application No. PCT/CN2023/088806, filed on Apr. 17, 2023.

(51) Int. Cl. H04N 19/107; H04N 19/105; H04N 19/109; H04N 19/11; H04N 19/147; H04N 19/30; H04N 19/503; H04N 19/593; H04N 19/597; H04N 19/70

(52) U.S. Cl. CPC H04N 19/107; H04N 19/105; H04N 19/109; H04N 19/11; H04N 19/147; H04N 19/30; H04N 19/503; H04N 19/593; H04N 19/597; H04N 19/70

(57) ABSTRACT

A decoding method applied to a decoder includes: decoding a bitstream to determine flag information of a first prediction mode corresponding to nodes in a current layer; where the flag information of the first prediction mode is used for indicating an optimal prediction mode of the nodes in the current layer; determining the optimal prediction mode corresponding to the nodes in the current layer based on the flag information of the first prediction mode; and determining attribute prediction values of the nodes in the current layer based on the optimal prediction mode corresponding to the nodes in the current layer.

### CROSS-REFERENCE TO RELATED APPLICATION

This application is a continuation of International Application No. PCT/CN2023/088806 filed on Apr. 17, 2023, which is incorporated herein by reference.

### TECHNICAL FIELD

Embodiments of the present disclosure relate to the field of point cloud compression technologies, and in particular to, encoding and decoding methods, an encoder, a decoder, a bitstream, and a storage medium.

### BACKGROUND

In a geometry-based point cloud compression (G-PCC) encoding and decoding framework or a video-based point cloud compression (V-PCC) encoding and decoding framework provided by the moving picture experts group (MPEG), geometric information of a point cloud and attribute information of the point cloud are encoded separately.

Currently, attribute information encoding is mainly encoding for color information. In the color information encoding, there are two main transform methods, one is a distance-based lifting transform that relies on level of detail (LOD) partitioning, and the other is a direct region adaptive hierarchal transform (RAHT).

However, during performing RAHT attribute inter encoding, a correlation between a spatial domain of the point cloud and a time domain of the point cloud is not fully utilized to remove redundancy of attributes, which results in low attribute encoding efficiency.

### SUMMARY

The embodiments of the present disclosure provide encoding and decoding methods, an encoder, a decoder, a bitstream and a non-transitory storage medium.

The technical solutions of the embodiments of the present disclosure may be implemented as follows.

In a first aspect, the embodiments of the present disclosure provide a decoding method, which is applied to a decoder and includes:
decoding a bitstream to determine flag information of a first prediction mode corresponding to nodes in a current layer; where the flag information of the first prediction mode is used for indicating an optimal prediction mode of the nodes in the current layer;
determining the optimal prediction mode corresponding to the nodes in the current layer based on the flag information of the first prediction mode; and
determining attribute prediction values of the nodes in the current layer based on the optimal prediction mode corresponding to the nodes in the current layer.

In a second aspect, the embodiments of the present disclosure provide an encoding method, which is applied to an encoder and includes:
determining flag information of a first prediction mode corresponding to nodes in a current layer; where the flag information of the first prediction mode is used for indicating an optimal prediction mode of the nodes in the current layer;
determining the optimal prediction mode corresponding to the nodes in the current layer based on the flag information of the first prediction mode; and
determining attribute prediction values of the nodes in the current layer based on the optimal prediction mode corresponding to the nodes in the current layer.

In a third aspect, the embodiments of the present disclosure provide an encoder. The encoder includes a first determining unit; where
the first determining unit is configured to determine flag information of a first prediction mode corresponding to nodes in a current layer, where the flag information of the first prediction mode is used for indicating an optimal prediction mode of the nodes in the current layer; and determine attribute prediction values of the nodes in the current layer based on the optimal prediction mode corresponding to the nodes in the current layer.

In a fourth aspect, the embodiments of the present disclosure provide an encoder. The encoder includes a first memory and a first processor; where
the first memory is configured to store a computer program executable on the first processor; and
the first processor is configured to, when executing the computer program, perform the method according to the second aspect.

In a fifth aspect, the embodiments of the present disclosure provide a decoder. The decoder includes a second determining unit; where
the second determining unit is configured to decode a bitstream to determine flag information of a first prediction mode corresponding to nodes in a current layer, where the flag information of the first prediction mode is used for indicating an optimal prediction mode of the nodes in the current layer; determine the optimal prediction mode corresponding to the nodes in the current layer based on the flag information of the first prediction mode; and determine attribute prediction values of the nodes in the current layer based on the optimal prediction mode corresponding to the nodes in the current layer.

In a sixth aspect, the embodiments of the present disclosure provide a decoder. The decoder includes a second memory and a second processor; where
the second memory is configured to store a computer program executable on the second processor; and
the second processor is configured to, when executing the computer program, perform the method according to the first aspect.

In a seventh aspect, the embodiments of the present disclosure provide a bitstream. The bitstream is generated by bit encoding based on information to be encoded; and the information to be encoded includes at least:
flag information of a first prediction mode, flag information of a second prediction mode, flag information of a third prediction mode, and quantized coefficient residuals.

In an eighth aspect, the embodiments of the present disclosure provide a non-transitory computer-readable storage medium. The non-transitory computer-readable storage medium stores a computer program thereon, where the computer program, when executed, implements the method according to the first aspect or the method according to the second aspect.

The embodiments of the present disclosure provide encoding and decoding methods, an encoder, a decoder, a bitstream and a non-transitory storage medium. The encoder and the decoder determine flag information of a first prediction mode corresponding to nodes in a current layer, the flag information of the first prediction mode being used for indicating an optimal prediction mode of the nodes in the current layer; determine the optimal prediction mode corresponding to the nodes in the current layer based on the flag information of the first prediction mode; and determine attribute prediction values of the nodes in the current layer based on the optimal prediction mode corresponding to the nodes in the current layer.

### BRIEF DESCRIPTION OF THE DRAWINGS

FIG. 1A is a schematic diagram of a three-dimensional point cloud picture.

FIG. 1B is a partially enlarged diagram of a three-dimensional point cloud picture.

FIG. 2A is a schematic diagram of six viewing angles of a point cloud picture.

FIG. 2B is a schematic diagram of a data storage format corresponding to a point cloud picture.

FIG. 3 is a schematic diagram of a network architecture of point cloud encoding and decoding.

FIG. 4A is a schematic diagram of a composition framework of a G-PCC encoder.

FIG. 4B is a schematic diagram of a composition framework of a G-PCC decoder.

FIG. 5A is a schematic diagram of a low plane position in a Z-axis direction.

FIG. 5B is a schematic diagram of a high plane position in a Z-axis direction.

FIG. 6 is a schematic diagram of a node encoding sequence.

FIG. 7A is a schematic diagram of plane flag information.

FIG. 7B is another schematic diagram of plane flag information.

FIG. 8 is a schematic diagram of sibling nodes of a current node.

FIG. 9 is a schematic diagram of an intersection of a laser radar and a node.

FIG. 10 is a schematic diagram of a neighborhood node at the same partitioning depth and the same coordinate.

FIG. 11A, FIG. 11B and FIG. 11C are schematic diagrams of a current node being located at a low plane position of a parent node.

FIG. 12A, FIG. 12B and FIG. 12C are schematic diagrams of a current node being located at a high plane position of a parent node.

FIG. 13 is a schematic diagram of predictive encoding of plane position information of a laser radar point cloud.

FIG. 14 is a schematic diagram of infer direct coding model (IDCM) encoding.

FIG. 15 is a schematic diagram of coordinate transform of a point cloud obtained by a rotating laser radar.

FIG. 16 is a schematic diagram of predictive encoding in an X-axis or a Y-axis direction.

FIG. 17A is a schematic diagram of an angle of a Y plane predicted by a horizontal azimuth angle.

FIG. 17B is a schematic diagram of an angle of an X plane predicted by ta horizontal azimuth angle.

FIG. 18 is another schematic diagram of predictive encoding in an X-axis or Y-axis direction.

FIG. 19A is a schematic diagram of three vertices included in a sub-block.

FIG. 19B is a schematic diagram of a triangle soup fitted using three vertices.

FIG. 19C is a schematic diagram of upsampling of a triangle soup.

FIG. 20 is a schematic diagram of a distance-based LOD construction process.

FIG. 21 is a schematic diagram of a visualization result of an LOD generation process.

FIG. 22 is a schematic diagram of an encoding process for attribute prediction.

FIG. 23 is a schematic diagram of composition of a pyramid structure.

FIG. 24 is another schematic diagram of composition of a pyramid structure.

FIG. 25 is a schematic diagram of an LOD structure for inter-layer nearest-neighbor search.

FIG. 26 is a schematic diagram of a nearest-neighbor search structure based on spatial relationships.

FIG. 27A is a schematic diagram of a co-plane spatial relationship.

FIG. 27B is a schematic diagram of a co-plane and co-edge spatial relationship.

FIG. 27C is a schematic diagram of a co-plane, co-edge and co-point spatial relationship;

FIG. 28 is a schematic diagram of inter-layer prediction based on fast search.

FIG. 29 is a schematic diagram of an LOD structure for intra-layer nearest-neighbor search of attribute.

FIG. 30 is a schematic diagram of intra-layer prediction based on fast search.

FIG. 31 is a schematic diagram of a block-based neighborhood search structure.

FIG. 32 is a schematic diagram of an encoding process of a lifting transform.

FIG. 33 is a schematic diagram of a RAHT transform structure.

FIG. 34 is a schematic diagram of a RAHT transform process along x, y and z directions.

FIG. 35A is a schematic diagram of a RAHT forward transform process.

FIG. 35B is a schematic diagram of a RAHT inverse transform process.

FIG. 36 is a schematic diagram of a structure of an attribute encoding block.

FIG. 37 is a schematic diagram of an overall process of RAHT attribute predicting transform encoding.

FIG. 38 is a schematic diagram of a neighborhood prediction relationship of a current block.

FIG. 39 is a schematic diagram of a calculation process of an attribute transform coefficient.

FIG. 40 is a schematic diagram of a RAHT attribute inter predictive encoding structure.

FIG. 41 is a schematic flowchart of a decoding method provided in the embodiments of the present disclosure.

FIG. 42 is a schematic flowchart of an encoding method provided in the embodiments of the present disclosure.

FIG. 43 is a schematic diagram of a composition structure of an encoder provided in the embodiments of the present disclosure.

FIG. 44 is a schematic diagram of a hardware structure of an encoder provided in the embodiments of the present disclosure.

FIG. 45 is a schematic diagram of a composition structure of a decoder provided in the embodiments of the present disclosure.

FIG. 46 is a schematic diagram of a hardware structure of a decoder provided in the embodiments of the present disclosure.

FIG. 47 is a schematic diagram of a composition structure of an encoding and decoding system provided in the embodiments of the present disclosure.

### DETAILED DESCRIPTION

To provide a more detailed understanding of features and technical contents of the embodiments of the present disclosure, the implementations of the embodiments of the present disclosure will be described in detail below in conjunction with the accompanying drawings. The accompanying drawings are for reference and illustration only and not intended to limit the embodiments of the present disclosure.

Unless defined otherwise, all technical and scientific terms used herein have the same meaning as those commonly understood by those skilled in the art of the present disclosure. The terms used herein are for the purpose of describing the embodiments of the present disclosure only and not intended to limit the present disclosure.

In the following description, the term of “some embodiments” may be referred to describe a subset of all possible embodiments. However, it can be understood that “some embodiments” may be the same subset or different subsets of all possible embodiments, and may be combined with each other without conflict.

It should also be noted that the terms “first\second\third” involved in the embodiments of the present disclosure are merely used to distinguish similar objects and do not represent a specific order for the objects. It can be understood that the specific order or sequence of the terms “first\second\third” may be interchanged if allowed, so that the embodiments of the present disclosure described here can be implemented in an order other than that illustrated or described here.

A point cloud is a three-dimensional representation form of a surface of an object. Point cloud (data) on the surface of the object may be acquired through acquisition devices such as a photoelectric radar, a laser radar, a laser scanner or a multi-view camera.

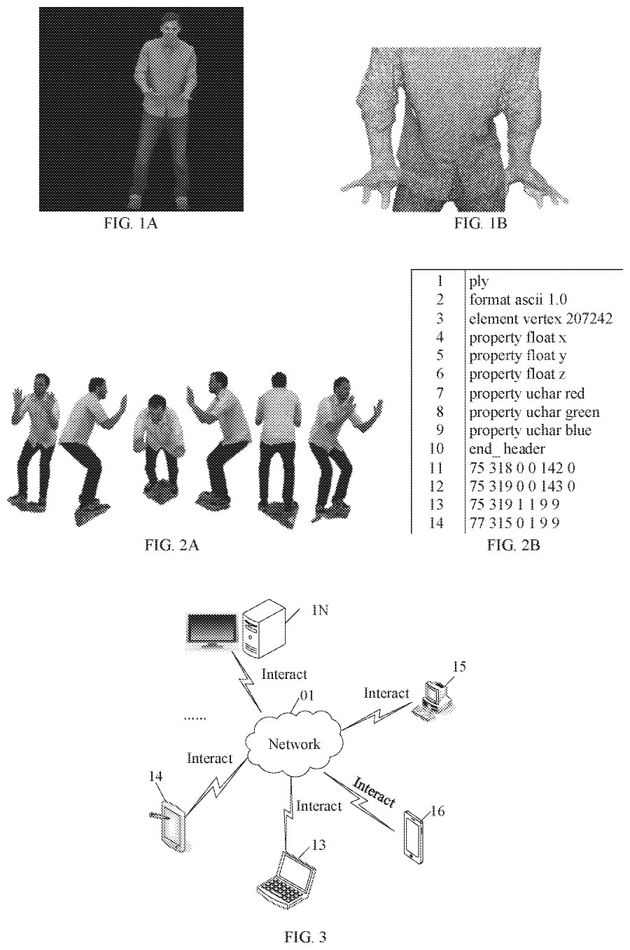

The point cloud is a set of discrete points in space that are irregularly distributed and express the spatial structure and surface attributes of a three-dimensional object or scenario. FIG. 1A illustrates a three-dimensional point cloud picture and FIG. 1B illustrates a partially enlarged diagram of a three-dimensional point cloud picture. It can be seen that a surface of the point cloud is composed of densely distributed points.

A two-dimensional picture has information expression at each pixel point and the distribution is regular, so there is no need to record its position information additionally. However, the distribution of points in the point cloud is random and irregular in three-dimensional space, so it is necessary to record the position of each point in space to completely express the point cloud. Similar to the two-dimensional picture, during the acquisition process, each position has corresponding attribute information. The attribute information is usually RGB color values, and the color values reflect the color of the object. For the point cloud, in addition to color information, the attribute information corresponding to each point also commonly includes a reflectance value, and the reflectance value reflects a material of the surface of the object. Therefore, the point cloud data generally includes geometric information composed of three-dimensional position information, and attribute information composed of three-dimensional color information and one-dimensional reflectance information. A point in the point cloud may include position information of the point and attribute information of the point. For example, the position information of the point may be three-dimensional coordinate information (x, y, z) of the point. The position information of the point may also be referred to as geometric information of the point. For example, the attribute information of the point may include color information (three-dimensional color information) and/or reflectance (one-dimensional reflectance information r), or the like. For example, the color information may be information in any color space. For example, the color information may be RGB information, where R represents red (R), G represents green (G) and B represents blue (B). For another example, the color information may be luma-chroma (YCbCr, YUV) information, where Y represents luminance (Luma), Cb (U) represents blue chromatic aberration and Cr (V) represents red chromatic aberration.

For a point cloud obtained according to the laser measurement principle, a point in the point cloud may include three-dimensional coordinate information of the point and a reflectance value of the point. For another example, for a point cloud obtained according to the photogrammetry principle, a point in the point cloud may include three-dimensional coordinate information of the point and three-dimensional color information of the point. For another example, for a point cloud obtained by combining the laser measurement principle and photogrammetry principle, a point in the point cloud may include three-dimensional coordinate information of the point, a reflectance value of the point and three-dimensional color information of the point.

FIG. 2A and FIG. 2B illustrate a point cloud picture and its corresponding data storage format, respectively. FIG. 2A provides six viewing angles of the point cloud picture, and FIG. 2B consists of a file header information part and a data part. The header information includes a data format, a data representation type, the total number of points in the point cloud and content represented by the point cloud. For example, the point cloud is in a “.ply” format, represented by ASCII code, and has a total of 207242 points, and each point has three-dimensional coordinate information (x, y, z) and three-dimensional color information (r, g, b).

Point clouds may be classified into following three types according to the acquisition ways:
a static point cloud: an object is static, and a device for acquiring the point cloud is also static;
a dynamic point cloud: an object is dynamic, but a device for acquiring the point cloud is static; and
a dynamically acquired point cloud: a device for acquiring the point cloud is dynamic. For example, point clouds may be classified into two types according to applications:
type I: a machine perception point cloud, which may be used for scenarios such as an autonomous navigation system, a real-time inspection system, a geographic information system, a visual sorting robot, and a disaster relief robot; and
type II: a human eyes perception point cloud, which may be used for point cloud application scenarios such as digital cultural heritage, free viewpoint broadcasting, 3D immersive communication, and 3D immersive interaction.

The point cloud may express spatial structures and surface attributes of three-dimensional objects or scenarios flexibly and conveniently; and since the point cloud is acquired by directly sampling real objects, the point cloud provides a strong sense of reality while ensuring accuracy. Therefore, the point cloud is widely applied, and its applied range includes a virtual reality game, a computer-aided design, a geographic information system, an automatic navigation system, digital cultural heritage, free viewpoint broadcasting, three-dimensional immersive remote presentation, and three-dimensional reconstruction of biological tissues and organs or the like.

The acquisition of the point cloud mainly includes following ways: computer generation, 3D laser scanning, 3D photogrammetry or the like. The computer may generate point clouds of virtual three-dimensional objects and scenarios. The 3D laser scanning may obtain point clouds of static real-world three-dimensional objects or scenarios, and may obtain millions of point clouds per second. The 3D photogrammetry may obtain point clouds of dynamic real-world three-dimensional objects or scenarios, and may obtain tens of millions of point clouds per second. These technologies reduce the cost and time period of point cloud data acquisition and improve the accuracy of data. The change in the way for acquiring point cloud data makes it possible to acquire a large amount of point cloud data. However, with the growth of application demand, the processing of massive 3D point cloud data has encountered the bottleneck in storage space and transmission bandwidth limitation.

For example, taking a point cloud video with a frame rate of 30 frames per second (fps) as an example, the number of points per frame of point cloud is 700,000, and each point has coordinate information xyz (float) and color information RGB (uchar). Thus, the data volume of a 10 s point cloud video is approximately 3.15 GB (0.7 million×(4 Byte×3+1 Byte×3)×30 fps×10 s=3.15 GB), where 1 Byte is 8 bit. For a two-dimensional video with a YUV sampling format of 4:2:0, a resolution of 1280×720 and a frame rate of 24 fps, the data volume of a 10s video is approximately 0.33 GB (1280×720×12 bit×24 fps×10 s≈0.33 GB), and the data volume of a 10 s three-dimensional video with two-viewpoints is approximately 0.66 GB (0.33×2=0.66 GB). It can be seen that, for videos with the same durations, the data volume of the point cloud video is much larger than that of the two-dimensional video or that of the three-dimensional video. Therefore, in order to well realize data management, save server storage space and reduce transmission traffic and transmission time between the server and the client, point cloud compression has become a key issue to promote the development of the point cloud industry.

That is, since the point cloud is a collection of massive points, storing the point cloud not only consumes a lot of memory, but also causes inconvenient for transmission; and there is no such large bandwidth to support direct transmission of the point cloud at the network layer without compression. Therefore, the point cloud needs to be compressed.

At present, a point cloud encoding framework that could perform compression on the point cloud may be a geometry-based point cloud compression (G-PCC) encoding and decoding framework or a video-based point cloud compression (V-PCC) encoding and decoding framework provided by the moving picture experts group (MPEG), or may be an audio video standard-point cloud compression (AVS-PCC) encoding and decoding framework provided by the AVS. The G-PCC encoding and decoding framework may be used to perform compression on a first type of static point cloud and a third type of dynamically acquired point cloud, which may be based on a point cloud compression test platform (Test Model Compression 13, TMC13), and the V-PCC encoding and decoding framework may be used to perform compression on a second type of dynamic point cloud, which may be based on a point cloud compression test platform (Test Model Compression 2, TMC2). Therefore, the G-PCC encoding and decoding framework is also referred to as a point cloud encoder and decoder (codec) TMC13, and the V-PCC encoding and decoding framework is also referred to as a point cloud encoder and decoder (codec) TMC2.

The embodiments of the present disclosure provide a network architecture of a point cloud encoding and decoding system including a decoding method and an encoding method. FIG. 3 is a schematic diagram of a network architecture of point cloud encoding and decoding provided in the embodiments of the present disclosure. As illustrated in FIG. 3, the network architecture includes one or more electronic devices 13 to 1N and a communication network 01, where the electronic devices 13 to 1N may perform video interaction through the communication network 01. During the implementation process, the electronic device may be one of various types of devices with point cloud encoding and decoding functions. For example, the electronic device may include a mobile phone, a tablet computer, a personal computer, a personal digital assistant, a navigator, a digital phone, a video phone, a television, a sensor device, a server, or the like, which is not limited in the embodiments of the present disclosure. The decoder or the encoder in the embodiments of the present disclosure may be the above electronic device.

The electronic device in the embodiments of the present disclosure has point cloud encoding and decoding functions, and generally, the electronic device includes a point cloud encoder (i.e., an encoder) and a point cloud decoder (i.e., a decoder).

The relevant technologies will be described by taking the G-PCC encoding and decoding framework as an example below.

It can be understood that in the point cloud G-PCC encoding and decoding framework, for point cloud data to be encoded, the point cloud data is partitioned into a plurality of slices through slice partitioning firstly. In each slice, geometric information of the point cloud and attribute information corresponding to each point are encoded separately.

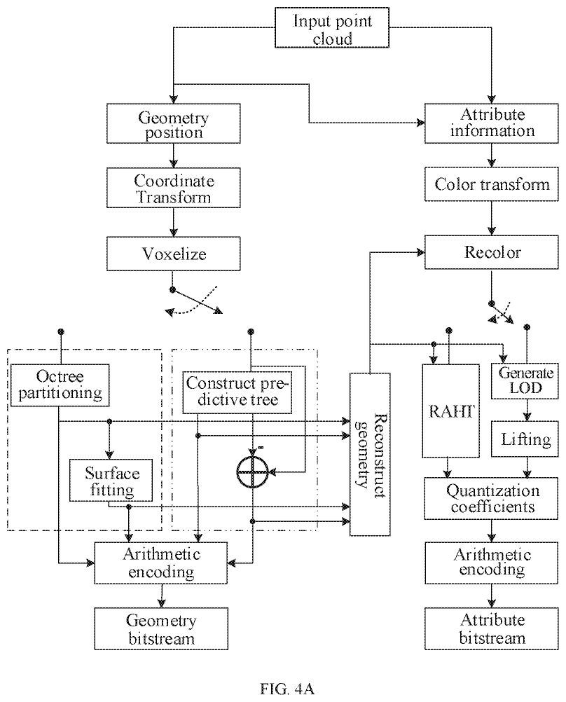

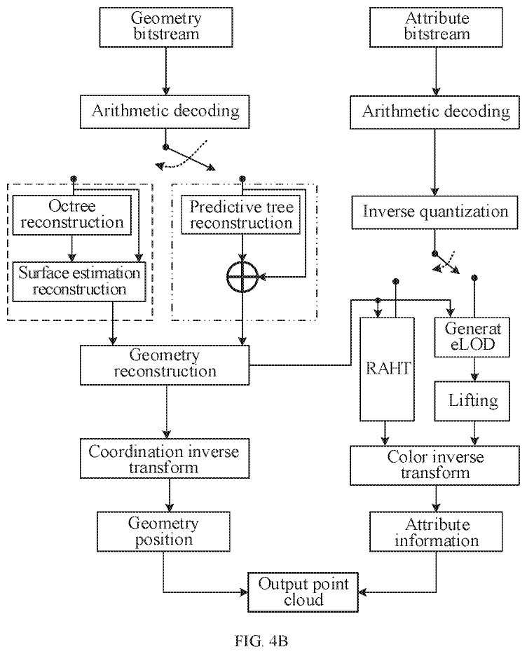

FIG. 4A illustrates a schematic diagram of a composition framework of a G-PCC encoder. As illustrated in FIG. 4A, during the geometry encoding process, coordinate transform is performed on the geometric information, so that all point clouds are included in a Bounding Box, and then quantization is performed, where the quantization mainly plays a role of scaling. Due to quantization and rounding, part of the point clouds have the same geometric information, and it is determined whether to remove duplicate points based on parameters. The process of quantization and removal of duplicate points is also referred to as a voxelization process. Then, octree partitioning or prediction tree construction is performed on the Bounding Box. During this process, arithmetic encoding is performed on points among the partitioned leaf nodes to generate a binary geometry bitstream; alternatively, arithmetic encoding (surface fitting based on vertexes) is performed on vertexes generated by partitioning to generate a binary geometry bitstream. During the attribute encoding process, after geometry encoding is completed and the geometric information is reconstructed, color transform is first required to transform the color information (i.e., attribute information) from the RGB color space to the YUV color space. Then, recoloring is performed on the point cloud using the reconstructed geometric information, so that unencoded attribute information corresponds to the reconstructed geometric information. Attribute encoding is mainly performed for the color information. During the color information encoding, there are two main transform methods: one is a distance-based lifting transform that relies on level of detail (LOD) partitioning, and the other is a direct region adaptive hierarchal transform (RAHT). Both methods could transform the color information from the spatial domain to the frequency domain, and obtain high-frequency coefficients and low-frequency coefficients through transform. Afterwards, quantization is performed on the coefficients, and then arithmetic encoding is performed on the quantization coefficients to generate a binary attribute bitstream.

FIG. 4B illustrates a schematic diagram of a composition framework of a G-PCC decoder. As illustrated in FIG. 4B, for the acquired binary bitstream, the geometry and attribute bitstreams in the binary bitstream are first decoded independently. During decoding the geometry bitstream, the geometric information of the point cloud is obtained through arithmetic decoding, octree reconstruction/prediction tree reconstruction, geometry reconstruction and coordinate inverse conversion. During decoding the attribute bitstream, the attribute information of the point cloud is obtained through arithmetic decoding, inverse quantization, LOD partitioning/RAHT and color inverse conversion. The point cloud data to be encoded is restored (i.e., the point cloud is output) based on the geometric information and the attribute information.

It should be noted that as illustrated in FIG. 4A or FIG. 4B, the current G-PCC geometry encoding and decoding may be partitioned into octree-based geometry encoding and decoding (marked by a dashed box) and prediction tree-based geometry encoding and decoding (marked by a dash-dotted line box).

For the octree-based geometry encoding (i.e., octree geometry encoding, OctGeomEnc), the OctGeomEnc includes the following contents. First, coordinate transform is performed on the geometric information, so that all point clouds are included in a Bounding Box. Then, quantization is performed, and the quantization mainly plays a role of scaling. Due to quantization and rounding, part of points have the same geometric information, and it is determined whether to remove duplicate points based on parameters. The process of quantization and removal of duplicate points is also referred to as a voxelization process. Next, tree partitioning (e.g., octree, quadtree or binary tree) is performed on the Bounding Box continually in an order of breadth-first traversal, and a placeholder code of each node is encoded. In the related art, a certain company provided an implicit geometry partitioning method. First, a bounding box (2^{d}^{ₓ}, 2^{d}^{_{y}}, 2^{d}^{_{z}}) of the point cloud is calculated, and assuming that dₓ>d_{y}>d_{z}, the bounding box is a cuboid accordingly. During geometry partitioning, binary tree partitioning is performed based on the x-axis to obtain two child nodes; and binary tree partitioning continues until the condition of dₓ=d_{y}>d_{z} is met, then quadtree partitioning is performed based on the x and y axes to obtain four child nodes; and quadtree partitioning continues until the condition of dₓ=d_{y}=d_{z} is met, and then octree partitioning is performed continually until the leaf node obtained through partitioning is a unit cube with a size of 1×1×1, at which the partitioning operation terminates. After that, the points in the leaf node are encoded to generate a binary bitstream. During the process of binary tree/quadtree/octree-based partitioning, two parameters, K and M, are introduced. The parameter K indicates the maximum number of binary tree/quadtree partitionings before octree partitioning is performed; and the parameter M is used to indicate that a side length of the corresponding minimum block is 2^{M} when binary tree/quadtree partitioning is performed. In addition, K and M must meet the conditions: assuming that dₘₐₓ=max(dₓ, d_{y}, d_{z}) and dₘᵢₙ=min(dₓ, d_{y}, d_{z}), the parameter K meeting the condition of K≥dₘₐₓ−dₘᵢₙ; and the parameter M meeting the condition of M≥dₘᵢₙ. The reason why the parameters K and M meet the above conditions is that, during the current geometry implicit partitioning, the priority of the partitioning manners in G-PCC is binary tree, quadtree and octree. Only when the block size of the node does not meet the condition of binary tree/quadtree, octree partitioning will be performed continually on the node until the minimum unit of the partitioned leaf node has a size of 1×1×1. The octree-based geometric information encoding mode may effectively encode the geometric information of the point cloud by utilizing the correlation between adjacent points in space. However, for some relatively planar nodes or nodes with planar characteristics, planar encoding may further improve the encoding efficiency of the geometric information of the point cloud.

For example, FIG. 5A and FIG. 5B provide schematic diagrams of plane positions. FIG. 5A illustrates a schematic diagram of a low plane position in a Z-axis direction, and FIG. 5B illustrates a schematic diagram of a high plane position in the Z-axis direction. As illustrated in FIG. 5A, (a), (a0), (a1), (a2) and (a3) here all belong to the low plane positions in the Z-axis direction. Taking (a) as an example, it can be seen that four occupied child nodes of the current node are all located in the low plane positions of the current node in the Z-axis direction. Therefore, it may be considered that the current node belongs to a Z plane and is a low plane in the Z-axis direction. Similarly, as illustrated in FIG. 5B, (b), (b1), (b2) and (b3) here all belong to the high plane positions in the Z-axis direction. Taking (b) as an example, it can be seen that four occupied child nodes of the current node are located in the high plane positions of the current node in the Z-axis direction. Therefore, it may be considered that the current node belongs to a Z plane and is a high plane in the Z-axis direction.

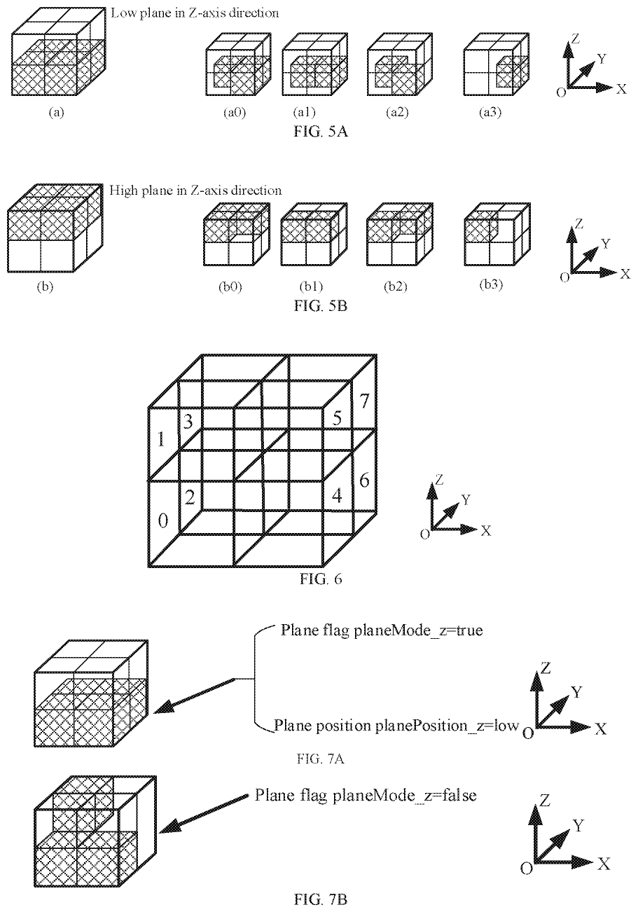

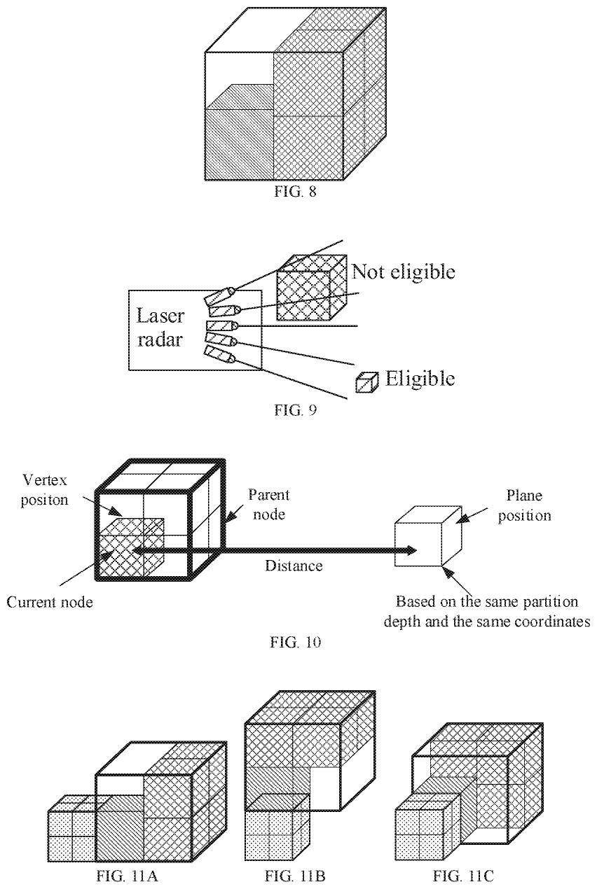

Furthermore, taking (a) in FIG. 5A as an example, the efficiency of octree encoding and the efficiency of planar encoding are compared. FIG. 6 provides a schematic diagram of a node encoding sequence, that is, encoding is performed on nodes according to the sequence of 0, 1, 2, 3, 4, 5, 6 and 7 illustrated in FIG. 6. Here, if the octree encoding mode is adopted for (a) in FIG. 5A, the placeholder information of the current node is represented as: 11001100. However, if the planar encoding mode is adopted, one identifier needs to be encoded first to represent that the current node is a plane in the Z-axis direction; secondly, if the current node is a plane in the Z-axis direction, the plane position of the current node needs to be represented; and then, only the placeholder information of the low plane nodes (i.e., the placeholder information of the four child nodes 0, 2, 4 and 6) in the Z-axis direction needs to be encoded. Therefore, only 6 bits need to be encoded when encoding is performed on the current node based on the planar encoding mode, which can reduce representation of 2 bits compared with the octree encoding in the related art. Based on the analysis, planar encoding achieves a significant improvement in encoding efficiency compared with octree encoding. Therefore, for an occupied node, if the planar encoding mode is adopted in a certain dimension, it is necessary to represent a plane flag (PlanarMode/PlaneMode) and a planar/plane position (PlanePos) information of the current node in the dimension, and then to encode the placeholder information of the current node based on the plane information of the current node. For example, FIG. 7A illustrates a schematic diagram of plane flag information. As illustrated in FIG. 7A, there is a low plane in the Z-axis direction; accordingly, a value of the plane flag information is true or 1, i.e., planarMode_z=true; and the plane position information (or referred to as planar position information) is a low plane, i.e., PlanePosition_z=low. FIG. 7B illustrates another schematic diagram of plane flag information. As illustrated in FIG. 7B, there is no plane in the Z-axis direction; accordingly, a value of the plane flag information is false or 0, i.e., planarMode_z=false.

It should be noted that, for PlaneMode_i: 0 represents that the current node is not a plane in an i-axis direction, and 1 represents that the current node is a plane in the i-axis direction. If the current node is a plane in the i-axis direction, for PlanePosition_i: 0 represents that the current node is a plane in the i-axis direction and the plane position is a low plane, and 1 represents that the current node is a high plane in the i-axis direction. Here, i represents the coordinate dimension, which may be the X-axis direction, the Y-axis direction or the Z-axis direction, and therefore i=0, 1, 2.

In the G-PCC standards, it is determined whether a node satisfies the condition for planar encoding; and in a case where the node satisfies the condition for planar encoding, it is necessary to perform predictive encoding on the plane flag information and plane position information.

In the embodiments of the present disclosure, there are three types of determination condition for determining whether the node meets planar encoding in the current G-PCC standards, which are described in detail one by one below.
I. The determination is performed based on a plane probability of the node in each dimension:
(1) a local area density (local_node_density) of the current node is determined; and
(2) a probability Prob(i) of the current node in each dimension is determined.

In a case where the local area density of the node is less than a threshold Th (e.g., Th=3), the plane probabilities Prob(i) of the current node in three coordinate dimensions are compared with thresholds Th0, Th1 and Th2, respectively, where Th0 <Th1<Th2 (e.g., Th0=0.6, Th1=0.77 and Th2=0.88). Here, Eligibleᵢ (i=0, 1, 2) may be used to represent whether the planar encoding is enabled in each dimension, where Eligibleᵢ=Prob(i)>=threshold.

It should be noted that the thresholds are adaptively changed. For example, in a case of Prob(0)>Prob(1)>Prob(2), the setting of Eligibleᵢ is as follows:

$${Eligible}_{0} = Prob ( 0 ) >= Th 0 ;$$

$${Eligible}_{1} = Prob ( 1 ) >= Th 1 ; and$$

$${Eligible}_{2} = Prob ( 2 ) >= Th 2.$$

In a case of Prob(1)>Prob(0)>Prob(2), the setting of Eligibleᵢ is as follows:

$${Eligible}_{0} = Prob ( 0 ) >= Th 1 ;$$

$${Eligible}_{1} = Prob ( 1 ) >= Th 0 ; and$$

$${Eligible}_{2} = Prob ( 2 ) >= Th 2.$$

Here, Prob(i) is updated as follows:

$${Prob ( i )}_{new} = ( L \times Prob ( i ) + δ ( coded node ) ) / L + 1.$$

Here, L=255; in addition, if the coded node is a plane, δ(coded node) is 1; otherwise, δ(coded node) is 0.

Here, local_node_density is updated as follows:

$$local\_node {\_density}_{new} = local\_node \_density + 4 * numSiblings .$$

Here, local_node_density is initialized to 4, and numSiblings is the number of sibling nodes of the node. Exemplarily, FIG. 8 illustrates a schematic diagram of sibling nodes of a current node. As illustrated in FIG. 8, the current node is a node filled with diagonal lines, and the nodes filled with grids are sibling nodes. Therefore, the number of the sibling nodes of the current node is 5 (including the current node itself).
II. It is determined whether the nodes in the current layer meet planar encoding based on a point cloud density of the current layer.

The density of points in the current layer is used to determine whether to perform planar encoding on the nodes in the current layer. Assuming that the number of points in the current point cloud to be encoded is pointCount, the number of points reconstructed after infer direct coding model (IDCM) encoding is numPointCountRecon. Since octree encoding is performed based on the order of breadth-first traversal, the number of nodes to be encoded in the current layer is assumed to be nodeCount; and then the determination of whether planar encoding is enabled on the current layer is assumed to be planarEligibleKOctreeDepth. Specifically, planarEligibleKOctreeDepth=(pointCount−numPointCountRecon)<nodeCount×1.3.

Here, in response to (pointCount−numPointCountRecon) being less than nodeCount×1.3, planarEligibleKOctreeDepth is true; and in response to (pointCount−numPointCountRecon) being not less than nodeCount×1.3, planarEligibleKOctreeDepth is false. In this way, in a case where planarEligibleKOctreeDepth is true, planar encoding is performed on all nodes in the current layer; otherwise, planar encoding is not performed on all nodes in the current layer, and only octree encoding is used
III. It is determined whether the current node meets planar encoding based on collection parameters of the laser radar point cloud.

FIG. 9 illustrates a schematic diagram of an intersection of a laser radar and a node. As illustrated in FIG. 9, a node filled with grids is passed through by two lasers simultaneously, and thus the current node is not a plane in the Z axis vertical direction; and a node filled with diagonal lines is sufficiently small such that the node cannot be passed through by two lasers simultaneously, and thus the node filled with diagonal lines may be a plane in the Z axis vertical direction.

Furthermore, for a node meeting the condition for planar encoding, predictive encoding may be performed on the plane flag information and the plane position information.

Firstly, predictive encoding is performed on the plane flag information.

Here, only three pieces of context information are adopted for encoding, that is, context design is performed on the plane flag in each coordinate dimension separately.

Secondly, predictive encoding is performed on the plane position information.

It should be understood that for encoding of the point cloud plane position information of the non-laser radar, the predictive encoding of the plane position information may include:
(a) plane position information of the current node obtained by predicting using the placeholder information of neighborhood nodes being three elements: predicted as a low plane, predicted as a high plane and unpredictable;
(b) a spatial distance between a node at the same partitioning depth and the same coordinates as the current node and the current node: “near” and “far”;
(c) if a node at the same partitioning depth and the same coordinates as the current node is a plane, determining the plane position of the node; and
(d) a coordinate dimension of the current node (i=0, 1, 2).

It should be noted that in the embodiments of the present disclosure, after the spatial distance between the node at the same partitioning depth and the same coordinates as the current node and the current node is determined, if the spatial distance is less than a preset distance threshold, the spatial distance may be determined to be “near”; or if the spatial distance is greater than the preset distance threshold, the spatial distance may be determined to be “far”.

Exemplarily, FIG. 10 illustrates a schematic diagram of a neighborhood node at the same partitioning depth and the same coordinates. As illustrated in FIG. 10, the bold large cube represents the parent node, the small cube filled with grids inside the parent node represents the current node, where a vertex position of the current node is shown; and the small cube filled with white represents the neighborhood node that is at the same partitioning depth and the same coordinates as the current node. The distance between the current node and the neighborhood node is the spatial distance, which may be determined as “near” or “far”. In addition, if the neighborhood node is a plane, the plane position of the neighborhood node is also required.

In this way, as illustrated in FIG. 10, the current node is a small cube filled with grids; then, the neighborhood node (a small cube filled with white) is searched at the same octree partitioning depth level and the same vertical coordinates, the distance between the two nodes is determined as “near” or “far”, and the plane position of the node is referred.

Furthermore, in the embodiments of the present disclosure, FIG. 11A to FIG. 11C illustrate schematic diagrams of a current node being located at a low plane position of a parent node. Three examples in which the current node is located at the low plane position of the parent node are illustrated in FIG. 11A, FIG. 11B and FIG. 11C. The specific instructions are as follows:
1) If any one of child nodes 4 to 7 of a node filled with points is occupied, and all nodes filled with grids are not occupied, there is a high probability that a plane exists in the current node (filled with diagonal lines), and the plane position is relatively lower.
2) If none of the child nodes 4 to 7 of the node filled with points is occupied, and any one of the nodes filled with grids is occupied, there is a high probability that a plane exists in the current node (filled with diagonal lines), and the plane position is relatively higher.
3) If all the child nodes 4 to 7 of the node filled with points are empty nodes, and all the nodes filled with grids are empty nodes, the plane position cannot be inferred and is therefore marked as unknown.
4) If any one of the child nodes 4 to 7 of the node filled with points is occupied, and any one of the nodes filled with grids is occupied, the plane position still cannot be inferred and is therefore marked as unknown.

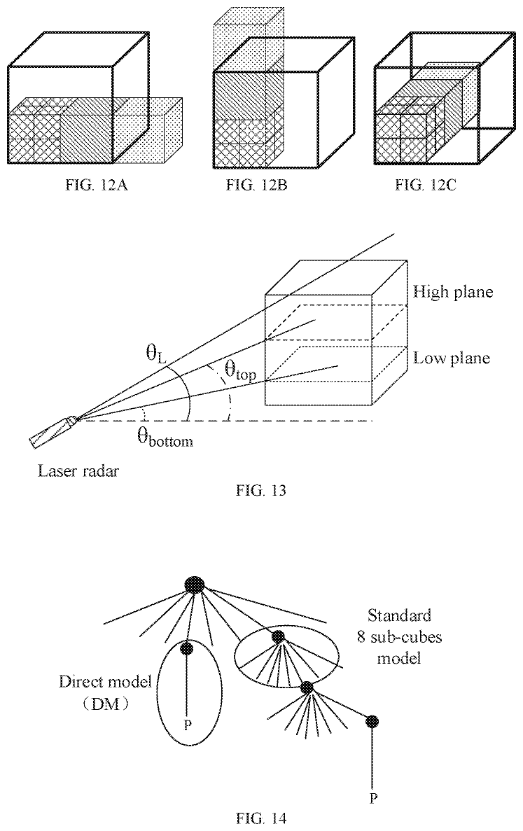

In the embodiments of the present disclosure, FIG. 12A to FIG. 12C illustrate schematic diagrams of a current node being located at a high plane position of a parent node. Three examples in which the current node is located at the high plane position of the parent node are illustrated in FIG. 12A, FIG. 12B and FIG. 12C. The specific instructions are as follows:
1) If any one of child nodes 4 to 7 of a node filled with grids is occupied, and a node filled with points is not occupied, there is a high probability that a plane exists in the current node (filled with diagonal lines), and the plane position is relatively low.
2) If none of the child nodes 4 to 7 of the node filled with grids is not occupied, and the node filled with points is occupied, there is a high probability that a plane exists in the current node (filled with diagonal lines), and the plane position is relatively high.
3) If none of the child nodes 4 to 7 of the node filled with grids is not occupied, and the node filled with points is not occupied, the plane position cannot be inferred and is therefore marked as unknown.
4) If one of the child nodes 4 to 7 of the node filled with grids is occupied, and the node filled with points is occupied, the plane position cannot be inferred and is therefore marked as unknown.

It should also be understood that for encoding of the point cloud plane position information of the laser radar, FIG. 13 illustrates a schematic diagram of predictive encoding of plane position information of a laser radar point cloud. As illustrated in FIG. 13, in a case where an emission angle of the laser radar is θ_{bottom}, the node may be mapped as a low plane (bottom virtual plane); and in a case where the emission angle of the laser radar is θₜₒₚ, the node may be mapped as a high plane (top virtual plane).

That is, the plane position of the current node is predicted using the laser radar collection parameters, and the position is quantified into a plurality of intervals using the position where the current node intersects with the laser ray, and finally the plurality of intervals are served as the context information of the plane position of the current node. The specific calculation process is as follows: assuming that the coordinates of the laser radar are (x_{Lidar}, y_{Lidar}, z_{Lidar}), and the geometric coordinates of the current node are (x, y, z), then a vertical tangent value tan 0 of the current node relative to the laser radar is first calculated. The calculation formula is as follows:

$$tan θ = \frac{z - {z}_{Lidar}}{\sqrt{{( x - {x}_{Lidar} )}^{2} + {( y - {y}_{Lidar} )}^{2}}}$$

Furthermore, since each Laser has a certain offset angle relative to the laser radar, it is further necessary to calculate a relative tangent value tan θ_{corr, L} of the current node relative to the Laser. The specific calculation is as follows:

$$tan {θ}_{corr , L} = \frac{z - {z}_{Lidar} - {z}_{L}}{\sqrt{{( x - {x}_{Lidar} )}^{2} + {( y - {y}_{Lidar} )}^{2}}} = tan θ - \frac{{z}_{L}}{r}$$

Then, prediction is performed on the plane position of the current node using the relative tangent value tan θ_{corr, L} of the current node. Specifically, assuming that a tangent value of a lower boundary of the current node is tan(θ_{bottom}), and a tangent value of an upper boundary of the current node is tan(θₜₒₚ), the plane position is quantized into 4 quantization intervals according to tan θ_{corr, L}, that is, the context information of the plane position is determined.

However, the octree-based geometric information encoding mode has an efficient compression rate only for points with correlation in space, while for points in isolated positions in the geometry space, complexity may be significantly reduced using a direct coding model (DCM). For all nodes in the octree, the use of DCM is not represented by flag bit information, but inferred through the parent node and neighbor information of the current node. There are three manners to determine whether the current node is eligible for DCM encoding, and the three manners are as follows:
(1) The current node has no sibling child nodes, that is, the parent node of the current node has only one child node, and a parent node of the parent node of the current node has only two occupied child nodes, that is, the current node has at most one neighboring node.
(2) The parent node of the current node has only one occupied child node (i.e., the current node); and six neighboring nodes that share a face with the current node also belong to empty nodes.
(3) The number of sibling nodes of the current node is greater than 1.

Exemplarily, FIG. 14 provides n schematic diagram of the IDCM encoding. If the current node is not eligible for DCM encoding, octree partitioning will be performed on the current node. If the current node is eligible for DCM encoding, the number of points included in the node will be further determined. In a case where the number of points is less than a threshold (e.g., 2), DCM encoding will be performed on the node, otherwise, octree partitioning will continue to be performed on the node. In a case where the DCM encoding mode is applied, it is necessary to encode whether the current node is a real isolated point, that is, IDCM_flag. If IDCM_flag is true, the current node adopts DCM encoding, otherwise, octree encoding is still adopted. In a case where the current node meets DCM encoding, it is necessary to encode the DCM encoding mode of the current node. At present, there are two DCM modes, which are: (a) only one point (or multiple points, but they are duplicate points) existing; and (b) including two points. Finally, it is necessary to encode the geometric information of each point. Assuming that a side length of the node is 2^{d}, d bits are required to encode each component of the geometric coordinates of the node, and this bit information is directly encoded into the bitstream. It should be noted here that in a case where encoding is performed on the laser radar point cloud, predictive encoding is performed on the three-dimensional coordinate information using the laser radar collection parameters, thereby further improving the encoding efficiency of the geometric information.

Furthermore, a process of the IDCM encoding will be introduced in detail below.

In a case where a current node meets the DCM encoding mode, the number numPoints of points of the current node is first encoded. The number of points of the current node is encoded based on different DirectModes.
If the current node does not meet requirements of the DCM node, the process is directly exited (that is, the number of points is greater than 2 and the points are not duplicate points).
If the number of points numPoints in the current node is less than or equal to 2, the encoding process is as follows:
   1) whether the numPoints of the current node is greater than 1 is encoded; and
   2) if the current node has only one point and the geometry encoding environment is geometry lossless encoding, it is necessary to encode that a second point of the current node is not a duplicate point.
If the number of points numPoints included in the current node is greater than 2, the encoding process is as follows:
   1) the numPoints of the current node being less than or equal to 1 is encoded; and
   2) the second point of the current node is encoded as a duplicate point, and then whether the number of duplicate points of the current node is greater than 1 is encoded; in a case where the number of the duplicate points is greater than 1, the number of remaining duplicate points needs to be decoded using exponential Golomb decoding.

After encoding the number of points in the current node, the coordinate information of the points included in the current node is encoded. The laser radar point cloud and human-eye-oriented point cloud will be introduced separately below.
I. Human-eye-oriented point cloud.
(1) If the current node includes only one point, the geometric information of the point in three-dimensions will be directly encoded (bypass coding).
(2) If the current node includes two points, the priority encoded coordinate axis dirextAxis will be first obtained using the geometric coordinates of the points. It should be noted here that the currently compared coordinate axes only include an x-axis and a y-axis, excluding a z-axis. Assuming that the geometric coordinates of the current node are nodePos, the determining manner is as follows:

$$dirextAxis = ! ( nodePos [ 0 ] < nodePos [ 1 ] )$$

That is, an axis with a smaller node coordinate geometric position will be used as the priority encoded coordinate axis dirextAxis, and then the geometric information of the priority encoded coordinate axis dirextAxis is encoded as follows. Assuming that the geometry bit depth to be encoded corresponding to the priority encoded axis is nodeSize Log 2, and assuming that the coordinates of the two points are pointPos[0] and pointPos[1], the specific encoding process is as follows:

```
  Bool sameBit=true;
  while(nodeSizeLog2&& sameBit){
    int mask=1<< nodeSizeLog2;
    --nodeSizeLog2;
    bool bit0=!!( pointPos[0]& mask)
bool bit1=!!( pointPos[1]& mask)
    sameBits=bit0==bit1;
    entropyCodeSameBit(sameBits); ///<entropy coding
    if(sameBits)
      encodePosBit(bit0);///<Bypass coding
    }
```

After encoding the priority encoded coordinate axis dirextAxis, the geometric coordinates of the current node are continued to be directly encoded. Assuming that the remaining encoding bit depth of each point is nodeSize Log 2, the specific encoding process is as follows:

for (int axisIdx=0;axisIdx<3;++axisIdx)
for (int mask=(1<< nodeSizeLog2[axisIdx])>>1;mask;mask>>1)
encodePosBit(!!(pointPos[axisIdx]&mask)).

II. Laser radar-oriented point cloud.

If the current node includes two points, the priority encoded coordinate axis dirextAxis is first obtained using the geometric coordinates of the points. Assuming that the geometric coordinates of the current node are nodePos, the determining manner is as follows:

$$dirextAxis = ! ( nodePos [ 0 ] < nodePos [ 1 ] )$$

That is, an axis with a smaller node coordinate geometric position will be used as the priority encoded coordinate axis dirextAxis. It should be noted here that the currently compared coordinate axes only include an x-axis and a y-axis, excluding a z-axis. Then, the geometric information of the priority encoded coordinate axis dirextAxis is encoded as follows. Assuming that the geometry bit depth to be encoded corresponding to the priority encoded axis is nodeSize Log 2, and assuming that the coordinates of the two points are pointPos[0] and pointPos[1], the specific encoding process is as follows:

```
  Bool sameBit=true;
  while(nodeSizeLog2&& sameBit){
    int mask=1<< nodeSizeLog2;
    --nodeSizeLog2;
    bool bit0=!!( pointPos[0]& mask)
bool bit1=!!( pointPos[1]& mask)
    sameBits=bit0==bit1;
    entropyCodeSameBit(sameBits);
    if(sameBits)
      encodePosBit(bit0);
    }
```

After encoding the priority encoded coordinate axis dirextAxis, the geometric coordinates of the current node are encoded.

Since the laser radar point cloud may obtain the collection parameters of the laser radar point cloud, and the geometric coordinate information of the current node may be predicted using the collection parameters, thereby further improving the encoding efficiency of the geometric information of the point cloud. Similarly, a directly encoded main axis direction may be first obtained using the geometric information nodePos of the current node, and then predictive encoding is performed on the geometric information in another dimension using the geometric information of the encoded direction. Also assuming that an axis direction of direct encoding is directAxis, and assuming that the bit depth to be encoded in direct encoding is nodeSize Log 2, the encoding mode is as follows:

for (int mask=(1<< nodeSizeLog2)>>1;mask;mask>>1)
encodePosBit(!!(pointPos[directAxis]&mask)).

It should be noted here that all geometric accuracy information in the directAxis direction will be encoded here.

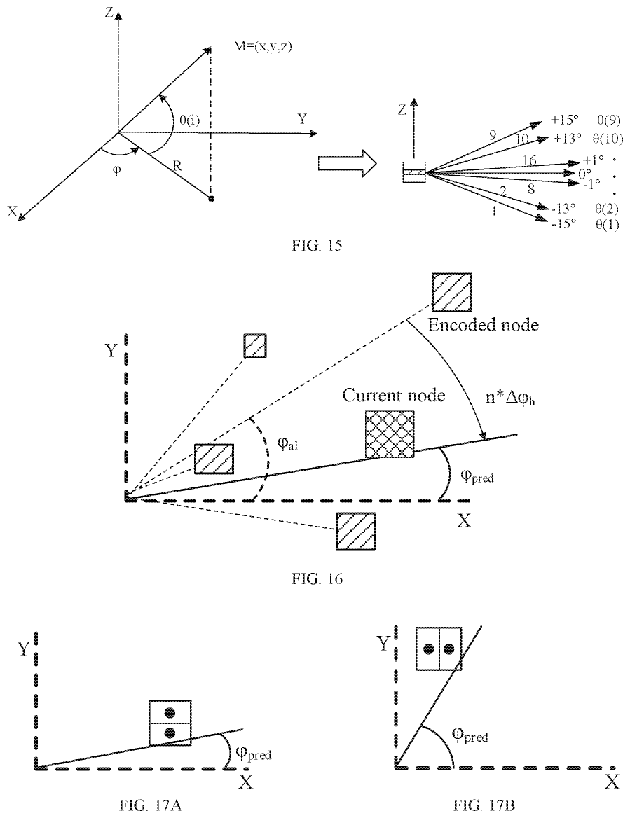

Exemplarily, FIG. 15 provides a schematic diagram of coordinate transform of a point cloud obtained by a rotating laser radar. Here, in a Cartesian coordinate system, (x, y, z) coordinates of each node may be converted into (R, φ, i). In addition, a laser scanner may perform laser scanning at a preset angle, and different θ(i) may be obtained under different values of i. For example, in a case where i is equal to 1, θ(1) may be obtained, and the corresponding scanning angle is −15°; in a case where i is equal to 2, θ(2) may be obtained, and the corresponding scanning angle is −13°; in a case where i is equal to 10, θ(10) may be obtained, and the corresponding scanning angle is +13°; and in a case where i is equal to 9, θ(19) may be obtained, and the corresponding scanning angle is +15°.

In this way, after encoding all the accuracy of the directAxis coordinate direction, the LaserIdx corresponding to the current point, that is, the pointLaserIdx number in FIG. 15, will be calculated first, and the LaserIdx of the current node, that is, nodeLaserIdx, will be calculated; secondly, predictive encoding is performed on the LaserIdx of the point (i.e., pointLaserIdx) by using the LaserIdx of the node (i.e., nodeLaserIdx). The calculation manner of the LaserIdx of the node or the point is as follows. Assuming that the geometric coordinates of the point are pointPos, starting coordinates of the laser ray are LidarOrigin, and assuming that the number of lasers is LaserNum, a tangent value of each laser is tan θ₁, and an offset position of each laser in the vertical direction is Zᵢ, then:

```
          Int bestLaserIdx=0;
          Int Distoration=INT_MAX;
      For (int LaserIdx=0; LaserIdx<numLaser;++ LaserIdx){
int radius = \sqrt{(pointPos[0] − LidarOrigin[0])² +}
\sqrt{ (pointPos[1] − LidarOrigin[1])²}
      int invRadius=1/ radius
    int Z=pointPos[2]+ Zᵢ
  int tanTheta = ZinvRadius
  if(std::abs(tanTheta−tanθᵢ)< Distoration){
          Distoration= std::abs(tanTheta−tanθᵢ);
          bestLaserIdx= LaserIdx;
          }
        }
```

After calculating the LaserIdx of the current point, predictive encoding is first performed on the pointLaserIdx of the point using the LaserIdx of the current node. After encoding the LaserIdx of the current point, predictive encoding is performed on the three-dimensional geometric information of the current point using the parameters collected by the laser radar.

Exemplarily, FIG. 16 illustrates a schematic diagram of predictive encoding in an X-axis or a Y-axis direction. As illustrated in FIG. 16, a box filled with grids represents a current node, and a box filled with diagonal lines represents an already coded node. Here, a corresponding prediction value of a horizontal azimuth angle, that is, φ_{pred}, is first obtained using the LaserIdx corresponding to the current point; secondly, the horizontal azimuth angle φ_{node} corresponding to the node is obtained using the node geometric information corresponding to the current point. Assuming that the geometric coordinates of the node are nodePos, the calculation manner between the horizontal azimuth angle φ and the geometric information of the node is as follows:

$$φ = arctan ( nodePos [ 1 ] / nodePos [ 0 ] )$$

Using the collection parameters of the laser radar, the number of rotation points numPoints of each laser is obtained, which represents the number of points obtained in a case where each laser ray rotates one circle. The rotation angular velocity deltaPhi of each laser may then be calculated using the number of rotation points of each laser, where the calculation manner is as follows:

$$deltaPhi = \frac{2 π}{numPoints}$$

Furthermore, a prediction value φ_{predPoint} of the horizontal azimuth angle corresponding to the current point is calculated using the horizontal azimuth angle φ_{node} of the node and the horizontal azimuth angle φ_{pred} of the previous laser encoding point corresponding to the current point, that is, the prediction value of the horizontal azimuth angle as illustrated in FIGS. 17A and 17B. FIG. 17A illustrates a schematic diagram of an angle of the Y plane predicted by the horizontal azimuth angle, and FIG. 17B illustrates a schematic diagram of an angle of the X plane predicted by the horizontal azimuth angle. Here, the prediction value φ_{predPoint} of the horizontal azimuth angle corresponding to the current point is calculated as follows:

$${φ}_{predPoint} = \frac{φ pred - φnode}{deltaPhi} \times deltaPhi + φ pred$$

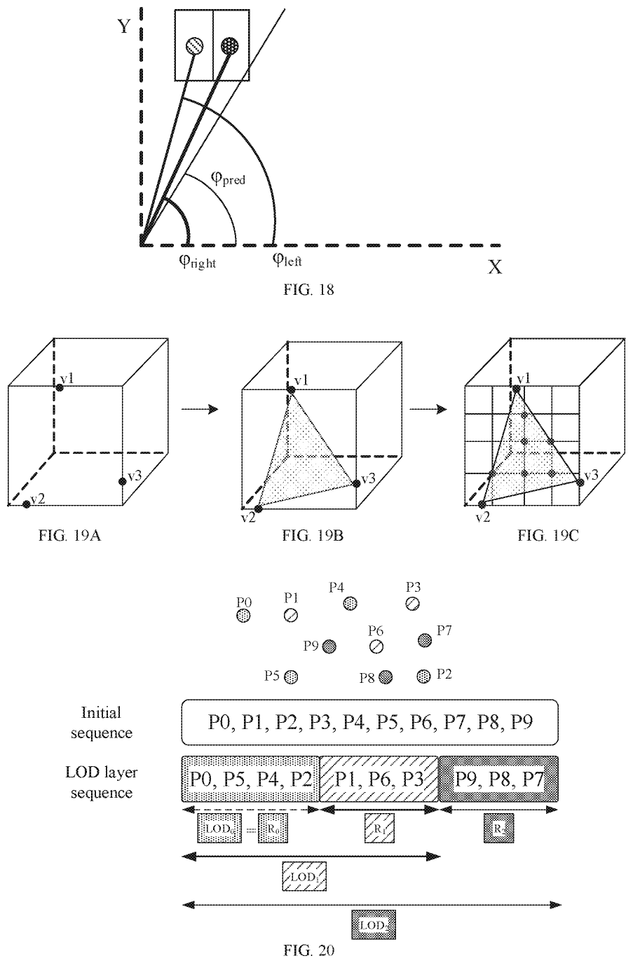

Exemplarily, FIG. 18 illustrates another schematic diagram of predictive encoding in the X-axis or Y-axis direction. As illustrated in FIG. 18, a part filled with grids (i.e., the left side) represents a low plane, a part filled with points (i.e., the right side) represents a high plane, φ_{left} represents a low plane horizontal azimuth angle of the current node, φ_{right} represents a high plane horizontal azimuth angle of the current node, and φ_{predPoint} represents the prediction value of the horizontal azimuth angle corresponding to the current node.

In this way, predictive encoding is performed on the geometric information of the current node using the prediction value φ_{predPoint} of the horizontal azimuth angle, the low plane horizontal azimuth angle φ_{left} and the high plane horizontal azimuth angle φ_{right} of the current node. The details are as follows:

$$int angLel = {φ}_{left} - {φ}_{pred} ;$$

$$int angLeR = {φ}_{right} - {φ}_{pred} ;$$

$$int context = ( angLel \geq 0 \&\& angLeR \geq 0 ) ‖ ( angLel < 0 \&\& angLeR < 0 ) ? 0 : 2 ;$$

$$int min Angle = std \text{::} min ( abs ( angLel ) , abs ( angLeR ) ) ;$$

$$int max Angle = std \text{::} max ( abs ( angLel ) , abs ( angLeR ) ) ;$$

$$context += max Angle > min Angle ? 0 : 1 ;$$

$$context += max Angle > min Angle ? 0 : 4.$$

After encoding the LaserIdx of the point, predictive encoding is performed on the Z-axis direction of the current point using the LaserIdx corresponding to the current point. That is, the depth information radius of the radar coordinate system is calculated using the x and y information of the current point. Then, a tangent value of the current point and an offset in the vertical direction are obtained using the laser LaserIdx of the current point. The prediction value of the Z-axis direction of the current point, namely Z_pred, may be obtained. The details are as follows:

$$int radius = \sqrt{{( pointPos [ 0 ] - LidarOrigin [ 0 ] )}^{2} + {( pointPos [ 1 ] - LidarOrigin [ 1 ] )}^{2}} ;$$

$$int tan Theta = tan {θ}_{laserIdx} ;$$

$$int zOffset = {Z}_{laserIdx} ;$$

$$Z\_pred = radius \times tan Theta - zOffset .$$

Furthermore, Z_pred is used to perform predictive encoding on the geometric information of the current point in the Z-axis direction to obtain the prediction residual Z_res, and finally Z_res is encoded.

It should be noted that as the node partitioning proceeds to leaf nodes, the number of duplicate points in the leaf nodes needs to be encoded in a case of geometry lossless encoding. Then, placeholder information of all nodes is encoded to generate a binary bitstream. In addition, a planar encoding mode is currently introduced in G-PCC. In a process of geometric partitioning, whether child nodes of the current node are located in the same plane will be determined; and if the child nodes of the current node meet the condition of being in the same plane, the child nodes of the current node will be represented by the plane.

For the octree-based geometry decoding, before decoding the placeholder information of each node, a decoding side will first determine, in the order of breadth-first traversal, whether to perform planar decoding or IDCM decoding on the current node using the reconstructed geometric information. If the current node meets a condition for the planar decoding, the decoding side will decode the planar flag information and the plane position information of the current node, and then decode the placeholder information of the current node based on the planar information. If the current node meets a condition for the IDCM decoding, the decoding side will decode whether the current node is a true IDCM node; and if the current node is a true IDCM node, the decoding side will continue to parse the DCM decoding mode of the current node, and then the decoding side may obtain the number of points in the current DCM node and finally decode the geometric information of each point. For a node that does not meet either the planar decoding or the DCM decoding, the placeholder information of the current node will be decoded. By continuously parsing in this manner, a placeholder code of each node is obtained, and the partitioning is continued for the nodes in turn until a unit cube of 1×1×1 is obtained. The number of points included in each leaf node is parsed, and geometric reconstruction point cloud information is restored finally.

A process of the IDCM decoding will be introduced in detail.

Similar to the processing at the encoding end, firstly, whether the node starts IDCM is decided using prior information. That is, starting conditions of IDCM are as follows.
(1) The current node has no sibling child nodes. That is, the parent node of the current node has only one child node, and a parent node of the parent node of the current node has only two occupied child nodes. That is, the current node has at most one neighboring node.
(2) The parent node of the current node has only one occupied child node (i.e., the current node), and six neighboring nodes sharing a face with the current node also belong to empty nodes.
(3) The number of sibling nodes of the current node is greater than 1.

Furthermore, in a case where the current node meets a condition for DCM encoding, whether the current node is a true DCM node, that is, IDCM_flag, is first decoded. In a case where IDCM_flag is true, the DCM encoding is performed on the current node; otherwise, the octree encoding is still performed.

Next, the number of points numPoints of the current node is decoded. The specific decoding mode is as follows.
i) First, whether the numPoints of the current node is greater than 1 is decoded;
ii) If the decoded numPoints of the current node is greater than 1, whether the second point is a duplicate point is further decoded. If the second point is not a duplicate point, it may be implicitly inferred that the second case of the DCM mode is met, where only two points are included.
iii) If the decoded numPoints of the current node is less than or equal to 1, whether the second point is a duplicate point is further decoded. If the second point is not a duplicate point, it may be implicitly inferred that the second case of the DCM mode is met, where only one point is contained. If the decoded second point is a duplicate point, it may be inferred that the third case of the DCM mode is met, where a plurality of points are contained, but they are all duplicate points. Then, whether the number of duplicate points is greater than 1 (entropy decoding) is further decoded, and if it is greater than 1, the number of remaining duplicate points is further decoded (decoded using exponential Golomb).

If the current node does not meet the requirements of the DCM node, the process is directly exited (that is, the number of points is greater than 2 and the points are not duplicate points).

After decoding the number of points in the current node, the coordinate information of the points included in the current node is decoded. The laser radar point cloud and the human-eye-oriented point cloud will be introduced separately below.

I. Human-eye-oriented point cloud.
(1) If the current node contains only one point, the geometric information of the point in the three-dimensions will be directly decoded (bypass coding).
(2) If the current node includes two points, the priority decoded coordinate axis dirextAxis will be first obtained using the geometric coordinates of the points. It should be noted here that the currently compared coordinate axes only include the x-axis and the y-axis, excluding the z-axis. Assuming that the geometric coordinates of the current node are nodePos, the determining manner is as follows:

$$dirextAxis = ! ( nodePos [ 0 ] < nodePos [ 1 ] )$$

That is, an axis with a smaller node coordinate geometric position is used as the priority decoded coordinate axis dirextAxis, and then the geometric information of the priority decoded coordinate axis dirextAxis is decoded as follows. Assuming that the geometry bit depth to be decoded corresponding to the priority decoded axis is nodeSize Log 2, and assuming that the coordinates of the two points are pointPos[0] and pointPos[1], respectively, the specific encoding process is as follows:

```
Bool sameBit=true;
while(nodeSizeLog2&& sameBit){
  pointPos[0][ dirextAxis]<<1;
  pointPos[1][ dirextAxis]<<1;
  --nodeSizeLog2;
      int bit=0;
      deEntropyCodeSameBit(sameBits); ///<entropy coding
      if(sameBits){
        bit =decodePosBit( );///<Bypass coding
        pointPos[0][ dirextAxis]|= bit
          pointPos[1][ dirextAxis]|= bit
      }else
        pointPos[1][dirextAxis]|= 1///<The reason here is that in a case of
      encoding, the two points will be sorted in the direction of the priority
      encoded axis, and thus it may be guaranteed that pointPos[0][dirextAxis]<
      pointPos[1][dirextAxis]. Therefore, in a case of decoding, if the two points
      have different bit information, it may be inferred that the bit of the first point
      is 0 and the bit of the second point is 1.
    }
```

After decoding the priority coordinate axis dirextAxis, the geometric coordinates of the current point are directly decoded. Assuming that the remaining encoding bit depth of each point is nodeSize Log 2, and assuming that the coordinate information of the point is pointPos, the specific decoding process is as follows:

```
for(int axisIdx=0;axisIdx<3;++axisIdx)
for(int idx= nodeSizeLog2[axisIdx]; idx; idx--){
  pointPos[axisIdx]<<1;
  pointPos[axisIdx]|=decodePosBit( );
  }
```

II. Laser radar-oriented point cloud.

If the current node includes two points, the priority decoding axis dirextAxis is first obtained using the geometric coordinates of the points. Assuming that the geometric coordinates of the current node are nodePos, the determining manner is as follows:

$$dirextAxis = ! ( nodePos [ 0 ] < nodePos [ 1 ] ) \qquad ( 11 )$$

That is, an axis with a smaller node coordinate geometric position is used as the priority decoded coordinate axis dirextAxis. It should be noted here that the currently compared coordinate axes only include the x-axis and the y-axis, excluding the z-axis. Then, the geometric information of the priority encoded coordinate axis dirextAxis is decoded as follows. Assuming that the geometry bit depth to be encoded corresponding to the priority decoded axis is nodeSize Log 2, and assuming that the coordinates of the two points are pointPos[0] and pointPos[1], respectively, the specific encoding process is as follows:

```
Bool sameBit=true;
while(nodeSizeLog2&& sameBit){
  pointPos[0][dirextAxis]<<1;
  pointPos[1][dirextAxis]<<1;
      --nodeSizeLog2;
      int bit=0;
      deEntropyCodeSameBit(sameBits); ///<entropy coding
      if(sameBits){
        bit =decodePosBit( );///<Bypass coding
        pointPos[0][ dirextAxis]|= bit
          pointPos[1][ dirextAxis]|= bit
      }else
        pointPos[1][dirextAxis]|= 1///<The reason here is that in a case of
      encoding, the two points will be sorted in the direction of the priority
      encoded axis, and thus it may be guaranteed that pointPos[0][dirextAxis]<
      pointPos[1][dirextAxis]. Therefore, in a case of decoding, if the two points
      have different bit information, it may be inferred that the bit of the first point
      is 0 and the bit of the second point is 1.
    }
```

After decoding the priority coordinate axis dirextAxis, the geometric coordinates of the current point are decoded.

Similarly, a directly decoded main axis direction may be first obtained using the geometric information nodePos of the current node, and then the geometric information in another dimension is decoded using the geometric information of the decoded direction. Also assuming that an axis direction of direct decoding is directAxis, and assuming that the bit depth to be decoded in direct decoding is nodeSize Log 2, the decoding mode is as follows:

```
for(int idx= nodeSizeLog2[directAxis]; idx; idx--){
  pointPos[directAxis]<<1;
  pointPos[directAxis]|=decodePosBit( );
  }
```

It should be noted here that all geometric accuracy information in the directAxis direction will be decoded here.

After decoding all the accuracy of the directAxis coordinate direction, the LaserIdx of the current node, i.e., nodeLaserIdx, is calculated first. Secondly, predictive decoding is performed on the LaserIdx of the point, i.e., pointLaserIdx, by using the LaserIdx of the node, i.e., nodeLaserIdx.

The calculation manner of the LaserIdx of the node or point is the same as that of the encoding side. Finally, prediction residual information between the LaserIdx of the current point and the LaserIdx of the node is decoded to obtain ResLaserIdx. The decoding mode is as follows:

$$PointLaserIdx = nodeLaserIdx + ResLaserIdx$$

After decoding the LaserIdx of the current point, predictive decoding is performed on the three-dimensional geometric information of the current point using the parameters collected by the laser radar. The specific algorithm is as follows.

As illustrated in FIG. 11A to FIG. 11C, the corresponding prediction value of the horizontal azimuth angle, i.e., φ_{pred}, is first obtained using the LaserIdx corresponding to the current point. Then, the horizontal azimuth angle φ_{node} corresponding to the node is obtained using the node geometric information corresponding to the current point. Assuming that the geometric coordinates of the node are nodePos, the calculation manner between the horizontal azimuth angle φ and the geometric information of the node is as follows:

$$φ = arctan ( nodePos [ 1 ] / nodePos [ 0 ] )$$

Using the collection parameters of the laser radar, the number of rotation points numPoints of each laser may be obtained, which represents the number of points obtained in a case where each laser ray rotates one circle. Then, the rotation angular velocity deltaPhi of each laser may be calculated using the number of rotation points of each laser. The calculation manner is as follows:

$$deltaPhi = \frac{2 π}{numPoints}$$

Furthermore, the prediction value φ_{predPoint} of the horizontal azimuth angle corresponding to the current point is calculated using the horizontal azimuth angle φ_{node} of the node and the horizontal azimuth angle φ_{pred} of the previous Laser encoding point corresponding to the current point, that is, the prediction value of the horizontal azimuth angle as illustrated in FIGS. 17A and 17B. The calculation is as follows:

$${φ}_{predPoint} = \frac{φ pred - φnode}{deltaPhi} \times deltaPhi + φ pred$$

In this way, predictive encoding is performed on the geometric information of the current node using the prediction value φ_{predPoint} of the horizontal azimuth angle, the low plane horizontal azimuth angle φ_{left} and the high plane horizontal azimuth angle φ_{right} of the current node. The details are as follows:

$$int angLel = {φ}_{left} - {φ}_{predPoint} ;$$

$$int angLeR = {φ}_{right} - {φ}_{predPoint} ;$$

$$int context = ( angLel \geq 0 \&\& angLeR \geq 0 ) ‖ ( angLel < 0 \&\& angLeR < 0 ) ? 0 : 2 ;$$

$$int abs AngleL = abs ( angLel ) ;$$

$$int abs AngleR = abs ( angLeR ) ;$$

$$context += abs AngleL > abs AngleR ? 0 : 1 ;$$

$$context += max Angle > min Angle ≪ 1 ? 4 : 0.$$

After decoding the LaserIdx of the point, predictive decoding is performed on the z-axis direction of the current point using the LaserIdx corresponding to the current point. That is, the depth information radius of the radar coordinate system is calculated using the x and y information of the current point. Then, the tangent value of the current point and the offset in the vertical direction are obtained using the laser LaserIdx of the current point, and the prediction value of the z-axis direction of the current point, namely Z_pred, may be obtained. The details are as follows:

$$int radius = \sqrt{{( pointPos [ 0 ] - LidarOrigin [ 0 ] )}^{2} + {( pointPos [ 1 ] - LidarOrigin [ 1 ] )}^{2}} ;$$

$$int tan Theta = tan {θ}_{laserIdx} ;$$

$$int zOffset = {Z}_{laserIdx} ;$$

$$Z\_pred = tan Theta - zOffset .$$

Furthermore, the decoded Z_res and Z_pred are used to reconstruct and restore the geometric information of the current point in the z-axis direction.

For geometric information encoding based on triangle soup (trisoup), in a geometric information encoding architecture based on the trisoup, similarly, geometric partitioning is also performed first. However, unlike the binary tree/quadtree/octree-based geometric information encoding, this method does not need to partition the point cloud into unit cubes with a side length of 1×1×1 step by step, but stops partitioning once there exist sub-blocks (blocks) with a side length of W. Based on a surface formed in each block by the distribution of the point cloud, at most twelve intersections (vertices) generated by this surface and twelve sides of the block are obtained.

Vertex coordinates of each block are encoded in turn to generate a binary bitstream.

For reconstruction of geometric information of the point cloud based on the trisoup, in a case of performing reconstruction of the geometric information of the point cloud, the decoding side first decodes the vertex coordinates to complete triangle soup reconstruction, a process of which is illustrated in FIGS. 19A, 19B and 19C. There are three vertices (v1, v2, v3) in a block illustrated in FIG. 19A, and the triangle soup, i.e., trisoup, formed by these three in a certain order is illustrated in FIG. 19B. Afterwards, sampling is performed on the triangle soup, and the obtained sampling points are used as a reconstructed point cloud within the block, as illustrated in FIG. 19C.

For geometry encoding based on the prediction tree (i.e., predictive geometry encoding or predictive geometry coding, PredGeomTree), the geometry encoding based on the prediction tree includes steps as follows. First, an input point cloud is sorted, and the sorting methods currently used include disorder, Morton order, azimuth order and radial distance order. An encoding side establishes a prediction tree structure using two different manners, which include: a high-latency slow mode (KD-Tree) and a low-latency fast mode (using laser radar calibration information). In a case of using the laser radar calibration information, each point is assigned into a different laser, and a prediction tree structure is established based on different lasers. Next, each node in the prediction tree is traversed based on the prediction tree structure, the geometric position information of the node is predicted by selecting different prediction modes to obtain a prediction residual, and the geometric prediction residual is quantized using a quantization parameter. Then, the prediction residual of the position information of the nodes in the prediction tree, the prediction tree structure and the quantization parameter are encoded through continuous iteration to generate a binary bitstream.

For geometry decoding based on the prediction tree, the decoding side reconstructs the prediction tree structure through continuously parsing the bitstream, then obtains the prediction residual information of the geometric position and a quantization parameter of each prediction node through parsing, and performs inverse quantization on the prediction residual for recovering, so as to obtain the reconstructed geometric position information of each node, and thus completes the geometric reconstruction on the decoding side.

The geometric information is reconstructed after the geometry encoding is completed. Currently, attribute encoding is mainly performed on color information. First, the color information is transformed from an RGB color space to a YUV color space. The point cloud is then recolored using the reconstructed geometric information to enable unencoded attribute information to correspond to the reconstructed geometric information. In color information encoding, there are two main transform manners: one is distance-based lifting transform that relies on LOD (level of detail) partitioning, and the other is a direct RAHT. Both manners may transform the color information from a spatial domain to a frequency domain, a high-frequency coefficient and a low-frequency coefficient are obtained through the transform, and then the coefficients are quantized and encoded to generate a binary bitstream, which is illustrated in FIGS. 4A and 4B.

Furthermore, in a case where the attribute information is predicted using the geometric information, Morton codes may be used for performing nearest-neighbor search, where a Morton code corresponding to each point in the point cloud may be obtained based on the geometric coordinates of this point. A method for calculating the Morton code is described as follows. For three-dimensional coordinates with each component represented by a d-bit binary value, the three components may be expressed as:

$$x = {\sum }_{ℓ = 1}^{d} {2}^{d - ℓ} {x}_{ℓ} , y = {\sum }_{ℓ = 1}^{d} {2}^{d - ℓ} {y}_{ℓ} , z = {\sum }_{ℓ = 1}^{d} {2}^{d - ℓ} {z}_{ℓ}$$

Here, [symbol] , [symbol] , [symbol] ∈{0,1} are binary values corresponding to bits, from the highest ( [symbol] =1) to the lowest ( [symbol] =d), of x, y, z, respectively. Morton code M is a method for x, y, z to perform crosswise arrangement in sequence on [symbol] , [symbol] , [symbol] starting from the highest bit to the lowest bit. The calculation formula of M is as follows:

$$M = {\sum }_{ℓ = 1}^{d} {2}^{3 ( d - ℓ )} ( 4 {x}_{ℓ} + 2 {y}_{ℓ} + {z}_{ℓ} ) = {\sum }_{{ℓ}^{′} = 1}^{3 d} {2}^{3 d - {ℓ}^{′}} {m}_{{ℓ}^{′}}$$

Here, [symbol] ∈{0,1} are values of M from the highest bit ( [symbol] =1) to the lowest bit ( [symbol] =3d), respectively. After the Morton code M of each point in the point cloud is obtained, the points in the point cloud are arranged in order of Morton code from small to large, and a weight w of each point is set to 1.

It may also be understood that for the G-PCC encoding and decoding framework, the general test conditions are as follows.
(1) There are 4 test conditions:
   condition 1: the geometric position being limitedly lossy, and the attributes being lossy;
   condition 2: the geometric position being lossless, and the attributes being lossy;
   condition 3: the geometric position being lossless, and the attributes being limitedly lossy; and
   condition 4: the geometric position being lossless, and the attributes being lossless.
(2) General test sequences include four types: Cat1A, Cat1B, Cat3-fused and Cat3-frame, where Cat2-frame point cloud includes only reflectance attribute information, Cat1A point cloud and Cat1B point cloud include only color attribute information, and Cat3-fused point cloud includes both the color attribute information and the reflectance attribute information.
(3) There are 2 technical routes in total, which are classified by the algorithm used for geometric compression.

Technical route 1: octree encoding branch.

At the encoding side, a bounding box is continuously partitioned into sub-cubes; and a non-empty sub-cube (including points in the point cloud) are continued to be partitioned until leaf nodes obtained by partitioning are unit cubes of 1×1×1. In a case of geometry lossless encoding, the number of points included in the leaf node needs to be encoded to complete the encoding of the geometric octree and generate the binary bitstream.

At the decoding side, the decoding side obtains, in the order of breadth-first traversal, a placeholder code of each node by continuous parsing, and the partitioning is continued for the nodes in turn until unit cubes of 1×1×1 are obtained. In a case of geometry lossless decoding, the number of points included in each leaf node needs to be parsed, and the geometric reconstruction point cloud information is restored finally.

Technical route 2: prediction tree encoding branch.

At the encoding side, the prediction tree structure is established using two different manners, which include: a manner based on a KD-Tree (high-latency slow mode) and a manner using laser radar calibration information (low-latency fast mode). Each point may be assigned into a different laser using laser radar calibration information, and the prediction tree structure is established based on different lasers. Next, each node in the prediction tree is traversed based on the prediction tree structure, the geometric position information of the node is predicted by selecting different prediction modes to obtain the prediction residual, and the geometric prediction residual is quantized using the quantization parameter. Then, the prediction residual of the position information of the nodes in the prediction tree, the prediction tree structure and the quantization parameter are encoded through continuous iteration to generate a binary bitstream.

At the decoding side, the decoding side reconstructs the prediction tree structure through continuously parsing the bitstream, then obtains the prediction residual information of the geometric position and a quantization parameter of each prediction node through parsing, and performs inverse quantization on the prediction residual for recovering, so as to obtain the reconstructed geometric position information of each node, and thus completes the geometric reconstruction on the decoding side.

It should also be noted that, as illustrated in FIG. 4A or FIG. 4B, the current G-PCC encoding framework includes three attribute encoding methods: predicting transform (PT), lifting transform (LT), and region adaptive hierarchal transform (RAHT). The first two methods perform predictive encoding on point clouds based on the generation order of LOD, and the RAHT performs adaptive transform on the attribute information from bottom to top based on the construction hierarchy of the octree. These three point cloud attribute encoding methods will be explained in details separately below.
(a) Predictive encoding of the attribute information of the point cloud.

The current attribute prediction module of G-PCC uses a nearest-neighbor attribute predictive encoding scheme based on a level-of-details (LoD) structure. The LOD construction methods include a distance-based LOD construction scheme, a fixed sampling rate-based LOD construction scheme, and an octree-based LOD construction scheme. In the distance-based LOD construction scheme, the point cloud is first Morton sorted before constructing LOD to ensure that there is a strong attribute correlation between adjacent points. FIG. 20 is a schematic diagram of a distance-based LOD construction process. As illustrated in FIG. 20, the point clouds are partitioned into L different point cloud layers of detail (Rl) l=0, 1, . . . L−1 based on L Manhattan distances (dl) l=0, 1, . . . L−1 preset by the user, where (dl) l=0, 1, . . . L−1 meets that dl is less than dl−1. The construction process of LOD is as follows.
(1) First, all points in the point cloud are marked as unvisited, and a set V is established to store the visited point set. (2) For each iteration 1, points in the point cloud are traversed; if the current point has been visited, the current point is skipped, otherwise the minimum distance D from the current point to the point set V is calculated; and if D is less than dl, the point is skipped, otherwise the current point is marked as visited and the current point is added to the layers of detail RI and the point set V. (3) The points in the level of detail LODl are composed of points in the layers of detail R0, R1, R2 . . . Rl. (4) The above steps are repeated until all points have been marked as visited.

Based on the LOD structure, an attribute value of each point is linearly weighted predicted using the reconstructed attribute value of the point in the same or higher LOD layer, where the maximum number of reference prediction neighbors is determined based on the encoder high-level syntax elements. For the attribute of each point, the rate-distortion optimization algorithm is used at the encoding side to select attributes of N nearest-neighbor points searched for weighted prediction or select attributes of a single nearest-neighbor point for prediction, and finally the selected prediction mode and prediction residual are encoded.

$${{Attr}_{i}}^{′} = Round ( \frac{1}{N} {\sum }_{m ∈ {p}_{i}} \frac{\frac{1}{{D}_{m}^{2}}}{{\sum }_{m ∈ {p}_{i}} \frac{1}{{D}_{m}^{2}}} {Attr}_{m} )$$

Here, N represents the number of prediction points in the nearest-neighbor point set of point i, Pᵢ represents a sum of the N nearest-neighbor points of point i, Dₘ represents a spatial geometric distance from the nearest-neighbor point m to the current point i, Attrₘ represents the attribute value of the nearest-neighbor point m after reconstruction, Attrᵢ′ represents the attribute prediction value of the current point i, and the number of points N is a preset value.

In order to balance attribute encoding efficiency and parallel processing between different LOD layers, a switch is introduced in the encoder high-level syntax element to control whether to introduce LOD intra-layer prediction. If the switch is turned on, LOD intra-layer prediction is enabled, and points within the same LOD layer may be used for prediction. It should be noted that in a case where the number of LOD layers is 1, LOD intra-layer prediction is always used.

FIG. 21 is a schematic diagram of a visualization result of an LOD generation process. As illustrated in FIG. 21, a subjective example of the distance-based LOD generation process is provided here. Specifically (from left to right), the points in the first layer represent an outer contour of the point cloud; as the number of LOD layers increases, the detail description of the point cloud gradually becomes clearer.

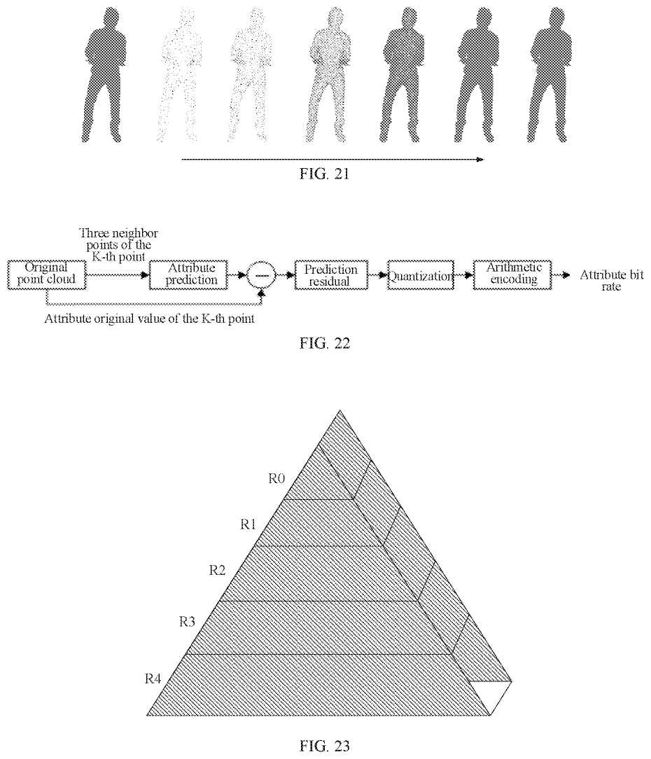

FIG. 22 is a schematic diagram of an encoding process for attribute prediction. As illustrated in FIG. 22, for the specific process of G-PCC attribute prediction, for an original point cloud, three neighbor points of the K-th point are searched, and then the attribute prediction is performed; a difference between an attribute prediction value of the K-th point and an attribute original value of the K-th point is calculated to obtain a prediction residual of the K-th point; and then quantization and arithmetic encoding are performed to finally generate an attribute bit rate.
(i) Optimal prediction value selection.

After the LOD is constructed, the three nearest-neighbor points of the current point to be encoded are first found from the encoded data points based on the generation order of the LOD. The attribute reconstructed values of the three nearest-neighbor points are used as candidate prediction values of the current point to be encoded; then, an optimal prediction value is selected from the attribute reconstructed values of the three nearest-neighbor points based on the rate-distortion optimization (RDO). For example, in a case of encoding an attribute value of the point P2 in FIG. 20, a prediction variable index of an attribute value of the nearest-neighboring point P4 is set to 1; attribute prediction variable indexes of the second nearest-neighboring point P5 and the third nearest-neighboring point P0 are set to 2 and 3, respectively; and a prediction variable index of a weighted average of the points P0, P5 and P4 is set to 0, as shown in Table 1; finally, the optimal prediction variable is selected using the RDO. The formula of the weighted average is as follows:

$${\hat{a}}_{i} = Round ( {\sum }_{j = 0}^{2} \frac{{\tilde{w}}_{ij}}{{\sum }_{j = 0}^{2} {\tilde{w}}_{ij}} {\tilde{a}}_{j} )$$

Here, \tilde{w}ᵢⱼ represents the spatial geometric weight from the neighbor point j to the current point i.

$${\tilde{w}}_{ij} = \frac{1}{{( {x}_{i} - {x}_{ij} )}^{2} + {( {y}_{i} - {y}_{ij} )}^{2} + {( {z}_{i} - {z}_{ij} )}^{2}}$$

Here, \hat{α}ᵢ represents the attribute prediction value of the current point i, j represents the indexes of the three neighbor points, ãⱼ represents the attribute value of the neighbor point after reconstruction, xᵢ, yᵢ, zᵢ are the geometric position coordinates of the current point i, and xᵢⱼ, yᵢⱼ, ziⱼ are the geometric coordinates of the neighbor point j.

For example, Table 1 provides an example of candidate prediction item samples for the attribute encoding.

TABLE 1

| Prediction | |
|---|---|
| mode | Prediction value |
| 0 | Weighted average of attributes of three neighbor |
| 1 | P4 (an attribute value of the first neighboring point) |
| 2 | P5 (an attribute value of the second neighboring point) |
| 3 | P0 (an attribute value of the third neighboring point) |

(ii) Attribute prediction residual and quantification.

Through the above prediction, the attribute prediction value (\hat{α}ᵢ)_{i∈0 . . . k-1} (where k represents a total number of points in the point cloud) of the current point i is obtained. Denoting an original attribute value of the current point by (aᵢ)_{i∈0 . . . k-1}, the attribute residual (rᵢ)_{i∈0 . . . k-1} is denoted as:

$${r}_{i} = {a}_{i} - {\hat{a}}_{i}$$

Furthermore, the prediction residual is quantified:

$${Q}_{i} = \frac{{r}_{i}}{Qs}$$

Here, Qᵢ represents the quantized attribute residual of the current point i, and Qs represents the quantization step, which may be calculated according to the quantization parameter (QP) specified by CTC.
(iii) Reconstruction of the attribute value at the encoding side.

The purpose of reconstruction at the encoding side is to predict subsequent points. Before the reconstruction of the attribute value, inverse quantization needs to be performed on the residual, \hat{r}ᵢ is denoted as the residual after inverse quantization:

$${\hat{r}}_{i} = {Q}_{i} \times Qs$$

The reconstructed value ãᵢ of the point i is obtained by adding \hat{r}ᵢ to the prediction value âᵢ:

$${\tilde{a}}_{i} = {\hat{r}}_{i} + {\hat{a}}_{i}$$

In a case of performing attribute nearest-neighbor search based on LOD partition, there are currently two major types of algorithms: intra nearest-neighbor search and inter nearest-neighbor search. The specific algorithm for the inter nearest-neighbor search is as follows. The intra nearest-neighbor search is partitioned into two algorithms: inter-layer nearest-neighbor search and intra-layer nearest-neighbor search.
(i) Intra nearest-neighbor search.

Intra nearest-neighbor search is classified into two algorithms: inter-layer nearest-neighbor search and intra-layer nearest-neighbor search. After LOD partitioning, a pyramid structure similar to that illustrated in FIG. 23 is obtained.

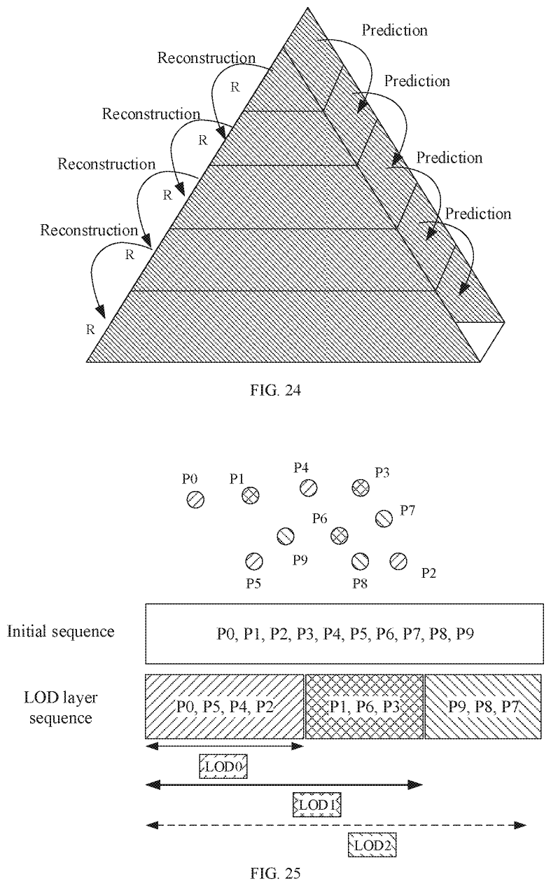

In an implementation, for the inter-layer nearest-neighbor search, the pyramid structure is illustrated in FIG. 24. FIG. 25 is a schematic diagram of an LOD construction process for inter-layer nearest-neighbor search. As illustrated in FIG. 25, different LOD layers are obtained based on geometric information partition, namely LOD0, LOD1 and LOD2. The points in LOD0 are used to predict attributes of points in a next LOD layer during the process of the inter-layer nearest-neighbor search.

The entire process of the intra nearest-neighbor search will be described in detail below.

In the entire LOD partition process, there are three sets O(k), L(k) and I(k). Here, k is an index of the LOD layer during LOD partition, I(k) is an input point set during the current LOD layer partition, and after LOD partition, the O(k) set and the L(k) set are obtained. The O(k) set stores the sampling point set, and the L(k) is a point set in the current LOD layer. That is, the entire LOD partition process is as follows:
(1) initialization;

$$if k = 0 , ( k ) ← \{ \} ; otherwise , L ( k ) ← L ( k - 1 ) ;$$

$$O ( k ) ← \{ \} ;$$

(2) the sampling points are stored in O(k) using the LOD partitioning algorithm, and the remaining points are partitioned into L(k); and
(3) in a case where the next iteration is performed, I←O(k).

It should be noted here that since the entire LOD partition process is based on the Morton code, O(k), L(k) and I(k) store the Morton code indexes corresponding to the points.

In a case of performing the inter-layer nearest-neighbor search, that is, the nearest-neighbor search is performed on the points in the L(k) set in the O(k) set. The specific search algorithm is as follows.

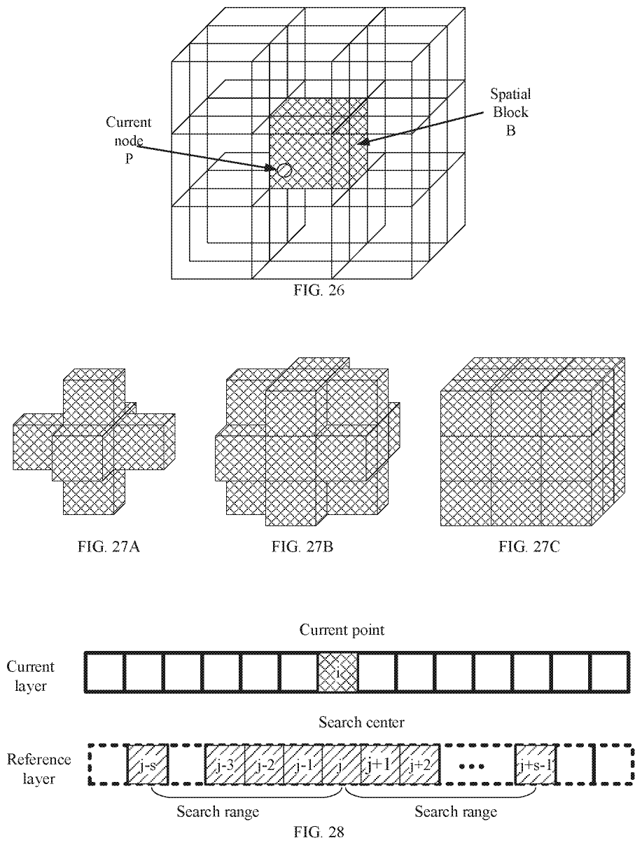

Taking the nearest-neighbor search based on spatial relationships as an example, in a case of predicting the current point P, the neighbor search is performed using a parent block (Block B) corresponding to the point P. As illustrated in FIG. 26, points in the neighbor blocks that are co-plane or co-edge with the current parent block are searched for attribute prediction.

FIG. 27A illustrates a schematic diagram of a co-plane spatial relationship, where there are a total of 6 spatial blocks that have relationships with the current parent block. FIG. 27B illustrates a schematic diagram of a co-plane and co-edge spatial relationship, where there are a total of 18 spatial blocks that have relationships with the current parent block. FIG. 27C illustrates a schematic diagram of a co-plane, co-edge and co-point spatial relationship, where there are a total of 26 spatial blocks that have relationships with the current parent block.

Firstly, the corresponding spatial block is obtained using the coordinates of the current point. Secondly, the nearest-neighbor search is performed in the previously encoded LOD layer to find the spatial blocks that are co-plane, co-edge and co-point with the current block, so as to obtain the N nearest-neighbors of the current point.

After performing the co-plane, co-edge and co-point nearest-neighbor searche, if the N nearest-neighbors of the current point are still not found, the N nearest-neighbors of the current point will be obtained based on a fast search algorithm. The specific algorithm is as follows.

As illustrated in FIG. 28, in a case of performing inter-layer prediction of attribute, the Morton code corresponding to the current point are first obtained using the geometric coordinates of the current point to be encoded, and then the first reference point ( ) with a Morton code greater than that of the current point is found in the reference picture based on the Morton code of the current point. Then, the nearest-neighbor search is performed within a range of [j-searchRange, j+searchRange].

Other specific algorithms for updating the nearest-neighbors are the same as the inter nearest-neighbor search algorithm and will not be described in detail here. The specific algorithms will be mentioned in the inter nearest-neighbor search algorithm.

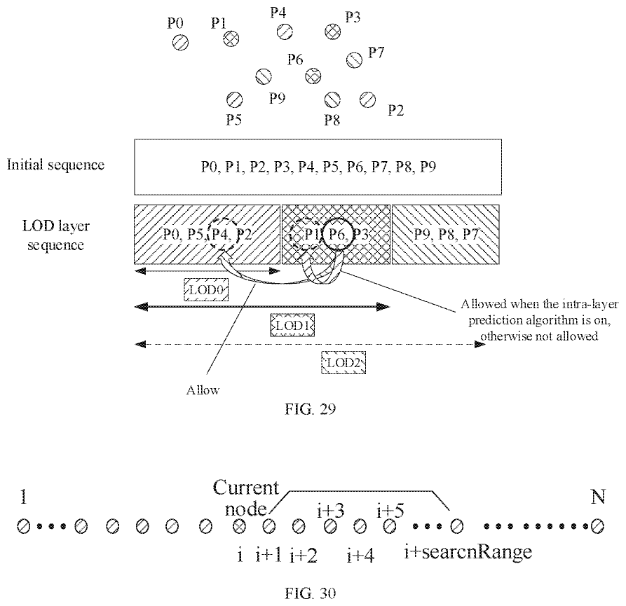

In another implementation, for the intra-layer nearest-neighbor search, FIG. 29 illustrates a schematic diagram of an LOD structure of the intra-layer nearest-neighbor search of attribute. As illustrated in FIG. 29, if the intra-layer prediction algorithm is turned on, that is, the syntax element EnableRefferingSameLoD=1, the intra-layer nearest-neighbor search may be allowed. For example, for the LOD1 layer, the nearest-neighbor point of the current point P6 may be P1, and other layers are not allowed; and if the syntax element EnableRefferingSameLoD=0, inter-layer search is allowed in other layers. For example, for the LOD1 layer, the nearest-neighbor point of the current point P6 may be P4. That is, in a case where the intra-layer prediction algorithm is turned on, a nearest-neighbor search will be performed in the same layer LOD and the encoded point sets in the same layer to obtain the N nearest-neighbors of the current point (the inter-layer nearest-neighbor search is also performed).

In a case of performing intra-layer prediction of attribute, the nearest-neighbor search is performed based on the fast search algorithm. The specific algorithm is illustrated in FIG. 30. The current point is represented by grids. Assuming that the Morton code index of the current point is i, the nearest-neighbor search will be performed within [i+1, i+searchRange]. The specific nearest-neighbor search algorithm is consistent with the inter-layer block-based fast search algorithm, which will not be described in detail here.
(ii) Inter nearest-neighbor search.

FIG. 28 is a schematic diagram of attribute inter prediction. As illustrated in FIG. 28, in a case of performing attribute inter prediction, the Morton code corresponding to the current point are obtained using the geometric coordinates of the current point to be encoded. Then, based on the Morton code of the current point, the first reference point (j) with a Morton code greater than that of the current point is found in the reference picture. Then, the nearest-neighbor search is performed within a range of j-searchRange, j+searchRange].

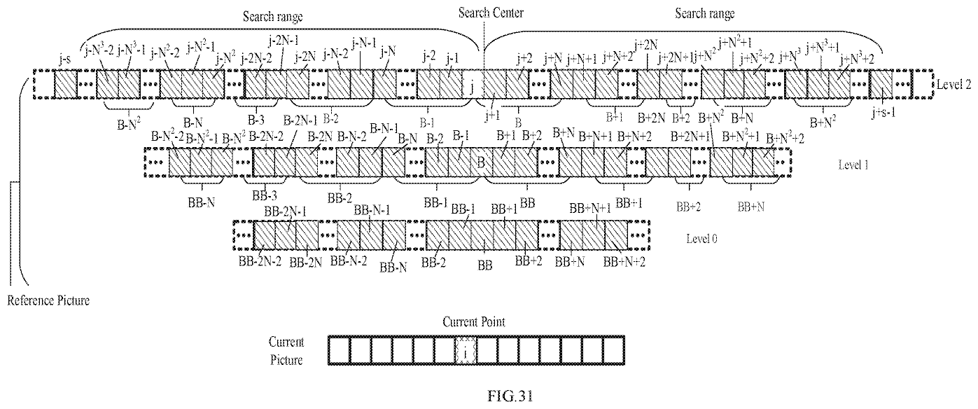

Currently, in a case of performing intra nearest-neighbor search and inter nearest-neighbor search, the neighborhood search is performed based on blocks, details may be seen from FIG. 31. As illustrated in FIG. 31, in a case of searching for the neighborhood of the current point (Morton code index is i), the points in the reference picture are partitioned into N (N=3) layers according to the Morton codes. The specific partition algorithm is as follows.
First layer: assuming that the number of points in the reference picture is numPoints, the points in the reference picture are partitioned into blocks each with M (M=2⁵=32) points.
   Second layer: on a basis of the first layer, the blocks in the first layer are partitioned into blocks each with M (M=2⁵=32) blocks in an order of Morton code.
   Third layer: on a basis of the second layer, the blocks in the first layer are partitioned into blocks each with M (M=2⁵=32) blocks in an order of Morton code.

Finally, the predicted structure illustrated in FIG. 31 is obtained.

In a case of performing attribute prediction based on the prediction structure illustrated in FIG. 31, assuming that the Morton code index of the current point to be encoded is i, the first point with the Morton code greater than or equal to the Morton code of the current point is obtained in the reference picture, and the first point has an index of j. Then, a block index of the reference point is calculated based on j. The specific calculation method is as follows.
First layer: BucketSize_0=2⁵=32.
Second layer: BucketSize_1=2⁵=32×BucketSize_0=1024.
Third layer: BucketSize_2=2⁵=32×BucketSize_1=32768.

Assuming that the reference range in the prediction picture of the current point is [j−searchRange, j+searchRange], a starting index of the third layer is calculated using j−searchRange, and an ending index of the third layer is calculated using j+searchRange. Next, it is determined whether some blocks in the second layer need to undergo nearest-neighbor search in the blocks in the third layer; then, moving to the second layer, it is determined whether a search is needed for each block in the first layer; if certain blocks in the first layer need to undergo nearest-neighbor search, points of some blocks in the first layer will be determined point by point to update the nearest-neighbors.

The index-based calculation block algorithm will be introduced below. Assuming that the Morton code index corresponding to the current point is “index”, the corresponding index of the block in the third layer is:

$$idx\_ 2 = index / BucketSize\_ 2$$

After the index idx_2 of the block in the third layer is obtained, the starting index and the ending index of the block, corresponding to the current block, in the second layer may be obtained using the idx_2:

$$startIdx 1 = idx\_ 2 \times BucketSize\_ 1$$

$$endIdx = idx\_ 2 \times BucketSize\_ 1 + BucketSize\_ 1 - 1$$

Similarly, based on the same algorithm, the index of the block in the first layer is obtained based on the index of the block in the second layer.

In a case of performing nearest-neighbor search based on blocks, it is first determined whether the current block needs to undergo nearest-neighbor search, that is, the nearest-neighbor search of the block is filtered. Each spatial block may be obtained based on two variables minPos and maxPos, where minPos represents the minimum value of the block and maxPos represents the maximum value of the block.

Assuming that the distance between the farthest point among the N nearest-neighbors searched for the current point and the current point is Dist, the coordinates of the point to be encoded are (x, y, z), and the current block is represented by (minPos, maxPos), where minPos is the minimum value of the bounding box in three dimensions, and maxPos is the maximum value of the bounding box in three dimensions, then the distance D between the current point and the bounding box is calculated as follows:

$$int dx = int ( std \text{::} max ( std \text{::} max ( min Pos [ 0 ] - point [ 0 ] , 0 ) , point [ 0 ] - max Pos [ 0 ] ) ) ;$$

$$int dy = int ( std \text{::} max ( std \text{::} max ( min Pos [ 1 ] - point [ 1 ] , 0 ) , point [ 1 ] - max Pos [ 1 ] ) ) ;$$

$$int dz = int ( std \text{::} max ( std \text{::} max ( min Pos [ 2 ] - point [ 2 ] , 0 ) , point [ 2 ] - max Pos [ 2 ] ) ) ;$$

$$D = dx + dy + dz ;$$

In a case where D is less than or equal to Dist, the points in the current block will be traversed.
(b) Lifting transform encoding of the attribute information of the point cloud.

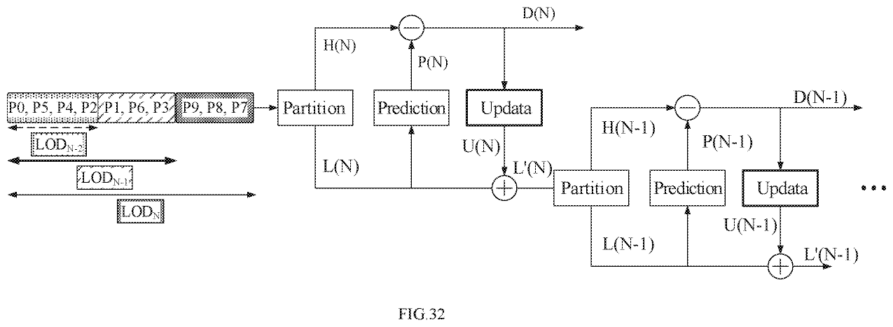

FIG. 32 is a schematic diagram of an encoding process of a lifting transform. The lifting transform also performs predictive encoding on the attributes of the point cloud based on LOD. The difference from the predicting transform is that the lifting transform will perform high and low layers partitioning on the LOD, perform prediction in a reversed order of generation layers of the LOD, and introduce an update operator in the prediction process to update the quantization weights of the points in the lower LOD layer, so as to improve the accuracy of the prediction. This is because the attribute values of the points in the lower LOD layer are frequently used to predict the attribute values of points in the higher LOD layer, and the points in the lower LOD layer should have great influence.
Step 1: partition process.

The partition process is to partition the complete LOD into lower LOD layer(s) L(N) and higher LOD(s) H(N). If a point cloud has three LOD layers, i.e., (LODₗ)_{l=0,1,2}, after partitioning, LOD₂ is the higher LOD layer, denoted as H(N), and (LODₗ)_{l=0,1} is the lower LOD layer, denoted as L (N).
Step 2: prediction process.

The points in the higher LOD layer select the attribute information of the nearest-neighbor point from the lower LOD layer as the attribute prediction value P(N) of the current point to be encoded. The prediction residual D(N) is recorded as:

$$D ( N ) = H ( N ) - P ( N )$$

Step 3: update process.

The attribute prediction residual D (N) in the higher LOD layer is updated to obtain U(N), and the attribute values of the points in the lower LOD layer are lifted using U(N), as shown in following formula:

$${L}^{′} ( N ) = L ( N ) + U ( N )$$

The above process will iterate continuously until the lowest LOD according to an order of LOD from high to low.

Since the LOD-based prediction scheme makes the points in the lower LOD layer have great influence, a transform scheme based on lifting wavelet transform updates the prediction residual by introducing quantization weights and according to the prediction residual D(N) and the distance between the prediction point and the neighboring point. Finally, adaptive quantization is performed on the prediction residual using the quantization weights in the transform process. It should be noted that the quantization weight value of each point may be determined through geometric reconstruction at the decoding side, and thus the quantization weight do not need to be encoded.
(c) Region adaptive hierarchal transform.

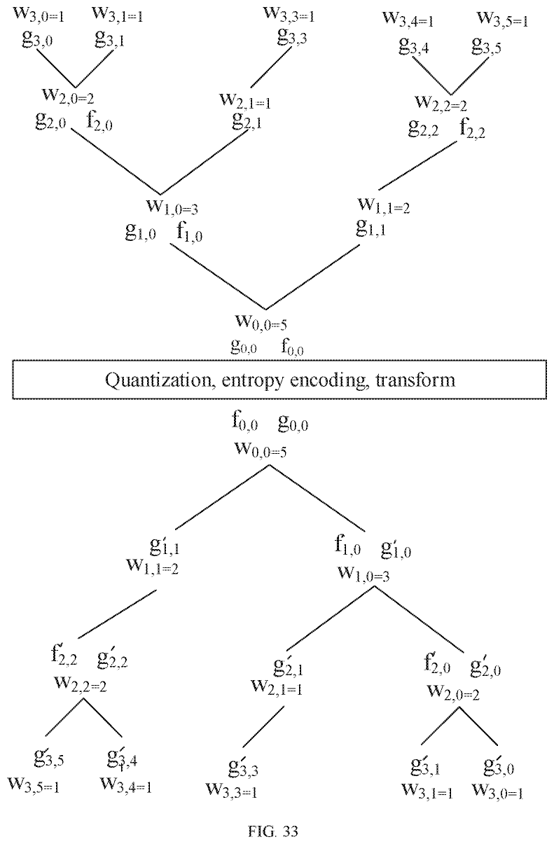

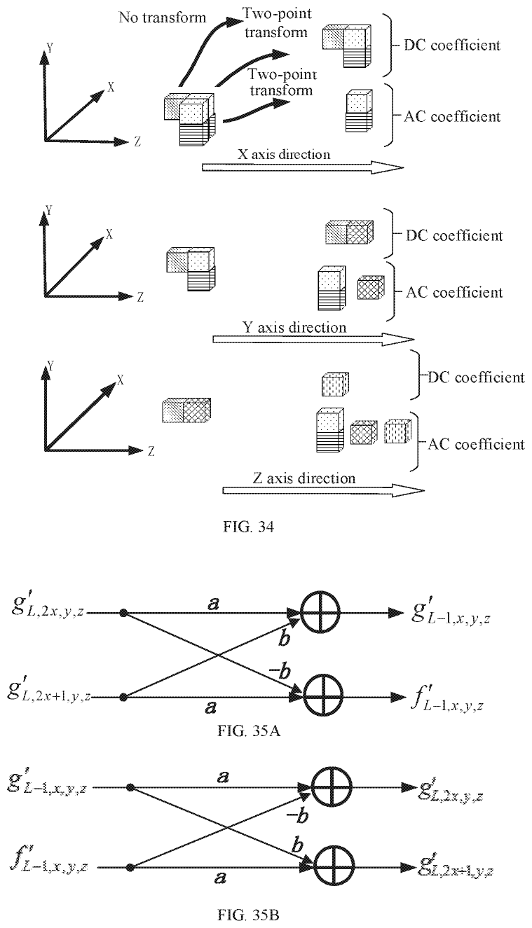

The region adaptive hierarchal transform (RAHT) is a Haar wavelet transform that may transform the attribute information of the point cloud from the spatial domain to the frequency domain to further reduce the correlation between the attributes of the point cloud. The main idea is to transform the nodes in each layer from the three dimensions of x, y and z (as illustrated in FIG. 34) in a bottom-up manner based on the octree structure, and to perform iteration until reaching the root node of the octree. As illustrated in FIG. 33, the basic idea is to perform wavelet transform based on the hierarchal structure of the octree, associate the attribute information with the nodes of the octree, perform recursive transform on the attributes of the occupied nodes in the same parent node in a bottom-up manner, and perform transform on the nodes in each layer in the three dimensions of X, Y and Z until reaching the root node of the octree. In the process of hierarchal transform, low-pass/low-frequency (DC) coefficients obtained after transforming the nodes in the same layer are passed to the nodes in the next layer for further transform, while all high-pass/high-frequency (AC) coefficients are encoded by the arithmetic encoder.

In the transform process, a DC coefficient (direct current component) of the nodes in the same layer after transform will be passed to the previous layer for further transform, and an AC coefficient (alternating current component) after transform of each layer will be quantized and encoded. The main transform process will be introduced below.

FIG. 35A is a schematic diagram of a RAHT forward transform process, and FIG. 35B is a schematic diagram of a RAHT inverse transform process. For the transform and inverse transform processes corresponding to RAHT, it is assumed that

$${g}_{L , 2 x , y , z}^{′} and {g}_{L , 2 x + 1 , y , z}^{′}$$

are two attributes DC coefficients of neighboring points in the L layer. After linear transform, the information of the L−1 layer is the AC coefficient

$${f}_{L - 1 , x , y , z}^{′}$$

and the DC coefficient

$${g}_{L - 1 , x , y , z}^{′} ;$$

then, no more transform will be performed on

$${f}_{L - 1 , x , y , z}^{′} ,$$

and quantization encoding will be performed on

$${f}_{L - 1 , x , y , z}^{′}$$

directly;

$${g}_{L - 1 , x , y , z}^{′}$$

will continue to search for nearest-neighbors for transform, and it will be passed directly to the L−2 layer if none are found. That is, the RAHT transform is only valid for nodes with neighboring points, and nodes without neighboring points will be passed directly to the previous layer. In the above transform process, the weights (the number of non-empty child nodes in a node) corresponding to

$${g}_{L , 2 x , y , z}^{′} and {g}_{L , 2 x + 2 , y , z}^{′}$$

are

$${w}_{L , 2 x , y , z}^{′} and {w}_{L , 2 x + 1 , y , z}^{′}$$

$$( abbreviated as {w}_{0}^{′} and {w}_{1}^{′} ) ,$$

and the weight of

$${g}_{L - 1 , x , y , z}^{′} is {w}_{L - 1 , x , y , z}^{′} ,$$

then the general transform formula is:

$$[ \begin{matrix}{g}_{L - 1 , x , y , z}^{′} \\ {f}_{L - 1 , x , y , z}^{′}\end{matrix} ] = {T}_{w 0 , w 1} [ \begin{matrix}{g}_{L , 2 x , y , z}^{′} \\ {g}_{L , 2 x + 1 , y , z}^{′}\end{matrix} ]$$

Here, T_{w0,w1} is a transform matrix:

$${T}_{w 0 , w 1} = \frac{1}{\sqrt{{w}_{0}^{′} + {w}_{1}^{′}}} [ \begin{matrix}\sqrt{{w}_{0}^{′}} & \sqrt{{w}_{1}^{′}} \\ - \sqrt{{w}_{1}^{′}} & \sqrt{{w}_{0}^{′}}\end{matrix} ]$$

The transform matrix will be updated as the weights corresponding to each point adaptively. The above process will be continuously iterated and updated based on the partition structure of the octree until reaching the root node of the octree.

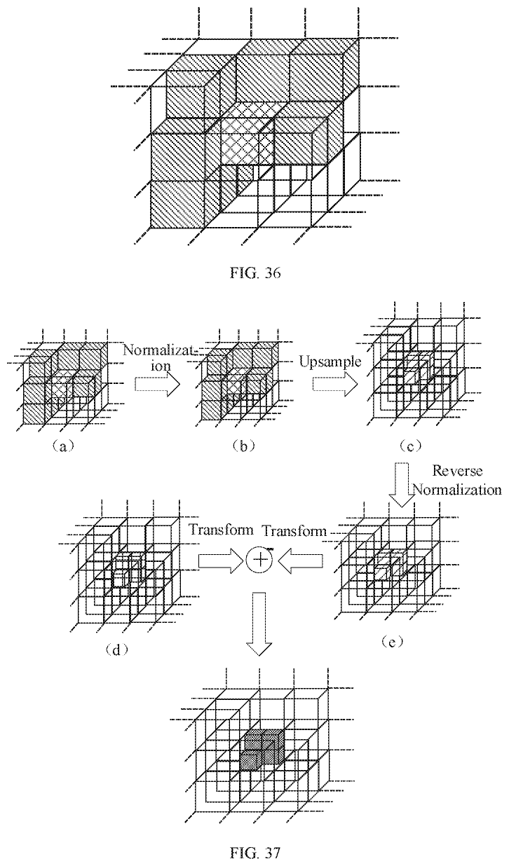

In an implementation, for region adaptive hierarchal intra predicting transform encoding, prediction may be performed based on RAHT transform encoding. As illustrated in FIG. 33, the RAHT attribute transform is continuously performed, based on an order of the octree hierarchy, from the voxel level until the root node is obtained, thereby completing the hierarchal transform encoding of the entire attribute. In predicting transform encoding, attribute predicting transform encoding is also performed based on the order of the octree hierarchy, but the transform is performed continuously from the root node to the voxel level. In each RAHT attribute transform process, attribute predicting transform encoding is performed based on a 2×2×2 block. The details are illustrated in FIG. 36. As illustrated in FIG. 36, it may be seen that the block filled with grids is the current block to be encoded, and the blocks filled with diagonal lines are some neighborhood blocks that are co-plane and co-edge with the current block to be encoded. Here, the attributes of the current block are normalized in the following manner:

$${A}_{node} = {\sum }_{p ∈ node} attribute ( p ) ;$$

$${w}_{node} = {\sum }_{p ϵ node} 1 = \{ p ∈ node \} ;$$

$${a}_{node} = {A}_{node} / {w}_{node} .$$

First, the attributes of the current block, i.e., A_{node}, may be obtained through the attributes of the points contained in the current block. An average value a_{node} of the attributes of the current block is obtained by simply adding the attributes of the points included in the current block and then normalizing the attributes of the current block with the number of points in the current block. The attribute transform encoding is performed using the average value of the attributes of the current block. The specific encoding process may be seen in FIG. 37.

As illustrated in FIG. 37, the overall process of RAHT attribute predicting transform encoding is illustrated. Here, (a) illustrates the current block and some co-plane and co-edge neighborhood blocks, (b) illustrates the normalized block, (c) illustrates the upsampled block, (d) illustrates the attribute of the current block, and (e) illustrates the attribute of the predicted block obtained by linear weighted fitting using the neighborhood attributes of the current block. Finally, the attributes of the two will be transformed separately to obtain DC and AC coefficients, and the AC coefficient will be predictively encoded.

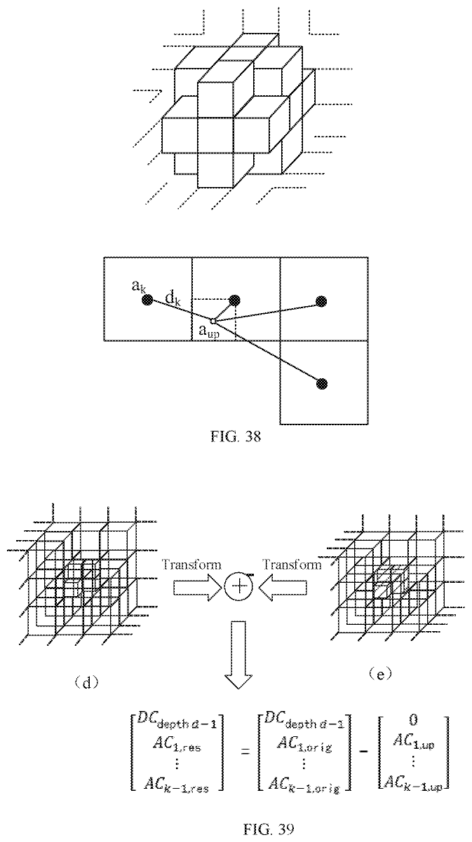

Here, the prediction attribute of the current block may be obtained by performing linear fitting as illustrated in FIG. 38. As illustrated in FIG. 38, 19 neighborhood blocks of the current block are obtained, the linear weighted prediction is performed on the attribute of each sub-block using the spatial geometric distances between the neighborhood blocks and each sub-block of the current block, and finally transform is performed using the attribute of the predicted block obtained by linear weighting. The specific attribute transform is illustrated in FIG. 39.

In FIG. 39, (d) represents an attribute original value, and the corresponding attribute transform coefficient is as follows:

$$[ \begin{matrix}* \\ {AC}_{1 , orig} \\ ⋮ \\ {AC}_{k - 1 , orig}\end{matrix} ] = {T}_{node} [ \begin{matrix}{A}_{1} , orig / \sqrt{{w}_{1}} \\ ⋮ \\ {A}_{k , orig} / \sqrt{{w}_{k}}\end{matrix} ]$$

Here, (e) represents an attribute prediction value, and the corresponding attribute transform coefficient is as follows:

$$[ \begin{matrix}* \\ {AC}_{1 , up} \\ ⋮ \\ {AC}_{k - 1 , up}\end{matrix} ] = {T}_{node} [ \begin{matrix}{A}_{1 , up} / \sqrt{{w}_{1}} \\ ⋮ \\ {A}_{k , up} / \sqrt{{w}_{k}}\end{matrix} ]$$

By subtracting the attribute prediction value from the attribute original value, the prediction residual may be obtained as follows:

$$[ \begin{matrix}{DC}_{depth d - 1} \\ {AC}_{1 , res} \\ ⋮ \\ {AC}_{k - 1 , res}\end{matrix} ] = [ \begin{matrix}{DC}_{depth d - 1} \\ {AC}_{1 , orig} \\ ⋮ \\ {AC}_{k - 1 , orig}\end{matrix} ] - [ \begin{matrix}0 \\ {AC}_{1 , up} \\ ⋮ \\ {AC}_{k - 1 , up}\end{matrix} ]$$

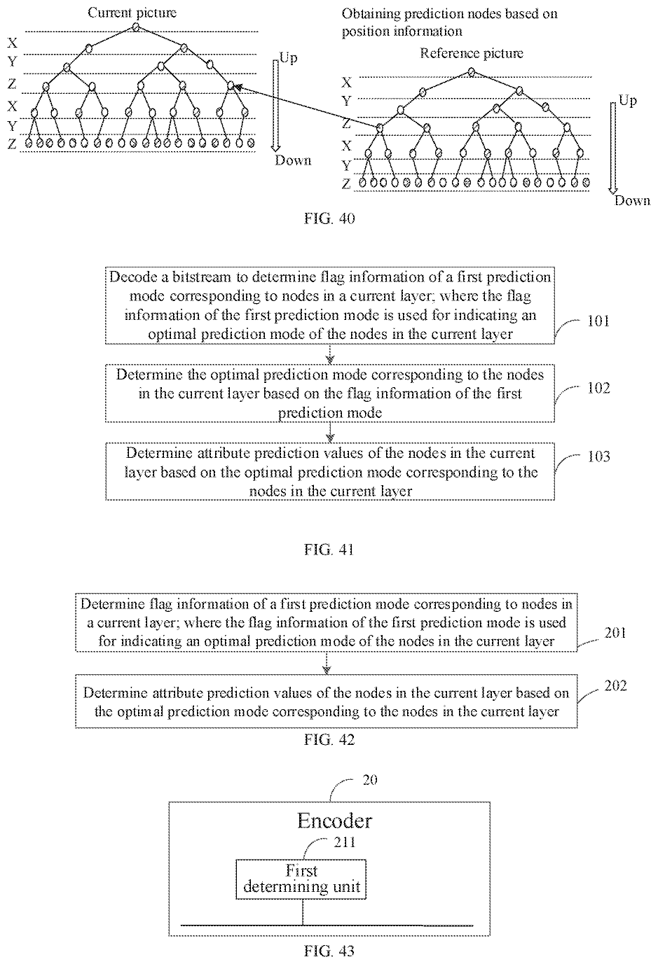

In another specific implementation, for region adaptive hierarchal inter predicting transform encoding, the G-PCC attribute inter prediction has a process similar to the intra predictive encoding. Firstly, a RAHT attribute transform encoding structure is constructed based on the geometric information, that is, the transform is continuously performed from the voxel level until the root node is obtained, thereby completing the hierarchal transform encoding of the entire attribute. In this way, the intra encoding structure and inter attribute encoding structure are constructed, the details are illustrated in FIG. 40.

As illustrated in FIG. 40, a co-located prediction node of the node to be encoded is obtained in the reference picture using the geometric information of the current node to be encoded, and then a predicted attribute of the current node to be encoded is obtained using the geometric information and attribute information of the reference node.

The attribute prediction value of the current node to be encoded is obtained in following two different manners:
1) The inter prediction node of the current node is valid, that is, the co-location node exists, and the attribute of the prediction node is directly used as the attribute prediction value of the current node to be encoded;
2) The inter prediction node of the current node is invalid, that is, the co-located node does not exist, and the attribute prediction value of the intra neighboring node is used as the attribute prediction value of the node to be encoded.

Finally, the attribute of the current node to be encoded is predicted using the obtained attribute prediction value, so as to complete the predictive encoding of the entire attribute.

Currently, in the common G-PCC RAHT attribute inter encoding, attribute prediction is only performed on the upper layers (e.g., first N layers, N=5) of the RAHT encoding structure using inter reconstruction points, and attribute prediction is performed on the lower layers using the attribute intra prediction. Such an attribute encoding scheme does not fully and effectively utilize a correlation between spatial and temporal domains of the point cloud to remove the redundancy of attributes, resulting in low encoding efficiency of attribute information. Based on this problem, this scheme adaptively selects an optimal predictive encoding method for each layer of the RAHT attribute encoding structure by introducing the rate-distortion optimization algorithm, and then passes the attribute predictive encoding mode to the decoding side. The decoding side adaptively restores the attribute information of the point cloud using the predicted decoding mode obtained through parsing, thereby further improving the encoding efficiency of the attribute information of the point cloud.

In order to solve the above problems, in the embodiments of the present disclosure, the encoder and the decoder determine flag information of a first prediction mode corresponding to nodes in a current layer, the flag information of the first prediction mode being used for indicating an optimal prediction mode of the nodes in the current layer; determine the optimal prediction mode corresponding to the nodes in the current layer based on the flag information of the first prediction mode; and determine attribute prediction values of the nodes in the current layer based on the optimal prediction mode corresponding to the nodes in the current layer. It may be seen that in the embodiments of the present disclosure, during predicting attribute information, the flag information of the first prediction mode may be transmitted in the bitstream, and the first prediction flag information may indicate the optimal prediction mode of the nodes in the current layer, so that the prediction mode determined by the flag information of the first prediction mode may be used for predicting attribute information of the nodes in the current layer, which may effectively remove the redundancy of the attributes, and improve the attribute encoding and decoding efficiency of the point cloud, thereby improving the encoding and decoding performance of the point cloud.

The embodiments of the present disclosure will be described in detail below with reference to the accompanying drawings.

In an embodiment of the present disclosure, referring to FIG. 41, a flowchart of a decoding method provided in the embodiments of the present disclosure is illustrated. As illustrated in FIG. 41, the method may include following steps.

In step 101, a bitstream is decoded to determine flag information of a first prediction mode corresponding to nodes in a current layer; where the flag information of the first prediction mode is used for indicating an optimal prediction mode of the nodes in the current layer.

In the embodiments of the present disclosure, the bitstream may be first decoded to determine the flag information of the first prediction mode corresponding to the nodes in the current layer.

It should be noted that the decoding method in the embodiments of the present disclosure specifically refers to a point cloud decoding method, which may be applied to a point cloud decoder (which may also be referred to as a “decoder” for short).

Accordingly, in the embodiments of the present disclosure, the current layer may be a RAHT transform layer to be decoded.

Furthermore, in the embodiments of the present disclosure, a RAHT attribute transform encoding structure is required to be constructed based on geometric information of points in the point cloud. Specifically, the transform may be continuously performed from a voxel level until a root node is obtained, so as to complete hierarchal transform encoding of the entire attribute, thereby obtaining the RAHT attribute transform encoding structure including at least one RAHT transform layer.

It should be noted that in the embodiments of the present disclosure, the RAHT attribute transform may be performed based on a hierarchal order of the octree. In the constructing process of the RAHT attribute transform encoding structure, the transform may be continuously performed from the voxel level until the root node is obtained based on the hierarchal order of the octree. For the process of attribute predicting transform encoding, it may also be based on the hierarchal order of the octree, but the transform is continuously performed from the root node to the voxel level.

It can be understandable that in the embodiments of the present disclosure, it may be defined that a layer obtained by downsampling sequentially along a preset direction, such as a Z direction, a Y direction, and an X direction, once each time is a RAHT transform layer, such as the current layer.

It should be noted that in the embodiments of the present disclosure, for the current layer, the current layer may include at least one point. Here, for the at least one point in the current layer, in a case of decoding the current layer, the at least one point may be used as a node to be decoded in the current layer.

Furthermore, in the embodiments of the present disclosure, each point in the current layer corresponds to a piece of geometric information and a piece of attribute information; where the geometric information represents a spatial relationship of the point, and the attribute information represents related information of an attribute of the point.

Here, the attribute information may be color information, reflectivity or other attributes, which is not specifically limited in the embodiments of the present disclosure. In a case where the attribute information is the color information, it may specifically be color information in any color space. Exemplarily, the attribute information may be color information in an RGB space, color information in a YUV space, color information in a YCbCr space, or the like, which is not specifically limited in the embodiments of the present disclosure.

It should be noted that in the embodiments of the present disclosure, the flag information of the first prediction mode may be used for determining the optimal prediction mode corresponding to the nodes in the current layer. Here, based on the flag information of the first prediction mode, a first prediction mode or a second prediction mode may be selected for performing encoding and decoding on the nodes in the current layer.

It should be noted that in the embodiments of the present disclosure, based on the optimal prediction mode indicated by the flag information of the first prediction mode, for nodes in the current layer that meet a condition for the attribute prediction, a prediction processing may be performed on the attribute information using the optimal prediction mode; while for nodes in the current layer that do not meet a condition for the attribute prediction, there is no need to perform the prediction processing on the attribute information.

That is, in the embodiments of the present disclosure, the optimal prediction mode indicated by the flag information of the first prediction mode corresponding to the nodes in the current layer may be applied to the nodes in the current layer that meet the condition for the attribute prediction.

Furthermore, in the embodiments of the present disclosure, after determining the flag information of the first prediction mode corresponding to the nodes in the current layer, in response to a value of the flag information of the first prediction mode being a first value, the optimal prediction mode corresponding to the nodes in the current layer is determined to be the first prediction mode; and in response to a value of the flag information of the first prediction mode being a second value, the optimal prediction mode corresponding to the nodes in the current layer is determined to be the second prediction mode.

It may be understood that in the embodiments of the present disclosure, the flag information of the first prediction mode may be used for indicating that the attribute information of the nodes in the current layer uses the first prediction mode or the second prediction mode for prediction.

It may be understood that in the embodiments of the present disclosure, the flag information of the first prediction mode may be used for indicating the optimal prediction mode of the attribute information of the nodes in the current layer.

It should be noted that in the embodiments of the present disclosure, the first value is different from the second value, and the first value and the second value may be in parameter forms or in numerical forms.

Exemplarily, in some embodiments, taking the first value being set to 1 and the second value being set to 0 as an example, the bitstream is decoded to determine the value of the flag information of the first prediction mode. In response to the value of the flag information of the first prediction mode being 1, it may be determined that the attribute information of the nodes in the current layer may use the first prediction mode. In response to the value of the flag information of the first prediction mode being 0, it may be determined that the attribute information of the nodes in the current layer may use the second prediction mode.

It should be noted that in the embodiments of the present disclosure, the first prediction mode and the second prediction mode may be two different prediction modes. The first prediction mode may include an attribute intra prediction mode and/or an attribute inter prediction mode; and the second prediction mode may include an attribute intra prediction mode.

Furthermore, in the embodiments of the present disclosure, for a current node among the nodes in the current layer, the number of first neighbors corresponding to the current node and the number of second neighbors corresponding to a parent node of the current node may be determined. In response to determining that the current node meets a condition for the attribute prediction based on the number of the first neighbors and the number of the second neighbors, the bitstream is decoded to determine the flag information of the second prediction mode corresponding to the nodes in the current layer. where, the flag information of the second prediction mode is used for determining whether to perform attribute inter prediction processing on the nodes in the current layer.

It should be noted that in the embodiments of the present disclosure, the number of the first neighbors is the number of neighboring nodes corresponding to the current node in the current layer; the number of the second neighbors is the number of neighboring nodes corresponding to the parent node of the current node in the current layer.

It may be understood that in the embodiments of the present disclosure, the condition for the attribute prediction is a condition for predicting the attribute information. Accordingly, it may be determined whether the prediction processing may be performed on the attribute information of the current node in the current layer based on the determined number of the first neighbors and the determined number of the second neighbors. That is, it may be determined whether the current node in the current layer meets the condition for predicting the attribute information based on the number of the first neighbors and the number of the second neighbors, that is, it is determined whether the attribute prediction may be used.

It may be understood that in the embodiments of the present disclosure, in a case of determining whether the current node in the current layer meets the condition for the attribute prediction based on the determined number of the first neighbors and the determined number of the second neighbors, in response to the number of the first neighbors being greater than a first threshold and the number of the second neighbors being greater than a second threshold, it may be determined that the current node meets the condition for the attribute prediction, that is, the attribute information of the current node may be predicted; and in response to the number of the first neighbors being less than or equal to the first threshold, or the number of the second neighbors being less than or equal to the second threshold, it may be determined that the current node does not meet the condition for the attribute prediction, that is, the attribute information of the current node is not allowed to be predicted.

It should be noted that in the embodiments of the present disclosure, the first threshold and the second threshold may be integers greater than 0, where the first threshold and the second threshold may be the same or different, which will not be specifically limited in the present disclosure.

Furthermore, in the embodiments of the present disclosure, in response to determining that the current node in the current layer meets the condition for the attribute prediction based on the number of the first neighbors and the number of the second neighbors, the flag information of the second prediction mode may be further determined. Here, the bitstream may be decoded to determine the flag information of the second prediction mode corresponding to the nodes in the current layer.

It should be noted that in the embodiments of the present disclosure, the flag information of the second prediction mode is used for determining whether to perform the attribute inter prediction processing on the nodes in the current layer. That is, the second prediction mode information may be flag information for indicating whether to perform the inter prediction on the nodes in the current layer.

Furthermore, in the embodiments of the present disclosure, after determining the flag information of the second prediction mode corresponding to the nodes in the current layer, in response to a value of the flag information of the second prediction mode being a third value, the attribute inter prediction processing is allowed to be performed on the nodes in the current layer; or in response to the value of the flag information of the second prediction mode being a fourth value, the attribute inter prediction processing is disallowed to be performed on the nodes in the current layer.

That is, in the embodiments of the present disclosure, the flag information of the second prediction mode may be used for indicating whether to allow predicting the attribute information of the nodes in the current layer using the inter prediction mode.

It should be noted that in the embodiments of the present disclosure, the third value is different from the fourth value, and the third value and the fourth value may be in parameter forms or in numerical forms.

Exemplarily, in some embodiments, taking the third value being set to 1 and the fourth value being set to 0 as an example, the bitstream is decoded to determine the value of the flag information of the second prediction mode. In response to the value of the flag information of the second prediction mode being 1, it may be determined that the attribute information of the nodes in the current layer may use the attribute inter prediction mode. In response to the value of the flag information of the second prediction mode being 0, it may be determined that the attribute information of the nodes in the current layer cannot use the attribute inter prediction mode.

Furthermore, in the embodiments of the present disclosure, after obtaining the flag information of the second prediction mode by parsing from the bitstream, in response to determining that the attribute inter prediction processing is allowed to be performed on the nodes in the current layer based on the flag information of the second prediction mode, the optimal prediction mode of the attribute information of the nodes in the current layer may be further determined. That is, the above process of determining the flag information of the first prediction mode may be performed; and in response to determining that the attribute inter prediction processing is not allowed to be performed on the nodes in the current layer based on the flag information of the second prediction mode, the above process of determining the flag information of the first prediction mode may no longer be performed.

Furthermore, in the embodiments of the present disclosure, the bitstream is decoded to determine flag information of a third prediction mode corresponding to the nodes in the current layer. In response to a value of the flag information of the third prediction mode being a fifth value, it is determined that the optimal prediction mode corresponding to the nodes in the current layer includes the transform mode and the prediction mode. In response to the value of the flag information of the third prediction mode being a sixth value, it is determined that the optimal prediction mode corresponding to the nodes in the current layer includes the prediction mode.

It should be noted that in the embodiments of the present disclosure, the flag information of the third prediction mode may be used for indicating whether the attribute information corresponding to the nodes in the current layer is determined by means of combining the transform mode with the prediction mode.

It may be understood that in the embodiments of the present disclosure, the fifth value is different from the sixth value, and the fifth value and the sixth value may be in parameter forms or in numerical forms.

Exemplarily, in some embodiments, taking the fifth value being set to 1 and the sixth value being set to 0 as an example, the bitstream is decoded to determine the value of the flag information of the third prediction mode. In response to the value of the flag information of the third prediction mode being 1, it may be determined that the attribute information of the nodes in the current layer may be determined by means of combining the transform mode with the prediction mode, and then the flag information of the first prediction mode corresponding to the nodes in the current layer may be further determined based on the above method, so as to further determine that the attribute information is determined using the first prediction mode or the second prediction mode. In response to the value of the flag information of the third prediction mode being 0, it may be determined that the attribute information of the nodes in the current layer cannot be determined by means of combining the transform mode and the prediction mode. For example, the attribute information of the nodes in the current layer is determined only using the transform mode.

Therefore, there is no need to determine the flag information of the first prediction mode corresponding to the nodes in the current layer.

It may be understood that in the embodiments of the present disclosure, after determining the flag information of the third prediction mode, in response to determining that the optimal prediction mode corresponding to the nodes in the current layer includes the transform mode and the prediction mode based on the flag information of the third prediction mode, the process of determining the flag information of the first prediction mode may be further performed.

It may be seen that in the embodiments of the present disclosure, whether to determine the flag information of the first prediction mode corresponding to the nodes in the current layer depends on the flag information of the second prediction mode and/or the flag information of the third prediction mode. In a case where the flag information of the second prediction mode indicates that the attribute inter prediction processing is allowed to be performed on the nodes in the current layer, it is chosen that the flag information of the first prediction mode of the nodes in the current layer is further determined, that is, the processing flow of the step 101 is performed, so as to determine that the attribute information of the nodes in the current layer is determined using the first prediction mode or the second prediction mode. In a case where the flag information of the third prediction mode indicates that the optimal prediction mode corresponding to the nodes in the current layer includes the transform mode and the prediction mode, it is chosen that the flag information of the first prediction mode of the nodes in the current layer is further determined, that is, the processing flow of the step 101 is performed, so as to determine that the attribute information of the nodes in the current layer is determined using the first prediction mode or the second prediction mode.

In step 102, the optimal prediction mode corresponding to the nodes in the current layer is determined based on the flag information of the first prediction mode.

In the embodiments of the present disclosure, after determining the flag information of the first prediction mode corresponding to the nodes in the current layer, the optimal prediction mode corresponding to the nodes in the current layer may be further determined based on the flag information of the first prediction mode, that is, the flag information of the first prediction mode is used for determining the optimal prediction mode for performing attribute information predication on the nodes in the current layer.

It may be understood that in the embodiments of the present disclosure, the flag information of the first prediction mode may be used for determining that the attribute information of the nodes in the current layer is determined using the first prediction mode or the second prediction mode. The first prediction mode includes the attribute intra prediction mode and/or the attribute inter prediction mode, and the second prediction mode includes the attribute intra prediction mode.

Furthermore, in the embodiments of the present disclosure, the attribute information of the nodes in the current layer is determined by selecting to use the attribute intra prediction mode and/or the attribute inter prediction mode. In response to the value of the flag information of the first prediction mode being the first value, it may be determined that the optimal prediction mode corresponding to the nodes in the current layer is the first prediction mode, that is, the optimal prediction mode corresponding to the nodes in the current layer is the attribute intra prediction mode and/or the attribute inter prediction mode. In response to the value of the flag information of the first prediction mode being the second value, it may be determined that the optimal prediction mode corresponding to the nodes in the current layer is the second prediction mode, that is, the optimal prediction mode corresponding to the nodes in the current layer is the attribute intra prediction mode.

It may be understood that in the embodiments of the present disclosure, in response to the flag information of the first prediction mode indicating that the first prediction mode is used for determining the attribute information of the nodes in the current layer, it may be considered that in a case of performing attribute prediction on the nodes in the current layer, a manner of combining the attribute intra prediction mode with the attribute inter prediction mode may be selected.

In step 103, attribute prediction values of the nodes in the current layer are determined based on the optimal prediction mode corresponding to the nodes in the current layer.

In the embodiments of the present disclosure, after determining the optimal prediction mode corresponding to the nodes in the current layer based on the flag information of the first prediction mode, the attribute prediction values of the nodes in the current layer may be further determined based on the optimal prediction mode corresponding to the nodes in the current layer.

Furthermore, in the embodiments of the present disclosure, in response to the optimal prediction mode corresponding to the nodes in the current layer being the first prediction mode, that is, the attribute information of the nodes in the current layer is predicted by means of combining the attribute intra prediction mode with the attribute inter prediction mode, then in a case where the attribute prediction values of the nodes in the current layer are determined based on the optimal prediction mode corresponding to the nodes in the current layer, reference positions corresponding to the nodes in the current layer may be determined in a reference picture corresponding to the current picture based on geometric information corresponding to the nodes in the current layer. In response to the reference positions corresponding to reconstructed reference points, the attribute prediction values of the nodes in the current layer may be further determined based on the attribute reconstruction values of the reconstructed reference points.

It may be understood that in the embodiments of the present disclosure, for a current node in the current layer, geometric information of the current node may be first determined, and then the corresponding reference position may be determined in the reference picture corresponding to the current picture using the geometric information, and it may be determined whether the inter prediction node of the current node is valid based on the reference position, that is, whether there is a co-located node of the current node in the reference picture.

It should be noted that in the embodiments of the present disclosure, the current picture may be a video picture to be decoded. Accordingly, the reference picture may be at least one decoded video picture.

It may be understood that in the embodiments of the present disclosure, for the current picture and the corresponding reference picture, the RAHT transform layer is constructed by selecting to use a same manner, that is, based on the hierarchal order of the octree, the transform may be continuously performed from the voxel level until the root node is obtained, so as to construct the RAHT attribute transform encoding structure. Therefore, the current picture and the corresponding reference picture have corresponding RAHT attribute transform encoding structures, and then the corresponding reference position may be determined in the reference picture based on set information of any node in the current layer.

It should be noted that in the embodiments of the present disclosure, in response to there being co-located nodes (reconstructed reference points) of the nodes in the current layer at the reference positions corresponding to the nodes in the current layer in the reference picture, it may be determined that the co-located nodes are inter prediction nodes corresponding to the nodes in the current layer, that is, the inter prediction nodes corresponding to the nodes in the current layer are valid (i.e., the reconstructed reference points exist).

Correspondingly, in the embodiments of the present disclosure, in response to determining that the inter prediction nodes corresponding to the nodes in the current layer are valid, attribute reconstruction values of the inter prediction nodes (reconstructed reference points) may be directly selected as the attribute prediction values of the nodes in the current layer.

Furthermore, in the embodiments of the present disclosure, in response to the optimal prediction mode corresponding to the nodes in the current layer being the first prediction mode, that is, the attribute information of the nodes in the current layer is predicted by means of combining the attribute intra prediction mode with the attribute inter prediction mode, then in a case where the attribute prediction values of the nodes in the current layer are determined based on the optimal prediction mode corresponding to the nodes in the current layer, the reference positions corresponding to the nodes in the current layer may be first determined in the reference picture corresponding to the current picture based on the geometric information corresponding to the nodes in the current layer. In response to the reference positions not corresponding to any reconstructed reference point, the neighboring nodes corresponding to the nodes in the current layer may be further determined in the current picture based on the geometric information corresponding to the nodes in the current layer; and then the attribute prediction values of the nodes in the current layer are determined based on the attribute prediction values of the neighboring nodes.

It should be noted that in the embodiments of the present disclosure, in response to there being no reconstructed reference points corresponding to the reference positions corresponding to the nodes in the current layer in the reference picture, that is, there are no co-located nodes (reconstructed reference points) of the nodes in the current layer, it may be determined that the inter prediction nodes corresponding to the nodes in the current layer are invalid (i.e., there are no reconstructed reference points).

Accordingly, in the embodiments of the present disclosure, in response to determining that the inter prediction nodes corresponding to the nodes in the current layer are invalid, the inter reference points cannot be used for determining the attribute prediction values of the nodes in the current layer. Therefore, it is necessary to use attribute prediction values of intra neighboring nodes to determine the attribute prediction values of the nodes in the current layer. That is, the neighboring nodes corresponding to the nodes in the current layer may be determined in the current picture based on the geometric information corresponding to the nodes in the current layer; and then the attribute prediction values of the nodes in the current layer may be determined based on the attribute prediction values of the neighboring nodes.

It may be seen that in the embodiments of the disclosure, in response to the optimal prediction mode corresponding to the nodes in the current layer being the first prediction mode, that is, the attribute information of the nodes in the current layer is predicted by means of combining the attribute intra prediction mode with the attribute inter prediction mode, for a current node to be decoded in the current layer, a co-located prediction node (a reference node) of the node to be decoded may be obtained in the reference picture using the geometric information of the current node to be decoded, and then a predicted attribute (i.e., an attribute prediction value) of the current node to be decoded may be obtained using the geometric information and attribute information of the reference node.

It may be understood that in the embodiments of the present disclosure, for the current node in the current layer, in response to the inter prediction node of the current node being valid, that is, the co-location node exists, an attribute of the prediction node may be directly used as the attribute prediction value of the current node; and in response to the inter prediction node of the current node being invalid, that is, the co-location node does not exist, an attribute prediction value of an intra neighboring node may be used as the attribute prediction value of the current node.

Furthermore, in the embodiments of the present disclosure, in response to the optimal prediction mode corresponding to the nodes in the current layer being the second prediction mode, that is, the attribute information of the nodes in the current layer is predicted using the attribute intra prediction mode, then in a case where the attribute prediction values of the nodes in the current layer are determined based on the optimal prediction mode corresponding to the nodes in the current layer, the neighboring nodes corresponding to the nodes in the current layer may be determined in the current picture based on the geometric information corresponding to the nodes in the current layer; and then the attribute prediction values of the nodes in the current layer are determined based on the attribute prediction values of the neighboring nodes.

It should be noted that in the embodiments of the present disclosure, regardless of whether the optimal prediction mode corresponding to the nodes in the current layer is the first prediction mode or the second prediction mode, in a case where the attribute prediction values of the nodes in the current layer are determined based on the attribute prediction values of the neighboring nodes, the attribute prediction values of the nodes in the current layer are determined based on the attribute reconstruction values and relative distance parameters corresponding to the neighboring nodes.

It should be noted that in the embodiments of the present disclosure, the relative distance parameters corresponding to the neighboring nodes may represent spatial geometric distances between child nodes corresponding to the nodes in the current layer and the neighboring nodes corresponding to the nodes in the current layer.

Exemplarily, in some embodiments, for the current node in the current layer, the current node includes two sub-nodes, that is, sub-node 1 and sub-node 2. A relative distance parameter between the current node and the neighboring node may include a spatial geometric distance between the sub-node 1 and the neighboring node, and may further include a spatial geometric distance between the sub-node 2 and the neighboring node.

Exemplarily, in some embodiments, for the current node in the current layer, linear fitting may be performed using attribute prediction values of neighborhood nodes (neighboring nodes) of the current node and a spatial geometric distance of each neighborhood node from the child node of the current node. Thus, the predicted attribute value of each child node of the current node may be obtained, and then the attribute prediction value of the current node may be determined.

Exemplarily, in some embodiments, for the current node in the current layer, 19 neighboring nodes of the current node may be determined, and then linear weighted prediction may be performed on the attribute of each child node using spatial geometric distances between the neighboring nodes and each child node of the current node, and thus the attribute prediction value of each child node may be obtained.

Furthermore, in the embodiments of the present disclosure, after determining the attribute prediction values of the nodes in the current layer based on the optimal prediction mode corresponding to the nodes in the current layer, the RAHT transform may be further performed based on the attribute prediction values of the nodes in the current layer, so as to determine reconstructed values of high-frequency coefficients and low-frequency coefficients corresponding to parent nodes of the nodes in the current layer. Then, RAHT inverse transform is performed based on the reconstructed values of the high-frequency coefficients and the low-frequency coefficients, so as to determine the attribute reconstruction values of the nodes in the current layer.

It may be understood that in the embodiments of the present disclosure, for the current node in the current layer, after determining the attribute prediction value of the current node, RAHT attribute transform is performed using the attribute prediction value, so as to obtain the corresponding DC coefficient and AC coefficient, that is, the corresponding DC coefficient and AC coefficient of the parent node of the current node. Here, the DC coefficient is the low-frequency coefficient, and the AC coefficient is the high-frequency coefficient.

It should be noted that in the embodiments of the present disclosure, for the current node in the current layer, the AC coefficient obtained by performing RAHT attribute transform using the attribute prediction value of the current node may be understood as the prediction value of the high-frequency coefficient corresponding to the parent node of the current node.

Furthermore, in the embodiments of the present disclosure, in a case where the RAHT transform is performed based on the attribute prediction values of the nodes in the current layer to determine the reconstructed values of the high-frequency coefficients and the low-frequency coefficients corresponding to the parent nodes of the nodes in the current layer, the RAHT transform may be performed based on the attribute prediction values of the nodes in the current layer to determine the prediction values of the high-frequency coefficients and the low-frequency coefficients corresponding to the parent nodes of the nodes in the current layer; and then the reconstructed values of the high-frequency coefficients corresponding to the parent nodes of the nodes in the current layer may be determined based on the prediction values of the high-frequency coefficients.

Furthermore, in the embodiments of the present disclosure, in a case where the reconstructed values of the high-frequency coefficients corresponding to the parent nodes of the nodes in the current layer are determined based on the prediction values of the high-frequency coefficients, the bitstream may be decoded to determine quantized coefficient residuals corresponding to the parent nodes of the nodes in the current layer; and then the reconstructed values of the high-frequency coefficients corresponding to the parent nodes of the nodes in the current layer may be determined based on the prediction values of the high-frequency coefficients and the quantized coefficient residuals.

Furthermore, in the embodiments of the present disclosure, in a case where the reconstructed values of the high-frequency coefficients corresponding to the parent nodes of the nodes in the current layer are determined based on the prediction values of the high-frequency coefficients and the quantized coefficient residuals, inverse quantization is performed on the quantized coefficient residuals to determine inverse-quantized residual values corresponding to the parent nodes of the nodes in the current layer; then, the reconstructed values of the high-frequency coefficients corresponding to the parent nodes of the nodes in the current layer may be determined based on the coefficient residuals corresponding to the parent nodes of the nodes in the current layer and the prediction values of the high-frequency coefficients corresponding to the parent nodes of the nodes in the current layer.

Exemplarily, in some embodiments, the coefficient residuals corresponding to the parent nodes of the nodes in the current layer and the prediction values of the high-frequency coefficients corresponding to the parent nodes of the nodes in the current layer may be summed up to obtain the reconstructed values of the high-frequency coefficients corresponding to the parent nodes of the nodes in the current layer.

Furthermore, in the embodiments of the present disclosure, after determining the low-frequency coefficients and the reconstruction values of the high-frequency coefficients corresponding to the parent nodes of the nodes in the current layer, the RAHT inverse transform may be performed based on the reconstruction values of the high-frequency coefficients and the low-frequency coefficients, and then the attribute reconstruction values of the nodes in the current layer may be determined.

Exemplarily, in some embodiments, it is assumed that

$${g}_{L , 2 x , y , z}^{′} and {g}_{L , 2 x + 1 , y , z}^{′}$$

are two attribute DC coefficients of neighboring points in an L layer. After linear transform, information of an L−1 layer is an AC coefficient

$${f}_{L - 1 , x , y , z}^{′}$$

and a DC coefficient

$${g}_{L - 1 , x , y , z}^{′} .$$

Then, no more transform will be performed on

$${f}_{L - 1 , x , y , z}^{′}$$

and quantization encoding may be directly performed on

$${f}_{L - 1 , x , y , z}^{′} ; {g}_{L - 1 , x , y , z}^{′}$$

will continue to search for nearest-neighbors for transform, and if the nearest-neighbor cannot be found,

$${g}_{L - 1 , x , y , z}^{′}$$

will be passed directly to an L−2 layer. That is, the RAHT transform is only valid for nodes with neighboring points. Nodes without neighboring points will be passed directly to a previous layer. In this transform process, the weights (the number of non-empty child nodes in a node) corresponding to

$${g}_{L , 2 x , y , z}^{′} and {g}_{L , 2 x + 2 , y , z}^{′}$$

are

$${w}_{L , 2 x , y , z}^{′} and {w}_{L , 2 x + 1 , y , z}^{′}$$

$$( abbreviated as {w}_{0}^{′} and {w}_{1}^{′} ) ,$$

and the weight of

$${g}_{L - 1 , x , y , z}^{′} is {w}_{L - 1 , x , y , z}^{′} ,$$

then a general transform formula is:

$$[ \begin{matrix}{g}_{L - 1 , x , y , z}^{′} \\ {f}_{L - 1 , x , y , z}^{′}\end{matrix} ] = {T}_{w 0 , w 1} [ \begin{matrix}{g}_{L , 2 x , y , z}^{′} \\ {g}_{L , 2 x + 1 , y , z}^{′}\end{matrix} ]$$

Here, T_{w0,w1} is a transform matrix, which will be updated as the weights corresponding to each point adaptively. The forward transform of the RAHT (also referred to as “RAHT forward transform”) is illustrated in the above FIG. 35A.

Exemplarily, in some embodiments, the attribute reconstruction value of the child node of the current node may be restored by performing inverse transform of the RAHT based on the obtained DC coefficient and AC coefficient of the child node of the current node. Here, the inverse transform of the RAHT (also referred to as “RAHT inverse transform” or “RAHT reverse transform”) is illustrated in the above FIG. 35B.

In conclusion, in the embodiments of the present disclosure, in a case where inter RAHT prediction is performed on attributes, in response to the attribute prediction being performed on the current layer to be decoded (the current layer), two decoding modes may be introduced to the current layer to be decoded, and then the optimal predictive decoding mode may be further selected for predictive decoding, which may improve the attribute encoding and decoding efficiency of the point cloud.

Exemplarily, in some embodiments, the encoding and decoding efficiency of the attributes are showed by using the encoding and decoding method provided in the embodiments of the present disclosure, which is shown in the following table:

TABLE 2

| Frame | TMC13- | Original | Now | Inter/ | | Now |
|---|---|---|---|---|---|---|
| index | v21.0 | proposal | proposal | Intra | BPP | BPP |
| 0 | 21376B | 21126B | 21126B | Intra | 98.8% | 98.8% |
| 1 | 21017B | 18180B | 17766B | Inter | 86.5% | 84.5% |
| 2 | 20954B | 17795B | 17354B | Inter | 84.9% | 82.8% |
| 3 | 21006B | 17818B | 16959B | Inter | 84.8% | 80.7% |
| 4 | 20964B | 18065B | 17720B | Inter | 86.2% | 84.5% |
| 5 | 20866B | 17782B | 17424B | Inter | 85.2% | 83.5% |
| 6 | 20851B | 17329B | 16678B | Inter | 83.1% | 79.98% |
| 7 | 20989B | 17989B | 17627B | Inter | 85.7% | 83.98% |
| overall | | | | | 86.9% | 84.85% |

It may be seen from the Table 2 that, for sequences that may use the inter attribute prediction, the attribute encoding BPP is reduced by about 17.15%. It may be seen that the encoding and decoding method provided in the embodiments of the present disclosure may significantly improve the attribute encoding efficiency of the point cloud.

It may be seen that in the encoding and decoding method provided in the embodiments of the present disclosure, at the encoding side, in a case of performing RAHT predictive encoding on the attributes, a predictive encoding mode in each RAHT encoding layer is introduced to adaptively select a combination of the inter predictive encoding mode with the intra predictive encoding mode or the intra predictive encoding mode, and the encoding mode is passed to the decoding side, and then the decoding side uses the encoding mode to reconstruct the attributes of the point cloud. In the embodiments of the present disclosure, the core is to introduce an encoding mode in each RAHT encoding layer to obtain the optimal encoding mode using the rate-distortion optimization selection algorithm at the encoding side, and then to use the decoding mode at the decoding side to reconstruct the attributes of the point cloud.

It should be noted that in the embodiments of the present disclosure, the encoding mode of each layer may be stored in an attribute block header (ABH), and a decoding mode of the encoding layer of the RAHT may be obtained using the ABH at the decoding side. Here, a form in which the parameter is encoded is not limited in the embodiments of the present disclosure.

Exemplarily, in some embodiments, the attribute data unit header syntax is as follows:

| | Descriptor | Semantics |
|---|---|---|
| attribute_data_unit_header( ) { | | |
| adu_attr_parameter_set_id | u(4) | 7.4.4.2 |
| adu_reserved_zero_3bits | u(3) | 7.4.4.2 |
| adu_sps_attr idx | ue(v) | 7.4.4.2 |
| adu_slice_id | ue(v) | 7.4.4.2 |
| if(meaninglod_dist_log2_offset_present) | | |
| lod_dist_log2_offset | se(v) | 10.6.2 |
| if(last_comp_pred_enabled && AttrDim == 3 ) | | |
| for(dpth = 0; dpth ≤ lod_max_levels_minus1; | | |
| dpth++) | | |
| last_comp_pred_coeff_diff[ dpth ] | se(v) | 10.6.10.1 |
| if(inter_comp_pred_enabled) | | |
| for(dpth = 0; dpth ≤ lod_max_levels_minus1; | | |
| dpth++) | | |
| for( = 1; < AttrDim; ++) | | |
| inter_comp_pred_coeff_diff[ dpth ][ c ] | se(v) | 10.6.10.1 |
| if(attr_qp_offsets_present meaning) | | |
| for(qc = 0; qc < Min(2, AttrDim); qc++) | | |
| attr_qp_offset[qc] | se(v) | 10.7.1 |
| attr_qp_layers_present | u(1) | 10.7.1 |
| if(attr_qp_layers_present meaning) { | | |
| attr_qp_layer_cnt_minus1 | ue(v) | 10.7.1 |
| for(dpth = 0; dpth ≤ attr_qp_layer_cnt_minus1; | | |
| dpth++) | | |
| for(qc = 0; qc < Min(2, AttrDim); qc++) | | |
| attr_qp_layer_offset[ dpth ][ qc ] | se(v) | 10.7.1 |
| } | | |
| attr_qp_region_cnt | ue(v) | 10.7.1 |
| if(attr_qp_region_cnt) | | |
| attr_qp_region_bits_minus1 | ue(v) | 10.7.1 |
| for( = 0; < attr_qp_region_cnt; ++ ) { | | |
| if(¬attr_coord_conv_enabled) { | | |
| for( = 0; < 3; ++) | | |
| attr_qp_region_origin_xyz[i][k] | u(v) | 10.7.1 |
| for( = 0; < 3; ++) | | |
| attr_qp_region_size_minus1_xyz[i][k] | u(v) | 10.7.1 |
| } else { | | |
| for( = 0; < 3; ++) | | |
| attr_qp_region_origin_rpi[i][k] | u(v) | 10.7.1 |
| for( = 0; < 3; ++) | | |
| attr_qp_region_size_minus1_rpi[i][k] | u(v) | 10.7.1 |
| } | | |
| for(ps = 0; ps < Min(2, AttrDim); ps++) | | |
| attr_qp_region_offset[ means][ps] | se(v) | 10.7.1 |
| } | | |
| disableAttrInterPred | u(1) | |
| if(attr_coding_type == 0&& !disableAttrInterPred) | | |
| if(raht_prediction_enabled){ | | |
| attr_code_mode_cnt | ue(v) | |
| for( = 0; < attr_code_mode_cnt; ++ ) | | |
| attr_code_mode[i] | u(1) | |
| } | | |
| byte_alignment( ) | | |
| } | | |

The embodiments of the present disclosure provide a decoding method. The decoder decodes the bitstream to determine the flag information of the first prediction mode corresponding to the nodes in the current layer, the flag information of the first prediction mode being used for indicating the optimal prediction mode of the nodes in the current layer; determines the optimal prediction mode corresponding to the nodes in the current layer based on the flag information of the first prediction mode; and determines the attribute prediction values of the nodes in the current layer based on the optimal prediction mode corresponding to the nodes in the current layer. It may be seen that in the embodiments of the present disclosure, during predicting the attribute information, the flag information of the first prediction mode may be transmitted in the bitstream, and the first prediction mode flag information may indicate the optimal prediction mode of the nodes in the current layer, so that the prediction mode determined by the flag information of the first prediction mode may be used for predicting the attribute information of the nodes in the current layer, which may effectively remove the redundancy of the attributes, and improve the attribute encoding and decoding efficiency of the point cloud, thereby improving the encoding and decoding performance of the point cloud.

An embodiment of the present disclosure provides an encoding method. FIG. 42 illustrates a schematic flowchart of an encoding method provided in the embodiments of the present disclosure. As illustrated in FIG. 42, encoding the point cloud may include following steps.

In step 201, flag information of a first prediction mode corresponding to nodes in a current layer is determined; where the flag information of the first prediction mode is used for indicating an optimal prediction mode of the nodes in the current layer.

In the embodiments of the present disclosure, the flag information of the first prediction mode corresponding to the nodes in the current layer may be first determined, where the flag information of the first prediction mode is used for indicating the optimal prediction mode of the nodes in the current layer.

It should be noted that the encoding method in the embodiments of the present disclosure specifically refers to a point cloud encoding method, which may be applied to a point cloud encoder (which may also be referred to as an “encoder” for short).

Accordingly, in the embodiments of the present disclosure, the current layer may be a RAHT transform layer to be encoded.

Furthermore, in the embodiments of the present disclosure, a RAHT attribute transform encoding structure is required to be constructed based on geometric information of points in the point cloud. Specifically, the transform may be continuously performed from a voxel level until a root node is obtained, so as to complete hierarchal transform encoding of the entire attribute, thereby obtaining the RAHT attribute transform encoding structure including at least one RAHT transform layer.

It should be noted that in the embodiments of the present disclosure, the RAHT attribute transform may be performed based on a hierarchal order of the octree. In the constructing process of the RAHT attribute transform encoding structure, the transform may be continuously performed from the voxel level until the root node is obtained based on the hierarchal order of the octree. For the process of attribute predicting transform encoding, it may also be based on the hierarchal order of the octree, but the transform is continuously performed from the root node to the voxel level.

It can be understandable that in the embodiments of the present disclosure, it may be defined that a layer obtained by downsampling sequentially along a preset direction, such as a Z direction, a Y direction, and an X direction, once each time, is a RAHT transform layer, such as the current layer.

It should be noted that in the embodiments of the present disclosure, for the current layer, the current layer may include at least one point. Here, for the at least one point in the current layer, in a case of encoding the current layer, the at least one point may be used as a node to be encoded in the current layer.

Furthermore, in the embodiments of the present disclosure, each point in the current layer corresponds to a piece of geometric information and a piece of attribute information; where the geometric information represents a spatial relationship of the point, and the attribute information represents related information of an attribute of the point.

Here, the attribute information may be color information, reflectivity or other attributes, which is not specifically limited in the embodiments of the present disclosure. In a case where the attribute information is the color information, it may specifically be color information in any color space. Exemplarily, the attribute information may be color information in an RGB space, color information in a YUV space, color information in a YCbCr space, or the like, which is not specifically limited in the embodiments of the present disclosure.

It should be noted that in the embodiments of the present disclosure, the flag information of the first prediction mode may be used for determining the optimal prediction mode corresponding to the nodes in the current layer. Here, based on the flag information of the first prediction mode, a first prediction mode or a second prediction mode may be selected for performing encoding and decoding on the nodes in the current layer.

It should be noted that in the embodiments of the present disclosure, based on the optimal prediction mode indicated by the flag information of the first prediction mode, for nodes in the current layer that meet a condition for the attribute prediction, a prediction processing may be performed on the attribute information using the optimal prediction mode; while for nodes in the current layer that do not meet a condition for the attribute prediction, there is no need to perform the prediction processing on the attribute information.

That is, in the embodiments of the present disclosure, the optimal prediction mode indicated by the flag information of the first prediction mode corresponding to the nodes in the current layer may be applied to the nodes in the current layer that meet the condition for the attribute prediction.

Furthermore, in the embodiments of the present disclosure, in a case where determining the flag information of the first prediction mode corresponding to the nodes in the current layer, predictive encoding is performed on the nodes in the current layer based on the first prediction mode and the second prediction mode using the rate-distortion optimization algorithm, so that the flag information of the first prediction mode may be determined and the flag information of the first prediction mode may be signaled into the bitstream.

It may be understood that in the embodiments of the present disclosure, at the encoding side, in a case of determining the flag information of the first prediction mode corresponding to the nodes in the current layer, the flag information of the first prediction mode may be set using the rate-distortion optimization algorithm.

Exemplarily, in some embodiments, at the encoding side, the rate-distortion optimization algorithm may be introduced to adaptively select the predictive encoding method of the nodes in the current layer. In this process, two predictive encoding modes, namely the first prediction mode and the second prediction mode, may be introduced. The first prediction mode may be a prediction mode combining intra and inter, that is, the first prediction mode may include an attribute intra prediction mode and/or an attribute inter prediction mode, and the second prediction mode may include an attribute intra prediction mode.

It should be noted that in the embodiments of the present disclosure, by using the rate-distortion optimization algorithm, predictive encoding is performed at the encoding side on the attribute information of the nodes in the current layer using the two prediction modes, namely the first prediction mode and the second prediction mode. Then, an optimal encoding mode of the current layer is determined from the first prediction mode and the second prediction mode using the rate-distortion optimization algorithm, and the optimal encoding mode is passed to the decoding side.

It may be understood that in the embodiments of the present disclosure, after determining the optimal encoding mode of the current layer from the first prediction mode and the second prediction mode using the rate-distortion optimization algorithm, the flag information of the first prediction mode may be set. Specifically, a value of the flag information of the first prediction mode may be set, and then the flag information of the first prediction mode may be signaled into the bitstream and passed to the decoding side, so that the optimal encoding mode is passed to the decoding side.

Accordingly, in the embodiments of the present disclosure, the decoding side performs reconstruction and restoration on the attribute information of the current layer point to be decoded (the nodes in the current layer) using the predictive decoding mode indicated by the flag information of the first prediction mode obtained by parsing.

Exemplarily, in some embodiments, in the rate-distortion optimization algorithm, the distortion D between a reconstructed attribute and an original attribute of each prediction mode is calculated, and then a bitstream R required for encoding each prediction mode is obtained. A rate-distortion cost is calculated as follows:

$$J = D + λ x R$$

Here, λ may be calculated through an attribute quantization parameter. The current X calculation manner is as follows:

$$λ = {2}^{\frac{QP - 4}{6}} \times N$$

The parameter N is currently set to different values depending on reflectivity and color.

Further, in the embodiments of the present disclosure, after determining the flag information of the first prediction mode corresponding to the nodes in the current layer, in response to a value of the flag information of the first prediction mode being a first value, the optimal prediction mode corresponding to the nodes in the current layer is determined to be the first prediction mode; or in response to a value of the flag information of the first prediction mode being a second value, the optimal prediction mode corresponding to the nodes in the current layer is determined to be the second prediction mode.

It may be understood that in the embodiments of the present disclosure, the flag information of the first prediction mode may be used for indicating that the attribute information of the nodes in the current layer uses the first prediction mode or the second prediction mode for prediction.

It may be understood that in the embodiments of the present disclosure, the flag information of the first prediction mode may be used for indicating the optimal prediction mode of the attribute information of the nodes in the current layer.

It should be noted that in the embodiments of the present disclosure, the first value is different from the second value, and the first value and the second value may be in parameter forms or in numerical forms.

Exemplarily, in some embodiments, taking the first value being set to 1 and the second value being set to 0 as an example, the value of the flag information of the first prediction mode is determined. In response to the value of the flag information of the first prediction mode being 1, it may be determined that the attribute information of the nodes in the current layer may use the first prediction mode. In response to the value of the flag information of the first prediction mode being 0, it may be determined that the attribute information of the nodes in the current layer may use the second prediction mode.

It should be noted that in the embodiments of the present disclosure, the first prediction mode and the second prediction mode may be two different prediction modes. The first prediction mode may include an attribute intra prediction mode and/or an attribute inter prediction mode; and the second prediction mode may include an attribute intra prediction mode.

Furthermore, in the embodiments of the present disclosure, for a current node among the nodes in the current layer, the number of first neighbors corresponding to the current node and the number of second neighbors corresponding to a parent node of the current node may be determined.

In response to determining that the current node meets a condition for attribute prediction based on the number of the first neighbors and the number of the second neighbors, the flag information of the second prediction mode corresponding to the nodes in the current layer is determined. where, the flag information of the second prediction mode is used for determining whether to perform attribute inter prediction processing on the nodes in the current layer.

It should be noted that in the embodiments of the present disclosure, the number of the first neighbors is the number of neighboring nodes corresponding to the current node in the current layer; the number of the second neighbors is the number of neighboring nodes corresponding to the parent node of the current node in the current layer.

It may be understood that in the embodiments of the present disclosure, the condition for the attribute prediction is a condition for predicting the attribute information. Accordingly, it may be determined whether the prediction processing may be performed on the attribute information of the current node in the current layer based on the determined number of the first neighbors and the determined number of the second neighbors. That is, it may be determined whether the current node in the current layer meets the condition for predicting the attribute information based on the number of the first neighbors and the number of the second neighbors, that is, it is determined whether the attribute prediction may be used.

It may be understood that in the embodiments of the present disclosure, in a case of determining whether the current node in the current layer meets the condition for the attribute prediction based on the determined number of the first neighbors and the determined number of the second neighbors, in response to the number of the first neighbors being greater than a first threshold and the number of the second neighbors being greater than a second threshold, it may be determined that the current node meets the condition for the attribute prediction, that is, the attribute information of the current node may be predicted; and in response to the number of the first neighbors being less than or equal to the first threshold, or the number of the second neighbors being less than or equal to the second threshold, it may be determined that the current node does not meet the condition for the attribute prediction, that is, the attribute information of the current node is not allowed to be predicted.

It should be noted that in the embodiments of the present disclosure, the first threshold and the second threshold may be integers greater than 0, where the first threshold and the second threshold may be the same or different, which will not be specifically limited in the present disclosure.

Furthermore, in the embodiments of the present disclosure, in response to determining that the current node in the current layer meets the condition for the attribute prediction based on the number of the first neighbors and the number of the second neighbors, the flag information of the second prediction mode may be further determined. Here, the flag information of the second prediction mode corresponding to the nodes in the current layer may be determined.

It should be noted that in the embodiments of the present disclosure, the flag information of the second prediction mode is used for determining whether to perform the attribute inter prediction processing on the nodes in the current layer. That is, the second prediction mode information may be flag information for indicating whether to perform the inter prediction on the nodes in the current layer.

Furthermore, in the embodiments of the present disclosure, after determining the flag information of the second prediction mode corresponding to the nodes in the current layer, in response to a value of the flag information of the second prediction mode being a third value, the attribute inter prediction processing is allowed to be performed on the nodes in the current layer; or in response to the value of the flag information of the second prediction mode being a fourth value, the attribute inter prediction processing is disallowed to be performed on the nodes in the current layer.

That is, in the embodiments of the present disclosure, the flag information of the second prediction mode may be used for indicating whether to allow predicting the attribute information of the nodes in the current layer using the inter prediction mode.

It should be noted that in the embodiments of the present disclosure, the third value is different from the fourth value, and the third value and the fourth value may be in parameter forms or in numerical forms.

Exemplarily, in some embodiments, taking the third value being set to 1 and the fourth value being set to 0 as an example, the value of the flag information of the second prediction mode is determined. In response to the value of the flag information of the second prediction mode being 1, it may be determined that the attribute information of the nodes in the current layer may use the attribute inter prediction mode. In response to the value of the flag information of the second prediction mode being 0, it may be determined that the attribute information of the nodes in the current layer cannot use the attribute inter prediction mode.

Furthermore, in the embodiments of the present disclosure, after obtaining the flag information of the second prediction mode by parsing from the bitstream, in response to determining that the attribute inter prediction processing is allowed to be performed on the nodes in the current layer based on the flag information of the second prediction mode, the optimal prediction mode of the attribute information of the nodes in the current layer may be further determined. That is, the above process of determining the flag information of the first prediction mode may be performed. In response to determining that the attribute inter prediction processing is not allowed to be performed on the nodes in the current layer based on the flag information of the second prediction mode, the above process of determining the flag information of the first prediction mode may no longer be performed.

Furthermore, in the embodiments of the present disclosure, flag information of a third prediction mode corresponding to the nodes in the current layer is determined. In response to a value of the flag information of the third prediction mode being a fifth value, it is determined that the optimal prediction mode corresponding to the nodes in the current layer includes the transform mode and the prediction mode. In response to the value of the flag information of the third prediction mode being a sixth value, it is determined that the optimal prediction mode corresponding to the nodes in the current layer includes the prediction mode.

It should be noted that in the embodiments of the present disclosure, the flag information of the third prediction mode may be used for indicating whether the attribute information corresponding to the nodes in the current layer is determined by means of combining the transform mode with the prediction mode.

It may be understood that in the embodiments of the present disclosure, the fifth value is different from the sixth value, and the fifth value and the sixth value may be in parameter forms or in numerical forms.

Exemplarily, in some embodiments, taking the fifth value being set to 1 and the sixth value being set to 0 as an example, the value of the flag information of the third prediction mode is determined. In response to the value of the flag information of the third prediction mode being 1, it may be determined that the attribute information of the nodes in the current layer may be determined by means of combining the transform mode with the prediction mode, and then the flag information of the first prediction mode corresponding to the nodes in the current layer may be further determined based on the above method, so as to further determine that the attribute information is determined using the first prediction mode or the second prediction mode. In response to the value of the flag information of the prediction mode being 0, it may be determined that the attribute information of the nodes in the current layer cannot be determined by means of combining the transform mode with the prediction mode. For example, the attribute information of the nodes in the current layer is determined only using the transform mode. Therefore, there is no need to determine the flag information of the first prediction mode corresponding to the nodes in the current layer.

It may be understood that in the embodiments of the present disclosure, after determining the flag information of the third prediction mode, in response to determining that the optimal prediction mode corresponding to the nodes in the current layer includes the transform mode and the prediction mode based on the flag information of the third prediction mode, the process of determining the flag information of the first prediction mode may be further performed.

It may be seen that in the embodiments of the present disclosure, whether to determine the flag information of the first prediction mode corresponding to the nodes in the current layer depends on the flag information of the second prediction mode and/or the flag information of the third prediction mode. In a case where the flag information of the second prediction mode indicates that the attribute inter prediction processing is allowed to be performed on the nodes in the current layer, it is chosen that the flag information of the first prediction mode of the nodes in the current layer is further determined, that is, the processing flow of the step 201 is performed, so as to determine that the attribute information of the nodes in the current layer is determined using the first prediction mode or the second prediction mode. In a case where the flag information of the third prediction mode indicates that the optimal prediction mode corresponding to the nodes in the current layer includes the transform mode and the prediction mode, it is chosen that the flag information of the first prediction mode of the nodes in the current layer is further determined, that is, the processing flow of the step 201 is performed, so as to determine that the attribute information of the nodes in the current layer is determined using the first prediction mode or the second prediction mode.

It may be understood that in the embodiments of the present disclosure, the flag information of the first prediction mode may be used for determining that the attribute information of the nodes in the current layer is determined using the first prediction mode or the second prediction mode. The first prediction mode includes the attribute intra prediction mode and/or the attribute inter prediction mode, and the second prediction mode includes the attribute intra prediction mode.

Furthermore, in the embodiments of the present disclosure, the attribute information of the nodes in the current layer is determined by selecting to use the attribute intra prediction mode and/or the attribute inter prediction mode. In response to the value of the flag information of the first prediction mode being the first value, it may be determined that the optimal prediction mode corresponding to the nodes in the current layer is the first prediction mode, that is, the optimal prediction mode corresponding to the nodes in the current layer is the attribute intra prediction mode and/or the attribute inter prediction mode. In response to the value of the flag information of the first prediction mode being the second value, it may be determined that the optimal prediction mode corresponding to the nodes in the current layer is the second prediction mode, that is, the optimal prediction mode corresponding to the nodes in the current layer is the attribute intra prediction mode.

It may be understood that in the embodiments of the present disclosure, in response to the flag information of the first prediction mode indicating that the first prediction mode is used for determining the attribute information of the nodes in the current layer, it may be considered that in a case of performing attribute prediction on the nodes in the current layer, a manner of combining the attribute intra prediction mode with the attribute inter prediction mode may be selected.

In step 202, attribute prediction values of the nodes in the current layer are determined based on the optimal prediction mode corresponding to the nodes in the current layer.

In the embodiments of the present disclosure, after determining the flag information of the first prediction mode corresponding to the nodes in the current layer, the attribute prediction values of the nodes in the current layer may be further determined based on the optimal prediction mode corresponding to the nodes in the current layer.

Furthermore, in the embodiments of the present disclosure, in response to the optimal prediction mode corresponding to the nodes in the current layer being the first prediction mode, that is, the attribute information of the nodes in the current layer is predicted by means of combining the attribute intra prediction mode with the attribute inter prediction mode, then in a case where the attribute prediction values of the nodes in the current layer are determined based on the optimal prediction mode corresponding to the nodes in the current layer, reference positions corresponding to the nodes in the current layer may be determined in a reference picture corresponding to the current picture based on geometric information corresponding to the nodes in the current layer. In response to the reference positions corresponding to reconstructed reference points, the attribute prediction values of the nodes in the current layer may be further determined based on the attribute reconstruction values of the reconstructed reference points.

It may be understood that in the embodiments of the present disclosure, for a current node in the current layer, geometric information of the current node may be first determined, and then the corresponding reference position may be determined in the reference picture corresponding to the current picture using the geometric information, and it may be determined whether the inter prediction node of the current node is valid based on the reference position, that is, whether there is a co-located node of the current node in the reference picture.

It should be noted that in the embodiments of the present disclosure, the current picture may be a video picture to be encoded. Accordingly, the reference picture may be at least one encoded video picture.

It may be understood that in the embodiments of the present disclosure, for the current picture and the corresponding reference picture, the RAHT transform layer is constructed by selecting to use a same manner, that is, based on the hierarchal order of the octree, the transform may be continuously performed from the voxel level until the root node is obtained, so as to construct the RAHT attribute transform encoding structure. Therefore, the current picture and the corresponding reference picture have corresponding RAHT attribute transform encoding structures, and then the corresponding reference position may be determined in the reference picture based on set information of any node in the current layer.

It should be noted that in the embodiments of the present disclosure, in response to there being co-located nodes (reconstructed reference points) of the nodes in the current layer at the reference positions corresponding to the nodes in the current layer in the reference picture, it may be determined that the co-located nodes are inter prediction nodes corresponding to the nodes in the current layer, that is, the inter prediction nodes corresponding to the nodes in the current layer are valid (i.e., the reconstructed reference points exist).

Correspondingly, in the embodiments of the present disclosure, in response to determining that the inter prediction nodes corresponding to the nodes in the current layer are valid, attribute reconstruction values of the inter prediction nodes (reconstructed reference points) may be directly selected as the attribute prediction values of the nodes in the current layer.

Furthermore, in the embodiments of the present disclosure, in response to the optimal prediction mode corresponding to the nodes in the current layer being the first prediction mode, that is, the attribute information of the nodes in the current layer is predicted by means of combining the attribute intra prediction mode with the attribute inter prediction mode, then in a case where the attribute prediction values of the nodes in the current layer are determined based on the optimal prediction mode corresponding to the nodes in the current layer, the reference positions corresponding to the nodes in the current layer may be first determined in the reference picture corresponding to the current picture based on the geometric information corresponding to the nodes in the current layer. In response to the reference positions not corresponding to any reconstructed reference point, the neighboring nodes corresponding to the nodes in the current layer may be further determined in the current picture based on the geometric information corresponding to the nodes in the current layer; and then the attribute prediction values of the nodes in the current layer are determined based on the attribute prediction values of the neighboring nodes.

It should be noted that in the embodiments of the present disclosure, in response to there being no reconstructed reference points corresponding to the reference positions corresponding to the nodes in the current layer in the reference picture, that is, there are no co-located nodes (reconstructed reference points) of the nodes in the current layer, it may be determined that the inter prediction nodes corresponding to the nodes in the current layer are invalid (i.e., there are no reconstructed reference points).

Accordingly, in the embodiments of the present disclosure, in response to determining that the inter prediction nodes corresponding to the nodes in the current layer are invalid, the inter reference points cannot be used for determining the attribute prediction values of the nodes in the current layer. Therefore, it is necessary to use attribute prediction values of intra neighboring nodes to determine the attribute prediction values of the nodes in the current layer. That is, the neighboring nodes corresponding to the nodes in the current layer may be determined in the current picture based on the geometric information corresponding to the nodes in the current layer; and then the attribute prediction values of the nodes in the current layer may be determined based on the attribute prediction values of the neighboring nodes.

It may be seen that in the embodiments of the disclosure, in response to the optimal prediction mode corresponding to the nodes in the current layer being the first prediction mode, that is, the attribute information of the nodes in the current layer is predicted by means of combining the attribute intra prediction mode with the attribute inter prediction mode, for a current node to be encoded in the current layer, a co-located prediction node (a reference node) of the node to be encoded may be obtained in the reference picture using the geometric information of the current node to be encoded, and then a predicted attribute (i.e., an attribute prediction value) of the current node to be encoded may be obtained using the geometric information and attribute information of the reference node.

It may be understood that in the embodiments of the present disclosure, for the current node in the current layer, in response to the inter prediction node of the current node being valid, that is, the co-location node exists, an attribute of the prediction node may be directly used as the attribute prediction value of the current node; or in response to the inter prediction node of the current node being invalid, that is, the co-location node does not exist, an attribute prediction value of an intra neighboring node may be used as the attribute prediction value of the current node.

Furthermore, in the embodiments of the present disclosure, in response to the optimal prediction mode corresponding to the nodes in the current layer being the second prediction mode, that is, the attribute information of the nodes in the current layer is predicted using the attribute intra prediction mode, then in a case where the attribute prediction values of the nodes in the current layer are determined based on the optimal prediction mode corresponding to the nodes in the current layer, the neighboring nodes corresponding to the nodes in the current layer may be determined in the current picture based on the geometric information corresponding to the nodes in the current layer; and then the attribute prediction values of the nodes in the current layer are determined based on the attribute prediction values of the neighboring nodes.

It should be noted that in the embodiments of the present disclosure, regardless of whether the optimal prediction mode corresponding to the nodes in the current layer is the first prediction mode or the second prediction mode, in a case where the attribute prediction values of the nodes in the current layer are determined based on the attribute prediction values of the neighboring nodes, the attribute prediction values of the nodes in the current layer are determined based on the attribute reconstruction values and relative distance parameters corresponding to the neighboring nodes.

It should be noted that in the embodiments of the present disclosure, the relative distance parameters corresponding to the neighboring nodes may represent the spatial geometric distances between the child nodes corresponding to the nodes in the current layer and the neighboring nodes corresponding to the nodes in the current layer.

Exemplarily, in some embodiments, for the current node in the current layer, the current node includes two sub-nodes, that is, sub-node 1 and sub-node 2. A relative distance parameter between the current node and a neighboring node may include a spatial geometric distance between the sub-node 1 and the neighboring node, and may further include a spatial geometric distance between the sub-node 2 and the neighboring node.

Exemplarily, in some embodiments, for the current node in the current layer, linear fitting may be performed using attribute prediction values of neighborhood nodes (neighboring nodes) of the current node and a spatial geometric distance of each neighborhood node from the child node of the current node. Thus, the predicted attribute value of each child node of the current node may be obtained, and then the attribute prediction value of the current node may be determined.

Exemplarily, in some embodiments, for the current node in the current layer, 19 neighboring nodes of the current node may be determined, and then linear weighted prediction may be performed on the attribute of each child node using the spatial geometric distances between the neighboring nodes and each child node of the current node, and thus the attribute prediction value of each child node may be obtained.

Furthermore, in the embodiments of the present disclosure, after determining the attribute prediction values of the nodes in the current layer based on the optimal prediction mode corresponding to the nodes in the current layer, the RAHT transform may be further performed based on the attribute prediction values of the nodes in the current layer and the attribute values of the nodes in the current layer, so as to determine reconstructed values of high-frequency coefficients and low-frequency coefficients corresponding to the parent nodes of the nodes in the current layer. Then, RAHT inverse transform is performed based on the reconstructed values of the high-frequency coefficients and the low-frequency coefficients, so as to determine the attribute reconstruction values of the nodes in the current layer.

Furthermore, in the embodiments of the present disclosure, in a case where the RAHT transform is performed based on the attribute prediction values of the nodes in the current layer and the attribute values of the nodes in the current layer to determine reconstructed values of high-frequency coefficients and low-frequency coefficients corresponding to the parent nodes of the nodes in the current layer, the RAHT transform may be performed based on the attribute prediction values of the nodes in the current layer to determine prediction values of the high-frequency coefficients and the low-frequency coefficients corresponding to the parent nodes of the nodes in the current layer. In addition, the RAHT transform may be performed based on the attribute values of the nodes in the current layer to determine the high-frequency coefficients and the low-frequency coefficients corresponding to the parent nodes of the nodes in the current layer. Then, the reconstructed values of the high-frequency coefficients corresponding to the parent nodes of the nodes in the current layer are determined based on the prediction values of the high-frequency coefficients corresponding to the parent nodes of the nodes in the current layer and the high-frequency coefficient corresponding to the parent nodes of the nodes in the current layer.

It may be understood that in the embodiments of the present disclosure, for the current node in the current layer, after determining the attribute prediction value of the current node, RAHT attribute transform is performed using the attribute prediction value, so as to obtain the corresponding DC coefficient and AC coefficient, that is, the corresponding DC coefficient and AC coefficient of the parent node of the current node. Here, the DC coefficient is the low-frequency coefficient, and the AC coefficient is the high-frequency coefficient.

It should be noted that in the embodiments of the present disclosure, for the current node in the current layer, the AC coefficient obtained by performing RAHT attribute transform using the attribute prediction value of the current node may be understood as the prediction value of the high-frequency coefficient corresponding to the parent node of the current node.

Correspondingly, in the embodiments of the present disclosure, for the current node in the current layer, the DC coefficient and the AC coefficient corresponding to the parent node of the current node may be obtained by performing RAHT attribute transform using the attribute value of the current node. Here, the DC coefficient is the low-frequency coefficient, and the AC coefficient is the high-frequency coefficient. The AC coefficient determined based on the attribute value of the current node may be understood as an original value of the high-frequency coefficient corresponding to the parent node of the current node.

Furthermore, in the embodiments of the present disclosure, in a case where the reconstructed values of the high-frequency coefficients corresponding to the parent nodes of the nodes in the current layer are determined based on the prediction values of the high-frequency coefficients corresponding to the parent nodes of the nodes in the current layer and the high-frequency coefficients corresponding to the parent nodes of the nodes in the current layer, coefficient residuals corresponding to the parent nodes of the nodes in the current layer may be determined based on the prediction values of the high-frequency coefficients corresponding to the parent nodes of the nodes in the current layer and the high-frequency coefficients corresponding to the parent nodes of the nodes in the current layer. Then, the reconstructed values of the high-frequency coefficients corresponding to the parent nodes of the nodes in the current layer may be determined based on the coefficient residuals corresponding to the parent nodes of the nodes in the current layer.

Furthermore, in the embodiments of the present disclosure, in a case where the reconstructed values of the high-frequency coefficients corresponding to the parent nodes of the nodes in the current layer are determined based on the prediction values of the high-frequency coefficients corresponding to the parent nodes of the nodes in the current layer and the high-frequency coefficients corresponding to the parent nodes of the nodes in the current layer, the coefficient residuals corresponding to the parent nodes of the nodes in the current layer may be determined based on the prediction values of the high-frequency coefficients corresponding to the parent nodes of the nodes in the current layer and the high-frequency coefficients corresponding to the parent nodes of the nodes in the current layer. Then, the reconstructed values of the high-frequency coefficients corresponding to the parent nodes of the nodes in the current layer may be determined based on the coefficient residuals corresponding to the parent nodes of the nodes in the current layer.

It should be noted that in the embodiments of the present disclosure, after obtaining the coefficient residuals corresponding to the parent nodes of the nodes in the current layer, the coefficient residuals may be further quantized to determine quantized coefficient residuals corresponding to the parent nodes of the nodes in the current layer. Then, the quantized coefficient residuals may be signaled into the bitstream and passed to the decoding side, so that the decoder may reconstruct the corresponding high-frequency coefficients based on the quantized coefficient residuals obtained by decoding the bitstream.

Furthermore, in the embodiments of the present disclosure, after quantizing the coefficient residuals to determine the quantized coefficient residual corresponding to the parent nodes of the nodes in the current layer, inverse quantization may be further performed on the quantized coefficient residuals to determine inverse-quantized residual values corresponding to the parent nodes of the nodes in the current layer. Then, the reconstructed values of the high-frequency coefficients corresponding to the parent node of the nodes in the current layer may be determined based on the inverse-quantized residual values corresponding to the parent nodes of the nodes in the current layer and the prediction values of the high-frequency coefficients corresponding to the parent nodes of the nodes in the current layer.

Exemplarily, in some embodiments, the inverse-quantized residual values corresponding to the parent nodes of the nodes in the current layer and the prediction values of the high-frequency coefficients corresponding to the parent nodes of the nodes in the current layer may be summed up to obtain the reconstructed values of the high-frequency coefficients corresponding to the parent nodes of the nodes in the current layer.

Furthermore, in the embodiments of the present disclosure, after determining the low-frequency coefficients and the reconstruction values of the high-frequency coefficients corresponding to the parent nodes of the nodes in the current layer, the RAHT inverse transform may be performed based on the reconstruction values of the high-frequency coefficients and the low-frequency coefficients, and then the attribute reconstruction values of the nodes in the current layer may be determined.

Exemplarily, in some embodiments, it is assumed that

$${g}_{L , 2 x , y , z}^{′} and {g}_{L , 2 x + 1 , y , z}^{′}$$

are two attribute DC coefficients of neighboring points in an L layer. After linear transform, information of an L−1 layer is an AC coefficient

$${f}_{L - 1 , x , y , z}^{′}$$

and a DC coefficient

$${g}_{L - 1 , x , y , z}^{′} .$$

Then, no more transform will be performed on

$${f}_{L - 1 , x , y , z}^{′}$$

and quantization encoding may be directly performed on

$${f}_{L - 1 , x , y , z}^{′} ; {g}_{L - 1 , x , y , z}^{′}$$

will continue to search for nearest-neighbors for transform, and if the nearest-neighbor cannot be found,

$${g}_{L - 1 , x , y , z}^{′}$$

will be passed directly to an L−2 layer. That is, the RAHT transform is only valid for nodes with neighboring points. Nodes without neighboring points will be passed directly to a previous layer. In this transform process, the weights (the number of non-empty child nodes in a node) corresponding to

$${g}_{L , 2 x , y , z}^{′} and {g}_{L , 2 x + 2 , y , z}^{′}$$

are

$${w}_{L , 2 x , y , z}^{′} and {w}_{L , 2 x + 1 , y , z}^{′}$$

$$( abbreviated as {w}_{0}^{′} and {w}_{1}^{′} ) ,$$

and the weight of

$${g}_{L - 1 , x , y , z}^{′} is {w}_{L - 1 , x , y , z}^{′} ,$$

then a general transform formula is:

$$[ \begin{matrix}{g}_{L - 1 , x , y , z}^{′} \\ {f}_{L - 1 , x , y , z}^{′}\end{matrix} ] = {T}_{w 0 , w 1} [ \begin{matrix}{g}_{L , 2 x , y , z}^{′} \\ {g}_{L , 2 x + 1 , y , z}^{′}\end{matrix} ]$$

Here, T_{w0,w1} is a transform matrix, which will be updated as the weights corresponding to each point adaptively. The forward transform of the RAHT (also referred to as “RAHT forward transform”) is illustrated in the above FIG. 35A.

Exemplarily, in some embodiments, the attribute reconstruction value of the child node of the current node may be restored by performing inverse transform of the RAHT based on the obtained DC coefficient and AC coefficient of the child node of the current node. Here, the inverse transform of the RAHT (also referred to as “RAHT inverse transform” or “RAHT reverse transform”) is illustrated in the above FIG. 35B.

In conclusion, in the embodiments of the present disclosure, in a case where inter RAHT prediction is performed on attributes, in response to the attribute prediction being performed on the current layer to be encoded (the current layer), two encoding modes may be introduced to the current layer to be encoded, and then the optimal predictive encoding mode may be further selected for predictive encoding, which may improve the attribute encoding and decoding efficiency of point cloud.

Exemplarily, in some embodiments, the encoding and decoding efficiency of the attributes are showed using the encoding and decoding method provided in the embodiments of the present disclosure, which is shown in the Table 2.

It may be seen from the Table 2 that, for sequences that may use the inter attribute prediction, the attribute encoding BPP is reduced by about 17.15%. It may be seen that the encoding and decoding method provided in the embodiments of the present disclosure may significantly improve the attribute encoding efficiency of the point cloud.

It may be seen that in the encoding and decoding method provided in the embodiments of the present disclosure, at the encoding side, in a case of performing RAHT predictive encoding on the attributes, a predictive encoding mode in each RAHT encoding layer is introduced to adaptively select a combination of the inter predictive encoding mode with the intra predictive encoding mode or the intra predictive encoding mode, and the encoding mode is passed to the decoding side. The decoding side uses the encoding mode to reconstruct the attributes of the point cloud. In the embodiments of the present disclosure, the core is to introduce an encoding mode in each RAHT encoding layer to obtain the optimal encoding mode using the rate-distortion optimization selection algorithm at the encoding side, and then to use the decoding mode at the decoding side to reconstruct the attributes of the point cloud.

It should be noted that in the embodiments of the present disclosure, the encoding mode of each layer may be stored in an attribute block header (ABH), and a decoding mode of the encoding layer of the RAHT may be obtained using the ABH at the decoding side. Here, a form in which the parameter is encoded is not limited in the embodiments of the present disclosure.

The embodiments of the present disclosure provide an encoding method. The encoder determines the flag information of the first prediction mode corresponding to the nodes in the current layer, the flag information of the first prediction mode being used for indicating the optimal prediction mode of the nodes in the current layer; and determines the attribute prediction values of the nodes in the current layer based on the optimal prediction mode corresponding to the nodes in the current layer. It may be seen that in the embodiments of the present disclosure, during predicting the attribute information, the flag information of the first prediction mode may be transmitted in the bitstream, and the first prediction mode flag information may indicate the optimal prediction mode of the nodes in the current layer, so that the prediction mode determined by the flag information of the first prediction mode may be used for predicting the attribute information of the nodes in the current layer, which may effectively remove the redundancy of the attributes, and improve the attribute encoding and decoding efficiency of the point cloud, thereby improving the encoding and decoding performance of the point cloud.

Based on the above embodiments, another embodiment of the present disclosure provides an encoding and decoding method. In the encoding and decoding method, in a case of performing RAHT inter prediction on attributes, in response to the current layer to be encoded performing attribute prediction, two encoding modes are introduced to the current layer to be encoded, and then an optimal predictive encoding mode for predictive encoding is selected using the rate-distortion optimization algorithm, thereby improving the attribute encoding efficiency of the point cloud.

It can be understandable that in the common G-PCC RAHT attribute inter encoding, attribute prediction is only performed on the upper layers (e.g., first N layers, N=5) of the RAHT encoding structure using inter reconstruction points, and attribute prediction is performed on the lower layers using the attribute intra prediction. Such an attribute encoding scheme does not fully and effectively utilize a correlation between spatial and temporal domains of the point cloud to remove the redundancy of attributes, resulting in low encoding efficiency of attribute information.

Based on this problem, this scheme adaptively selects the optimal predictive encoding method for each layer of the RAHT attribute encoding structure by introducing the rate-distortion optimization algorithm, and then passes the attribute predictive encoding mode to the decoding side. The decoding side adaptively restores the attribute information of the point cloud using the predicted decoding mode obtained through parsing, thereby further improving the encoding efficiency of the attribute information of the point cloud.

Exemplarily, in some embodiments, a RAHT attribute encoding layer may be defined. The current attribute RAHT transform encoding order is to partition the attributes from the root node in sequence to the voxel levels (1×1×1), thereby completing the attribute encoding and attribute reconstruction of the entire point cloud. Here, it may be defined that a layer obtained by downsampling along the Z direction, the Y direction and the X direction once each time is a RAHT transform layer (i.e., layer).

Exemplarily, in some embodiments, based on the RAHT attribute encoding layer, the predictive encoding mode of the current layer is adaptively selected by introducing the rate-distortion optimization algorithm, and two predictive encoding modes are introduced: 1. a prediction mode combined intra and inter (an existing manner); 2. an intra prediction mode.

Exemplarily, in some embodiments, at the encoding side, by using the rate-distortion optimization algorithm, predictive encoding is performed on the attribute information of the nodes in the current layer using two prediction modes. Then, the optimal encoding mode of the current layer is obtained using the rate-distortion optimization algorithm, and the optimal encoding mode is passed to the decoding side. The decoding side performs reconstruction and restoration on the attribute information of the current layer point to be decoded using the predictive decoding mode obtained by parsing. Here, in the rate-distortion optimization algorithm, the distortion D between a reconstructed attribute and an original attribute of each prediction mode is first calculated, and then a bitstream R required for encoding each prediction mode is obtained. A rate-distortion cost is calculated as follows:

$$J = D + λ xR$$

Here, λ may be calculated through an attribute quantization parameter. The current X calculation manner is as follows:

$$λ = {2}^{\frac{QP - 4}{6}} \times N$$

The parameter N is currently set to different values depending on reflectivity and color.

Furthermore, in the embodiments of the present disclosure, a predictive encoding mode of each layer is added to the ABH parameter set, and the specific algorithm at the encoding side is as follows.

In step 1, it is adaptively determined whether the nodes in the current layer may use attribute prediction based on the number of neighborhood nodes in the current layer and the number of neighborhood nodes of the parent nodes.

In step 2, in response to the nodes in the current layer using the attribute prediction and performing the attribute inter prediction, the rate-distortion optimization algorithm is introduced for the current layer, costs corresponding to each predictive encoding mode are calculated by encoding each node in the current layer, so as to obtain the optimal predictive encoding mode.

In step 3, predictive encoding is performed on the attributes of the nodes in the current layer using the optimal predictive encoding mode.

The specific algorithm at the decoding side is as follows.

In step 1, it is adaptively determined whether the nodes in the current layer may use attribute prediction based on the number of neighborhood nodes in the current layer and the number of neighborhood nodes of the parent nodes.

In step 2, in response to the nodes in the current layer using the attribute prediction and performing the attribute inter prediction, the optimal predictive decoding mode of the current layer may be obtained for the nodes.

In step 3, predictive decoding is performed on the attributes of the nodes in the current layer using the optimal predictive decoding mode.

In conclusion, in the encoding and decoding method provided in the embodiments of the present disclosure, in a case where inter RAHT prediction is performed on attributes, in response to the attribute prediction being performed on the current layer to be encoded, two encoding modes may be introduced to the current layer to be encoded. Then, the optimal predictive encoding mode may be further selected for predictive encoding using the rate-distortion optimization algorithm, which may improve the attribute encoding efficiency of the point cloud.

That is, in the encoding and decoding method provided in the embodiments of the present disclosure, in a case of performing RAHT predictive encoding on the attributes, a predictive encoding mode in each RAHT encoding layer is introduced to adaptively select a combination of the inter predictive encoding mode with the intra predictive encoding mode or the intra predictive encoding mode, and the encoding mode is passed to the decoding side. The decoding side reconstructs the attributes of the point cloud using the encoding mode. In this scheme, the focus is on introducing an encoding mode in each RAHT encoding layer to obtain the optimal encoding mode using the rate-distortion optimization selection algorithm at the encoding side, and then reconstructing the attributes of the point cloud using the decoding mode at the decoding side.

Currently, the encoding mode of each layer is stored in the ABH, and the decoding mode of the encoding layer of the RAHT is obtained through the ABH at the decoding side. There is no restriction on the form in which the parameter is encoded.

The embodiments of the present disclosure provide an encoding and decoding method.

The encoder and the decoder determine flag information of a first prediction mode corresponding to nodes in a current layer, the flag information of the first prediction mode being used for indicating an optimal prediction mode of the nodes in the current layer; determine the optimal prediction mode corresponding to the nodes in the current layer based on the flag information of the first prediction mode; and determine attribute prediction values of the nodes in the current layer based on the optimal prediction mode corresponding to the nodes in the current layer. It may be seen that in the embodiments of the present disclosure, during predicting attribute information, the flag information of the first prediction mode may be transmitted in the bitstream, and the first prediction mode flag information may indicate the optimal prediction mode of the nodes in the current layer, so that the prediction mode determined by the flag information of the first prediction mode may be used for predicting attribute information of the nodes in the current layer, which may effectively remove the redundancy of the attributes, and improve the attribute encoding and decoding efficiency of the point cloud, thereby improving the encoding and decoding performance of the point cloud.

Based on the above embodiments, in yet another embodiment of the present disclosure, based on the same inventive concept as the above embodiments, FIG. 43 is a first schematic diagram of a composition structure of an encoder. As illustrated in FIG. 43, an encoder 20 may include a first determining unit 211.

The first determining unit 211 is configured to determine flag information of a first prediction mode corresponding to nodes in a current layer, where the flag information of the first prediction mode is used for indicating an optimal prediction mode of the nodes in the current layer; and determine attribute prediction values of the nodes in the current layer based on the optimal prediction mode corresponding to the nodes in the current layer.

It may be understood that in the embodiments, the “unit” may be part of a circuit, part of a processor, part of a program or software, or the like, and may also be a module or may be non-modular. Moreover, various components in the embodiments may be integrated into one processing unit, or each unit may be physically present alone, or two or more units may be integrated into one unit. The above integrated unit may be implemented in the form of hardware or a software function module.

The integrated unit may be stored in a non-transitory computer readable storage medium if implemented in the form of the software functional module and not sold or used as a separate product. Based on such understanding, for the technical solution in the embodiments, an essential of the technical solution, or a part of the technical solution that contributes to the prior art, or a whole or part of the technical solution may be embodied in the form of a software product, and the computer software product is stored in a storage medium and includes various instructions for causing a computer device (which may be a personal computer, a server, or a network device) or a processor to perform all or part of the steps of the method described in the various embodiments of the present disclosure. The above storage medium includes various media that can store program codes, such as a USB flash drive (U disk), a mobile hard disk, a read only memory (ROM), a random access memory (RAM), a diskette, or an optical disk.

Therefore, the embodiments of the present disclosure provide a non-transitory computer-readable storage medium, which is applied to an encoder 20. The computer-readable storage medium has a computer program stored thereon, and the computer program, when executed by a first processor, implements the methods described in any one of the above embodiments.

Based on the compositions of the above encoder 20 and the non-transitory computer-readable storage medium, FIG. 44 is a second schematic diagram of the composition structure of the encoder. As illustrated in FIG. 44, the encoder 20 may include a first memory 221, a first processor 222, a first communication interface 223 and a first bus system 224. The first memory 221, the first processor 222, and the first communication interface 223 are coupled together via the first bus system 224. It may be understood that the first bus system 224 is configured to implement connection and communication between these components. The first bus system 224 includes not only a data bus but also a power bus, a control bus, and a status signal bus. However, for the sake of clarity, various buses are collectively referred to as the first bus system 224.

The first communication interface 223 is configured to receive and transmit signals in a process of receiving and transmitting information with other external network elements.

The first memory 221 is configured to store a computer program capable of being running on the first processor.

The first processor 222 is configured to determine flag information of a first prediction mode corresponding to nodes in a current layer, the flag information of the first prediction mode being used for indicating an optimal prediction mode of the nodes in the current layer; and determine attribute prediction values of the nodes in the current layer based on the optimal prediction mode corresponding to the nodes in the current layer.

It may be understood that the first memory 221 in the embodiments of the present disclosure may be a volatile memory or a non-volatile memory, or may include both volatile and non-volatile memories. The non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM), which is used as an external cache. By way of illustration but not limitation, many forms of RAMs are available, such as a static random access memory (static RAM, SRAM), a dynamic random access memory (dynamic RAM, DRAM), a synchronous dynamic random access memory (synchronous DRAM, SDRAM), a double data rate synchronous dynamic random access memory (double Data Rate SDRAM, DDR SDRAM), an enhanced synchronous dynamic random access memory (enhanced SDRAM, ESDRAM), a synchronous link dynamic random access memory (synchlink DRAM, SLDRAM), and a direct memory bus random access memory (direct rambus RAM, DRRAM). The first memory 221 of the systems and methods described herein is intended to include, but is not limited to, these and any other suitable types of memories.

The first processor 222 may be an integrated circuit chip having a signal processing capability. In the implementation process, various steps of the above methods may be completed by an integrated logic circuit of hardware or instructions in the form of software in the first processor 222. The first processor 222 mentioned above may be a general-purpose processor, a digital signal processor (DSP), an application specific integrated circuit (ASIC), a field programmable gate array (FPGA) or other programmable logic devices, a discrete gate or transistor logic devices, and discrete hardware components. Various methods, steps and logic block diagrams disclosed in the embodiments of the present disclosure may be implemented or performed. A general-purpose processor may be a microprocessor, or the processor may be any conventional processor or the like. The steps of the methods disclosed in combination with the embodiments of the present disclosure may be directly embodied as being performed and completed by a hardware decoding processor, or by a combination of hardware and software modules in the decoding processor. The software module may be located in a mature storage medium in the art such as a random access memory, a flash memory, a read-only memory, a programmable read-only memory, an electrically erasable programmable memory, or a register. The storage medium is located in the first memory 221, and the first processor 222 reads the information in the first memory 221 and completes the steps of the above methods in combination with its hardware.

It may be understood that the embodiments described in the present disclosure may be implemented by hardware, software, firmware, middleware, microcode, or a combination thereof. For hardware implementation, the processing unit may be implemented in one or more application specific integrated circuits (ASICs), digital signal processors (DSPs), digital signal processing devices (DSPDs), programmable logic devices (PLDs), field programmable gate arrays (FPGAs), general-purpose processors, controllers, microcontrollers, microprocessors, other electronic units configured to perform the functions described in the present disclosure, or a combination thereof. For software implementation, the technology described in the present disclosure may be implemented through modules (e.g., procedures, functions) that perform the functions described in the present disclosure. The software codes may be stored in a memory and executed by a processor. The memory may be implemented within the processor or external to the processor.

Optionally, as another embodiment, the first processor 222 is further configured to perform the methods described in any one of the above embodiments when executing the computer program.

The embodiments of the present disclosure provide an encoder. The encoder determines the flag information of the first prediction mode corresponding to the nodes in the current layer, the flag information of the first prediction mode being used for indicating the optimal prediction mode of the nodes in the current layer; and determines the attribute prediction values of the nodes in the current layer based on the optimal prediction mode corresponding to the nodes in the current layer. It may be seen that in the embodiments of the present disclosure, during predicting the attribute information, the flag information of the first prediction mode may be transmitted in the bitstream, and the first prediction mode flag information may indicate the optimal prediction mode of the nodes in the current layer, so that the prediction mode determined by the flag information of the first prediction mode may be used for predicting the attribute information of the nodes in the current layer, which may effectively remove the redundancy of the attributes, and improve the attribute encoding and decoding efficiency of the point cloud, thereby improving the encoding and decoding performance of the point cloud.

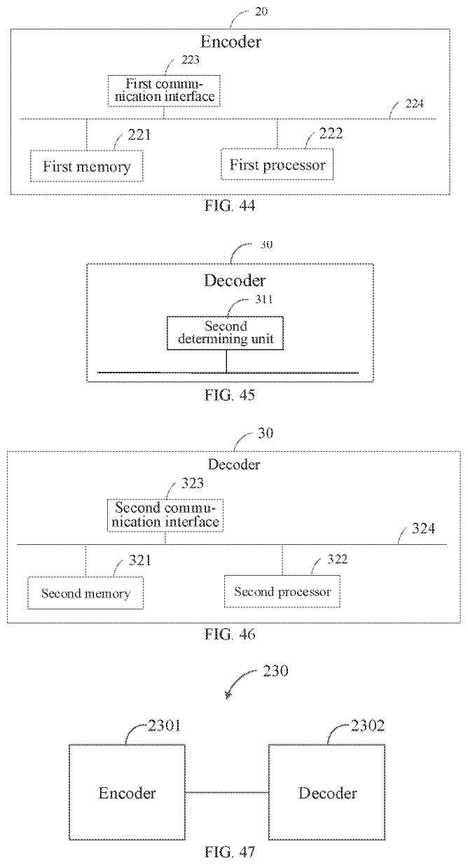

FIG. 45 is a first schematic diagram of a composition structure of a decoder. As illustrated in FIG. 45, the decoder 30 may include a second determining unit 311.

The second determining unit 311 is configured to decode a bitstream to determine flag information of a first prediction mode corresponding to nodes in a current layer, the flag information of the first prediction mode being used for indicating an optimal prediction mode of the nodes in the current layer; determine the optimal prediction mode corresponding to the nodes in the current layer based on the flag information of the first prediction mode; and determine attribute prediction values of the nodes in the current layer based on the optimal prediction mode corresponding to the nodes in the current layer.

It may be understood that in the embodiments, the “unit” may be part of a circuit, part of a processor, part of a program or software, or the like, and may also be a module or may be non-modular. Moreover, various components in the embodiments may be integrated into one processing unit, or each unit may be physically present alone, or two or more units may be integrated into one unit. The above integrated unit may be implemented in the form of hardware or a software function module.

The integrated unit may be stored in a non-transitory computer readable storage medium if implemented in the form of the software functional module and not sold or used as a separate product. Based on such understanding, for the technical solution in the embodiments, an essential of the technical solution, or a part of the technical solution that contributes to the prior art, or a whole or part of the technical solution may be embodied in the form of a software product, and the computer software product is stored in a storage medium and includes various instructions for causing a computer device (which may be a personal computer, a server, or a network device) or a processor to perform all or part of the steps of the method described in the various embodiments of the present disclosure. The above storage medium includes various media that can store program codes, such as a USB flash drive (U disk), a mobile hard disk, a read only memory (ROM), a random access memory (RAM), a diskette, or an optical disk.

Therefore, the embodiments of the present disclosure provide a non-transitory computer-readable storage medium, which is applied to a decoder 30. The non-transitory computer-readable storage medium has a computer program stored thereon, and the computer program, when executed by a first processor, implements the methods described in any one of the above embodiments.

Based on the compositions of the above decoder 30 and the non-transitory computer-readable storage medium, FIG. 46 is a second schematic diagram of the composition structure of the decoder. As illustrated in FIG. 46, the decoder 30 may include a second memory 321, a second processor 322, a second communication interface 323 and a second bus system 324. The second memory 321, the second processor 322, and the second communication interface 323 are coupled together via the second bus system 324. It may be understood that the second bus system 324 is configured to implement connection and communication between these components. The second bus system 324 includes not only a data bus but also a power bus, a control bus, and a status signal bus. However, for the sake of clarity, various buses are collectively referred to as the second bus system 324.

The second communication interface 323 is configured to receive and transmit signals in a process of receiving and transmitting information with other external network elements.

The second memory 321 is configured to store a computer program capable of being running on the second processor.

The second processor 322 is configured to decode a bitstream to determine flag information of a first prediction mode corresponding to nodes in a current layer, the flag information of the first prediction mode being used for indicating an optimal prediction mode of the nodes in the current layer; determine the optimal prediction mode corresponding to the nodes in the current layer based on the flag information of the first prediction mode; and determine attribute prediction values of the nodes in the current layer based on the optimal prediction mode corresponding to the nodes in the current layer.

It may be understood that the second memory 321 in the embodiments of the present disclosure may be a volatile memory or a non-volatile memory, or may include both volatile and non-volatile memories. The non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM), which is used as an external cache. By way of illustration but not limitation, many forms of RAMs are available, such as a static random access memory (static RAM, SRAM), a dynamic random access memory (dynamic RAM, DRAM), a synchronous dynamic random access memory (synchronous DRAM, SDRAM), a double data rate synchronous dynamic random access memory (double Data Rate SDRAM, DDR SDRAM), an enhanced synchronous dynamic random access memory (enhanced SDRAM, ESDRAM), a synchronous link dynamic random access memory (synchlink DRAM, SLDRAM), and a direct memory bus random access memory (direct rambus RAM, DRRAM). The second memory 321 of the systems and methods described herein is intended to include, but is not limited to, these and any other suitable types of memories.

The second processor 322 may be an integrated circuit chip having a signal processing capability. In the implementation process, various steps of the above methods may be completed by an integrated logic circuit of hardware or instructions in the form of software in the second processor 322. The second processor 322 mentioned above may be a general-purpose processor, a digital signal processor (DSP), an application specific integrated circuit (ASIC), a field programmable gate array (FPGA) or other programmable logic devices, a discrete gate or transistor logic devices, and discrete hardware components. Various methods, steps and logic block diagrams disclosed in the embodiments of the present disclosure may be implemented or performed. A general-purpose processor may be a microprocessor, or the processor may be any conventional processor or the like. The steps of the methods disclosed in combination with the embodiments of the present disclosure may be directly embodied as being performed and completed by a hardware decoding processor, or by a combination of hardware and software modules in the decoding processor. The software module may be located in a mature storage medium in the art such as a random access memory, a flash memory, a read-only memory, a programmable read-only memory, an electrically erasable programmable memory, or a register. The storage medium is located in the second memory 321, and the second processor 322 reads the information in the second memory 321 and completes the steps of the above methods in combination with its hardware.

It will be understood that the embodiments described in the present disclosure may be implemented by hardware, software, firmware, middleware, microcode, or a combination thereof. For hardware implementation, the processing unit may be implemented in one or more application specific integrated circuits (ASICs), digital signal processors (DSPs), digital signal processing devices (DSPDs), programmable logic devices (PLDs), field programmable gate arrays (FPGAs), general-purpose processors, controllers, microcontrollers, microprocessors, other electronic units configured to perform the functions described in the present disclosure, or a combination thereof. For software implementation, the technology described in the present disclosure may be implemented through modules (e.g., procedures, functions) that perform the functions described in the present disclosure. The software codes may be stored in a memory and executed by a processor. The memory may be implemented within the processor or external to the processor.

The embodiments of the present disclosure provide a decoder. The decoder decodes a bitstream to determine flag information of a first prediction mode corresponding to nodes in a current layer, the flag information of the first prediction mode being used for indicating an optimal prediction mode of the nodes in the current layer; determines the optimal prediction mode corresponding to the nodes in the current layer based on the flag information of the first prediction mode; and determines attribute prediction values of the nodes in the current layer based on the optimal prediction mode corresponding to the nodes in the current layer. It may be seen that in the embodiments of the present disclosure, during predicting the attribute information, the flag information of the first prediction mode may be transmitted in the bitstream, and the first prediction mode flag information may indicate the optimal prediction mode of the nodes in the current layer, so that the prediction mode determined by the flag information of the first prediction mode may be used for predicting the attribute information of the nodes in the current layer, which may effectively remove the redundancy of the attributes, and improve the attribute encoding and decoding efficiency of the point cloud, thereby improving the encoding and decoding performance of the point cloud.

In yet another embodiment of the present disclosure, referring to FIG. 32, a schematic diagram of a composition structure of an encoding and decoding system provided in the embodiments of the present disclosure is illustrated. As illustrated in FIG. 32, the encoding and decoding system 230 may include an encoder 2301 and a decoder 2302.

In the embodiment of the present disclosure, the encoder 2301 may be the encoder as described in any one of the above embodiments, and the decoder 2302 may be the decoder as described in any one of the above embodiments.

In yet another embodiment of the present disclosure, the embodiments of the present disclosure further provide a bitstream, which is generated by bit encoding based on information to be encoded. The information to be encoded includes at least: flag information of a first prediction mode, flag information of a second prediction mode, flag information of a third prediction mode, and quantized coefficient residuals.

It should be noted that in the embodiments of the present disclosure, the terms “comprising”, “including” or any other variations thereof are intended to encompass a non-exclusive inclusion, so that a process, method, object or apparatus including a series of elements includes not only those elements, but also other elements not explicitly listed, or also includes elements inherent to such process, method, object or apparatus. Without more limitations, an element defined by the phrase “comprising a . . . ” does not exclude the presence of other identical elements in the process, method, object or apparatus comprising the elements.

The serial numbers in the above embodiments of the present disclosure are for description only and do not represent advantages or disadvantages of the embodiments.

The methods disclosed in several method embodiments provided in the present disclosure may be arbitrarily combined without conflict to obtain new method embodiments.

The features disclosed in several product embodiments provided in the present disclosure may be arbitrarily combined without conflict to obtain new product embodiments.

The features disclosed in several method or device embodiments provided in the present disclosure may be arbitrarily combined without conflict to obtain new method embodiments or device embodiments.

The foregoing are merely specific implementations of the present disclosure, but the protection scope of the present disclosure is not limited thereto. Changes or replacements that any person skilled in the art could readily conceive of within the technical scope of the present disclosure shall be included in the protection scope of the present disclosure. Therefore, the protection scope of the present disclosure shall be subject to the protection scope of the claims.

### INDUSTRIAL APPLICABILITY

The embodiments of the present disclosure provide encoding and decoding methods, an encoder, a decoder, a bitstream and a non-transitory storage medium. The encoder and the decoder determine flag information of a first prediction mode corresponding to nodes in a current layer, the flag information of the first prediction mode being used for indicating an optimal prediction mode of the nodes in the current layer; determine the optimal prediction mode corresponding to the nodes in the current layer based on the flag information of the first prediction mode; and determine attribute prediction values of the nodes in the current layer based on the optimal prediction mode corresponding to the nodes in the current layer. It may be seen that in the embodiments of the present disclosure, during predicting attribute information, the flag information of the first prediction mode may be transmitted in the bitstream, and the first prediction mode flag information may indicate the optimal prediction mode of the nodes in the current layer, so that the prediction mode determined by the flag information of the first prediction mode may be used for predicting attribute information of the nodes in the current layer, which may effectively remove the redundancy of the attributes, and improve the attribute encoding and decoding efficiency of the point cloud, thereby improving the encoding and decoding performance of the point cloud.

What is claimed is:

1. A decoding method, applied to a decoder, the method comprising:
decoding a bitstream to determine flag information of a first prediction mode corresponding to nodes in a current layer; wherein the flag information of the first prediction mode is used for indicating an optimal prediction mode of the nodes in the current layer;
determining the optimal prediction mode corresponding to the nodes in the current layer based on the flag information of the first prediction mode; and
determining attribute prediction values of the nodes in the current layer based on the optimal prediction mode corresponding to the nodes in the current layer.

2. The method according to claim 1, wherein determining the optimal prediction mode corresponding to the nodes in the current layer based on the flag information of the first prediction mode comprises:
in response to a value of the flag information of the first prediction mode being a first value, determining that the optimal prediction mode corresponding to the nodes in the current layer is a first prediction mode; or
in response to the value of the flag information of the first prediction mode being a second value, determining that the optimal prediction mode corresponding to the nodes in the current layer is a second prediction mode.

3. The method according to claim 2, wherein
the first prediction mode comprises an attribute intra prediction mode and/or an attribute inter prediction mode; and
the second prediction mode comprises an attribute intra prediction mode.

4. The method according to claim 3, further comprising:
for a current node among the nodes in the current layer, determining a number of first neighbors corresponding to the current node and a number of second neighbors corresponding to a parent node of the current node; and
in response to determining that the current node meets a condition for attribute prediction based on the number of the first neighbors and the number of the second neighbors, decoding the bitstream to determine flag information of a second prediction mode corresponding to the current node; wherein the flag information of the second prediction mode is used for determining whether to perform attribute inter prediction processing on the current node.

5. The method according to claim 4, further comprising:
in response to a value of the flag information of the second prediction mode being a third value, allowing performing the attribute inter prediction processing on the nodes in the current layer; or
in response to the value of the flag information of the second prediction mode being a fourth value, disallowing performing the attribute inter prediction processing on the nodes in the current layer.

6. The method according to claim 5, further comprising:
in response to allowing performing the attribute inter prediction processing on the nodes in the current layer, performing a process of determining the flag information of the first prediction mode.

7. The method according to claim 4, further comprising:
in response to the number of the first neighbors being greater than a first threshold, and the number of the second neighbors being greater than a second threshold, determining that the current node meets the condition for the attribute prediction; or
in response to the number of the first neighbors being less than or equal to the first threshold, or the number of the second neighbors being less than or equal to the second threshold, determining that the current node does not meet the condition for the attribute prediction.

8. The method according to claim 3, wherein in response to the optimal prediction mode corresponding to the nodes in the current layer being the first prediction mode, determining the attribute prediction values of the nodes in the current layer based on the optimal prediction mode corresponding to the nodes in the current layer comprises:
determining reference positions corresponding to the nodes in the current layer in a reference picture corresponding to a current picture based on geometric information corresponding to the nodes in the current layer; and
in response to the reference positions corresponding to reconstructed reference points, determining the attribute prediction values of the nodes in the current layer based on attribute reconstruction values of the reconstructed reference points.

9. The method according to claim 8, further comprising:
in response to the reference positions not corresponding to any reconstructed reference point, determining neighboring nodes corresponding to the nodes in the current layer in the current picture based on the geometric information corresponding to the nodes in the current layer; and
determining the attribute prediction values of the nodes in the current layer based on attribute prediction values of the neighboring nodes.

10. The method according to claim 3, wherein in response to the optimal prediction mode corresponding to the nodes in the current layer being the second prediction mode, determining the attribute prediction values of the nodes in the current layer based on the optimal prediction mode corresponding to the nodes in the current layer comprises:
determining neighboring nodes corresponding to the nodes in the current layer in a current picture based on geometric information corresponding to the nodes in the current layer; and
determining the attribute prediction values of the nodes in the current layer based on attribute prediction values of the neighboring nodes.

11. An encoding method, applied to an encoder, the method comprising:
determining flag information of a first prediction mode corresponding to nodes in a current layer; wherein the flag information of the first prediction mode is used for indicating an optimal prediction mode of the nodes in the current layer; and
determining attribute prediction values of the nodes in the current layer based on the optimal prediction mode corresponding to the nodes in the current layer.

12. The method according to claim 11, wherein determining the flag information of the first prediction mode corresponding to the nodes in the current layer comprises:
performing predictive encoding on the nodes in the current layer based on a first prediction mode and a second prediction mode respectively using a rate-distortion optimization algorithm to determine the flag information of the first prediction mode; and signaling the flag information of the first prediction mode into a bitstream.

13. The method according to claim 12, wherein
the first prediction mode comprises an attribute intra prediction mode and/or an attribute inter prediction mode; and
the second prediction mode comprises an attribute intra prediction mode.

14. The method according to claim 13, further comprising:
for a current node among the nodes in the current layer, determining a number of first neighbors corresponding to the current node and a number of second neighbors corresponding to a parent node of the current node; and
in response to determining that the current node meets a condition for attribute prediction based on the number of the first neighbors and the number of the second neighbors, determining flag information of a second prediction mode corresponding to the current node; wherein the flag information of the second prediction mode is used for determining whether to perform attribute inter prediction processing on the current node.

15. The method according to claim 14, further comprising:
in response to a value of the flag information of the second prediction mode being a third value, allowing performing the attribute inter prediction processing on the nodes in the current layer; or
in response to a value of the flag information of the second prediction mode being a fourth value, disallowing performing the attribute inter prediction processing on the nodes in the current layer.

16. The method according to claim 15, further comprising:
in response to allowing performing the attribute inter prediction processing on the nodes in the current layer, performing a process of determining the flag information of the first prediction mode.

17. The method according to claim 14, further comprising:
in response to the number of the first neighbors being greater than a first threshold, and the number of the second neighbors being greater than a second threshold, determining that the current node meets the condition for the attribute prediction; or
in response to the number of the first neighbors being less than or equal to the first threshold, or the number of the second neighbors being less than or equal to the second threshold, determining that the current node does not meet the condition for the attribute prediction.

18. The method according to claim 13, wherein in response to the optimal prediction mode corresponding to the nodes in the current layer being the first prediction mode, determining the attribute prediction values of the nodes in the current layer based on the optimal prediction mode corresponding to the nodes in the current layer comprises:
determining reference positions corresponding to the nodes in the current layer in a reference picture corresponding to a current picture based on geometric information corresponding to the nodes in the current layer; and
in response to the reference positions corresponding to reconstructed reference points, determining the attribute prediction values of the nodes in the current layer based on attribute reconstruction values of the reconstructed reference points;
wherein the method further comprises:
in response to the reference positions not corresponding to any reconstructed reference point, determining neighboring nodes corresponding to the nodes in the current layer in the current picture based on the geometric information corresponding to the nodes in the current layer; and
determining the attribute prediction values of the nodes in the current layer based on attribute prediction values of the neighboring node.

19. The method according to claim 13, wherein in response to the optimal prediction mode corresponding to the nodes in the current layer being the second prediction mode, determining the attribute prediction values of the nodes in the current layer based on the optimal prediction mode corresponding to the nodes in the current layer comprises:
determining neighboring nodes corresponding to the nodes in the current layer in a current picture based on geometric information corresponding to the nodes in the current layer; and
determining the attribute prediction values of the nodes in the current layer based on attribute prediction values of the neighboring nodes.

20. A bitstream, wherein the bitstream is generated by bit encoding based on information to be encoded; and the information to be encoded comprises at least: flag information of a first prediction mode, flag information of a second prediction mode, flag information of a third prediction mode, and quantized coefficient residuals.
